(19) United States
(12) Patent Application Publication
(10) Pub. No.: US 2023/0067026 A1
(43) Pub. Date: Mar. 2, 2023

(54) AUTOMATED DATA ANALYTICS METHODS FOR NON-TABULAR DATA, AND RELATED SYSTEMS AND APPARATUS

(71) Applicant: DataRobot, Inc., Boston, MA (US)

(72) Inventors: Yurii Huts, Lviv (UA); Chin Ee Kin, Johor (MY); Anton Kasyanov, Kyiv (UA); Zachary Albert Mayer, Boston, MA (US); Xavier Conort, Singapore (SG); Hon Nian Chua, Singapore (SG); Sabari Shanmugam, Singapore (SG); Atanas Mitkov Atanasov, Copenhagen (DK); Ivan Richard Pyzow, South Pasadena, CA (US)

(73) Assignee: DataRobot, Inc., Boston, MA (US)

(21) Appl. No.: 17/800,173

(22) PCT Filed: Feb. 17, 2021
(86) PCT No.: PCT/US2021/018404

§ 371 Date: Aug. 16, 2022

Related U.S. Application Data
(60) Provisional application No. 62/977,591, filed on Feb. 17, 2020.
(60) Provisional application No. 62/990,256, filed on Mar. 16, 2020.

(51) Int. Cl. G06V 10/82; G06V 10/771; G06V 30/422

(52) U.S. Cl. CPC G06V 10/82; G06V 10/771; G06V 30/422

(57) ABSTRACT

Automated data analytics techniques for non-tabular data sets may include methods and systems for (1) automatically developing models that perform tasks in the domains of computer vision, audio processing, speech processing, text processing, or natural language processing; (2) automatically developing models that analyze heterogeneous data sets containing image data and non-image data, and/or heterogeneous data sets containing tabular data and non-tabular data; (3) determining the importance of an image feature with respect to a modeling task, (4) explaining the value of a modeling target based at least in part on an image feature, and (5) detecting drift in image data. In some cases, multi-stage models may be developed, wherein a pre-trained feature extraction model extracts low-, mid-, high-, and/or highest-level features of non-tabular data, and a data analytics models uses those features (or features derived therefrom) to perform a data analytics task.

### CROSS-REFERENCE TO RELATED APPLICATIONS

This application is a National Stage Entry under 35 U.S.C. § 371 of International Application No. PCT/US2021/018404, filed Feb. 17, 2021, which claims the benefit of priority under 35 U.S.C. § 119 to U.S. Provisional Application No. 62/977,591, titled “Automatic Data Analytics Using Two-Stage Models” and filed on Feb. 17, 2020, and U.S. Provisional Application No. 62/990,256, titled “Automatic Data Analytics Using Two-Stage Models” on Mar. 16, 2020, each of which is hereby incorporated by reference herein in its entirety.

The subject matter of this application is related to the subject matter of U.S. patent application Ser. No. 15/790,803, titled “Systems for time-series predictive data analytics, and related methods and apparatus” on Oct. 23, 2017, and International Patent Application No. PCT/US2019/066381, titled “Methods for Detecting and Interpreting Data Anomalies, and Related Systems and Devices” on Dec. 13, 2019, each of which is hereby incorporated by reference herein in its entirety.

### TECHNICAL FIELD

The present disclosure generally relates to machine learning and data analytics. Portions of the disclosure relate specifically to the use of automated machine learning techniques to develop and deploy data analytics tools for image data.

### BACKGROUND

Data analytics tools are used to guide decision-making and/or to control systems in a wide variety of fields and industries, e.g., security; transportation; fraud detection; risk assessment and management; supply chain logistics; development and discovery of pharmaceuticals and diagnostic techniques; and energy management. Historically, the processes used to develop data analytics tools suitable for carrying out specific data analytics tasks generally have been expensive and time-consuming, and often have required the expertise of highly-trained data scientists. Such processes generally includes steps of data collection, data preparation, feature engineering, model generation, and/or model deployment.

“Automated machine learning” technology may be used to automate significant portions of the above-described process of developing data analytics tools. In recent years, advances in automated machine learning technology have substantially lowered the barriers to the development of certain types of data analytics tools, particularly those that operate on time-series data, structured and unstructured textual data, categorical data, and numerical data.

“Computer vision” generally refers to the use of computer systems to analyze and interpret image data. Computer vision tools generally use models that incorporate principles of geometry and/or physics. Such models may be trained to solve specific problems within the computer vision domain using machine learning techniques. For example, computer vision models may be trained to perform object recognition (recognizing instances of objects or object classes in images), identification (identifying an individual instance of an object in an image), detection (detecting specific types of objects or events in images), etc.

### SUMMARY

Automated data analytics techniques for non-tabular data sets are disclosed.

In general, one innovative aspect of the subject matter described in this specification can be embodied in a method for determining an importance of an aggregate image feature, the method including obtaining a plurality of data samples, wherein each of the plurality of data samples is associated with respective values for a set of features and with a respective value for a target, wherein the set of features includes a feature having an aggregate image data type, and wherein the feature having the aggregate image data type includes a plurality of features each having a constituent image data type; for each of the plurality of constituent image features, determining a feature importance score indicating an expected utility of the constituent image feature for predicting the values of the target; and determining a feature importance score for the aggregate image feature based on the feature importance scores of the constituent image features, wherein the feature importance score for the aggregate image feature indicates an expected utility of the aggregate image feature for predicting the values of the target.

Other embodiments of this aspect include corresponding computer systems, apparatus, and computer programs recorded on one or more computer storage devices, each configured to perform the actions of the method. A system of one or more computers can be configured to perform particular actions by virtue of having software, firmware, hardware, or a combination of them installed on the system (e.g., instructions stored in one or more storage devices) that in operation causes or cause the system to perform the actions. One or more computer programs can be configured to perform particular actions by virtue of including instructions that, when executed by data processing apparatus, cause the apparatus to perform the actions.

The foregoing and other embodiments can each optionally include one or more of the following features, alone or in combination. In some embodiments, the aggregate image feature includes an image feature vector. In some embodiments, the feature importance score includes a univariate feature importance score, a feature impact score, or a Shapley value. The actions of the method may further include, prior to determining the feature importance score for the aggregate image feature based on the feature importance scores of the constituent image features, normalizing and/or standardizing the feature importance scores for the constituent image features.

The actions of the method may further include, for each data sample of the plurality of data samples, extracting respective values for the plurality of constituent image features from a first plurality of images using a pre-trained image processing model. In some embodiments, the pre-trained image processing model includes a pre-trained image feature extraction model or a pre-trained, fine-tunable image processing model. In some embodiments, the pre-trained image processing model includes a convolutional neural network model previously trained on a training data set including a second plurality of images.

In some embodiments, determining the feature importance score for the aggregate image feature includes selecting a highest feature importance score among the feature importance scores for the constituent image features, and using the selected highest feature importance score as the feature importance score for the aggregate image feature. In some embodiments, the set of features further includes a feature having a non-image data type, and the actions of the method further include quantitatively comparing a feature importance score of the feature having the non-image data type with the feature importance score of the aggregate image feature; and determining, based on the quantitative comparison, whether the non-image feature or the aggregate image feature has greater expected utility for predicting the values of the target.

In general, another innovative aspect of the subject matter described in this specification can be embodied in an image-based data analytics method, including obtaining inference data, wherein the inference data include image data; extracting, by an image feature extraction model, respective values of a plurality of constituent image features derived from the image data; and determining a value of a data analytics target based on the values of the plurality of constituent image features, wherein the determining is performed by a trained machine learning model.

Other embodiments of this aspect include corresponding computer systems, apparatus, and computer programs recorded on one or more computer storage devices, each configured to perform the actions of the method. A system of one or more computers can be configured to perform particular actions by virtue of having software, firmware, hardware, or a combination of them installed on the system (e.g., instructions stored in one or more storage devices) that in operation causes or cause the system to perform the actions. One or more computer programs can be configured to perform particular actions by virtue of including instructions that, when executed by data processing apparatus, cause the apparatus to perform the actions.

The foregoing and other embodiments can each optionally include one or more of the following features, alone or in combination. In some embodiments, the image feature extraction model is pre-trained. In some embodiments, the image feature extraction model includes a convolutional neural network. In some embodiments, the plurality of constituent image features include one or more low-level image features, one or more mid-level image features, one or more high-level image features, and/or one or more highest-level image features.

In some embodiments, the inference data further include non-image data. In some embodiments, determining of the value of the data analytics target is also based on values of one or more features derived from the non-image data. The actions of the method may further include arranging the values of the constituent image features and the values of the features derived from the non-image data in a table, wherein the determining of the value of the data analytics target is performed by applying the trained machine learning model to the table. In some embodiments, the image feature extraction model is not fitted to the values of the plurality of constituent image features derived from the image data. In some embodiments, the trained machine learning model includes a gradient boosting machine. In some embodiments, the value of the data analytics target includes a prediction based on the inference data, a description of the inference data, a classification associated with the inference data, and/or a label associated with the inference data.

In general, another innovative aspect of the subject matter described in this specification can be embodied in a method for explaining a value of a target based at least in part on an image feature, the method including obtaining a data sample including image data, wherein the data sample is associated with respective values for a set of features and a value for a target, wherein the set of features includes an aggregate image feature, and wherein the aggregate image feature includes a plurality of constituent image features; obtaining, from an image feature extraction model, (1) respective values of the plurality of constituent image features for the image data and (2) respective activation maps corresponding to each of the constituent image features, wherein each of the activation maps indicates which regions of the image data, if any, activated a neural network layer corresponding to the respective constituent image feature; determining a feature importance score for each of the plurality of constituent image features, wherein the feature importance score for each constituent image feature indicates an expected utility of the constituent image feature for predicting the value of the target; and generating an image inference explanation visualization based on the feature importance scores for the plurality of constituent image features, the values of the plurality of constituent image features, and the activation maps, wherein the image inference explanation visualization identifies portions of the image data that contribute to the determination of the value of the target.

Other embodiments of this aspect include corresponding computer systems, apparatus, and computer programs recorded on one or more computer storage devices, each configured to perform the actions of the method. A system of one or more computers can be configured to perform particular actions by virtue of having software, firmware, hardware, or a combination of them installed on the system (e.g., instructions stored in one or more storage devices) that in operation causes or cause the system to perform the actions. One or more computer programs can be configured to perform particular actions by virtue of including instructions that, when executed by data processing apparatus, cause the apparatus to perform the actions.

The foregoing and other embodiments can each optionally include one or more of the following features, alone or in combination. In some embodiments, the data sample further includes non-image data. In some embodiments, the value of the target is determined by a two-stage visual artificial intelligence (AI) model, and the image inference explanation visualization explains, in part, how the model determined the value of the target.

In general, another innovative aspect of the subject matter described in this specification can be embodied in a two-stage data analytics method, including obtaining inference data, wherein the inference data include first data, wherein the first data include image data, natural language data, speech data, auditory data, or a combination thereof; extracting, by a feature extraction model, respective values of a plurality of constituent features derived from the first data; and determining a value of a data analytics target based on the values of the plurality of constituent features, wherein the determining is performed by a trained machine learning model.

Other embodiments of this aspect include corresponding computer systems, apparatus, and computer programs recorded on one or more computer storage devices, each configured to perform the actions of the method. A system of one or more computers can be configured to perform particular actions by virtue of having software, firmware, hardware, or a combination of them installed on the system (e.g., instructions stored in one or more storage devices) that in operation causes or cause the system to perform the actions. One or more computer programs can be configured to perform particular actions by virtue of including instructions that, when executed by data processing apparatus, cause the apparatus to perform the actions.

The foregoing and other embodiments can each optionally include one or more of the following features, alone or in combination. In some embodiments, the feature extraction model is pre-trained. In some embodiments, the feature extraction model includes a convolutional neural network (CNN), recurrent neural network (RNN), or Transformer-based neural network. In some embodiments, the plurality of constituent features include one or more low-level features extracted by a first layer of the neural network, one or more mid-level features extracted by a second layer of the neural network, one or more high-level features extracted by a third layer of the neural network, and/or one or more highest-level features extracted by a fourth layer of the neural network.

In some embodiments, the inference data further include second data. In some embodiments, determining of the value of the data analytics target is also based values of one or more features derived from the second data. The actions of the method may further include arranging the values of the constituent features of the first data and the values of the features derived from the second data in a table, wherein the determining of the value of the data analytics target is performed by applying the trained machine learning model to the table. In some embodiments, the trained machine learning model includes a gradient boosting machine. In some embodiments, the value of the data analytics target includes a prediction based on the inference data, a description of the inference data, a classification associated with the inference data, and/or a label associated with the inference data.

In general, another innovative aspect of the subject matter described in this specification can be embodied in a method for detecting drift in image data, including obtaining respective first anomaly scores for each of a first plurality of data samples associated with a first time, each of the first plurality of data samples associated with respective values for a set of constituent image features extracted from first image data, the respective first anomaly score for each data sample indicating an extent to which the data sample is anomalous; obtaining respective second anomaly scores for each of a second plurality of data samples associated with a second time after the first time, each of the second plurality of data samples associated with respective values for the set of constituent image features extracted from second image data, the respective second anomaly score for each data sample indicating an extent to which the data sample is anomalous; determining a first quantity of data samples of the first plurality of data samples having respective first anomaly scores greater than a threshold anomaly score; determining a second quantity of data samples of the second plurality of data samples having respective second anomaly scores greater than the threshold anomaly score; determining a quantity difference between the first and second quantities of data samples; and responsive to an absolute value of the quantity difference being greater than a threshold difference, performing one or more actions associated with detection of image data drift.

Other embodiments of this aspect include corresponding computer systems, apparatus, and computer programs recorded on one or more computer storage devices, each configured to perform the actions of the method. A system of one or more computers can be configured to perform particular actions by virtue of having software, firmware, hardware, or a combination of them installed on the system (e.g., instructions stored in one or more storage devices) that in operation causes or cause the system to perform the actions. One or more computer programs can be configured to perform particular actions by virtue of including instructions that, when executed by data processing apparatus, cause the apparatus to perform the actions.

The foregoing and other embodiments can each optionally include one or more of the following features, alone or in combination. In some embodiments, the one or more actions associated with detection of image data drift include providing a message to a user, the message indicating that image data drift has been detected. In some embodiments, the one or more actions associated with detection of image data drift include generating a new image feature extraction model based on the second plurality of data samples associated with the second time point.

In general, another innovative aspect of the subject matter described in this specification can be embodied in a computer-implemented method including obtaining training data for a data analytics model, wherein the training data include a plurality of training data samples, wherein each of the data samples includes a respective training image; extracting, from each of the training images, a respective numeric value of an image feature; obtaining multiple sets of scoring data, wherein each set of scoring data corresponds to a different time period and includes a respective plurality of scoring data samples, wherein each of the scoring data samples includes a respective scoring image; extracting, from each of the scoring images, a respective numeric value of the image feature; for each set of scoring data, providing the numeric values of the image feature extracted from the training images and the numeric values of the image feature extracted from the respective set of scoring data as input to a classifier; detecting, based on output from the classifier, drift in the numeric values of the image feature over time; determining that the drift corresponds to a reduction in accuracy of the data analytics model; and facilitating a corrective action to improve the accuracy of the data analytics model.

Other embodiments of this aspect include corresponding computer systems, apparatus, and computer programs recorded on one or more computer storage devices, each configured to perform the actions of the method. A system of one or more computers can be configured to perform particular actions by virtue of having software, firmware, hardware, or a combination of them installed on the system (e.g., instructions stored in one or more storage devices) that in operation causes or cause the system to perform the actions. One or more computer programs can be configured to perform particular actions by virtue of including instructions that, when executed by data processing apparatus, cause the apparatus to perform the actions.

The foregoing and other embodiments can each optionally include one or more of the following features, alone or in combination. In some embodiments, the data analytics model is trained using the training data, and wherein the data analytics model is used to make predictions based on the scoring data. In some embodiments, each set of scoring data represents a distinct period of time. In some embodiments, the classifier includes a covariate shift classifier configured to detect statistically significant differences between two sets of data. In some embodiments, detecting the drift over time includes detecting the drift in two or more of the sets of scoring data.

In some embodiments, determining that the drift corresponds to a reduction in accuracy of the data analytics model includes determining an impact of the image feature on the reduction in accuracy. In some embodiments, determining the impact includes displaying, via a graphical user interface, a chart including an indication of the impact of the image feature on the reduction in accuracy. In some embodiments, the corrective action includes one or more of sending an alert to a user of the data analytics model, refreshing the data analytics model, retraining the data analytics model, switching to a new data analytics model, or any combination thereof.

In some embodiments, for a particular image selected from the training images or scoring images, extracting the numeric value of the image feature of the particular image includes, with a pre-trained image processing model, extracting respective values of a plurality of constituent image features from the particular image; and applying a transformation to the values of the constituent image features to determine the numeric value of the image feature. In some embodiments, the transformation is a dimensionality-reducing transformation. In some embodiments, the transformation includes a principal component analysis (PCA) and/or a uniform manifold approximation and projection (UMAP).

In general, another innovative aspect of the subject matter described in this specification can be embodied in a model development system including an image feature extraction module operable to extract values of one or more image feature candidates from image data; a data preparation and feature engineering module operable to obtain values of one or more of a plurality of features based, at least in part, on the values of the image feature candidates; and a model creation and evaluation module operable to generate and evaluate one or more machine learning models trained to determine a value of a data analytics target based on the values of the plurality of features. In some embodiments, the data preparation and feature engineering module is further operable to obtain values of one or more of the plurality of features based, at least in part, on non-image data.

The above and other preferred features, including various novel details of implementation and combination of events, will now be more particularly described with reference to the accompanying figures and pointed out in the claims. It will be understood that the particular systems and methods described herein are shown by way of illustration only and not as limitations. As will be understood by those skilled in the art, the principles and features described herein may be employed in various and numerous embodiments without departing from the scope of any of the present inventions. As can be appreciated from foregoing and following description, each and every feature described herein, and each and every combination of two or more such features, is included within the scope of the present disclosure provided that the features included in such a combination are not mutually inconsistent. In addition, any feature or combination of features may be specifically excluded from any embodiment of any of the present inventions.

The foregoing Summary, including the description of some embodiments, motivations therefor, and/or advantages thereof, is intended to assist the reader in understanding the present disclosure, and does not in any way limit the scope of any of the claims.

### BRIEF DESCRIPTION OF THE DRAWINGS

The accompanying figures, which are included as part of the present specification, illustrate the presently preferred embodiments and together with the generally description given above and the detailed description of the preferred embodiments given below serve to explain and teach the principles described herein.

FIG. 1 shows a block diagram of a model development system 100, according to some embodiments.

FIG. 2A shows examples of user interface elements for providing a data set that includes image data and non-image data, according to some embodiments.

FIG. 2B shows examples of user interface elements for initiating model development on a data set that includes image data and non-image data, according to some embodiments.

FIG. 3 shows an example of exploratory data analysis results for the data set of FIG. 2A.

FIGS. 4 and 5 each show an example of a user interface displaying subsets of images from the data set of FIG. 2A.

FIG. 6 shows a blueprint for the development of a data analytics model using image data and non-image data, according to some embodiments.

FIG. 7 shows summaries of some examples of blueprints for the development of data analytics models using image data and non-image data, according to some embodiments.

FIG. 8A shows some examples of modified images of a furry animal.

FIG. 8B shows a portion of a user interface for image augmentation, according to some embodiments.

FIG. 8C shows another portion of the user interface for image augmentation, according to some embodiments.

FIG. 9 shows a user interface for tuning a pre-trained image processing model, according to some embodiments.

FIG. 10A shows a block diagram of an image processing model, according to some embodiments.

FIG. 10B shows a block diagram of a pre-trained image feature extraction model, according to some embodiments.

FIG. 10C shows a block diagram of a pre-trained, fine-tunable image processing model, according to some embodiments.

FIG. 10D shows a block diagram of another image processing model, according to some embodiments.

FIG. 11 shows a block diagram of a model deployment system 1100, according to some embodiments.

FIG. 12A shows a portion of a user interface for displaying visualizations of data drift, according to some embodiments.

FIG. 12B shows another portion of the user interface for displaying visualizations of data drift, according to some embodiments.

FIG. 13 shows an example of neural network visualization, according to some embodiments.

FIG. 14A shows examples of occlusion-based image inference explanations, according to some embodiments.

FIG. 14B shows examples of multicolor image inference explanations, according to some embodiments.

FIG. 14C shows examples of monochromatic image inference explanations, according to some embodiments.

FIG. 14D shows an example of an explanation user interface displaying image inference explanations for exterior images of houses that the a model correctly assigned to a particular price range, according to some embodiments.

FIG. 15 shows an example of an image embedding visualization, according to some embodiments.

FIG. 16 shows an example of a user interface in which feature impact values for image and non-image features are displayed, according to some embodiments.

FIG. 17 is a data flow diagram showing a process for generating an image inference explanation visualization, according to some embodiments.

FIG. 18A is a flow chart of an image-based data analytics method, according to some embodiments.

FIG. 18B is a flow chart of a two-stage data analytics method, according to some embodiments.

FIG. 19A is a flow chart of a method for determining the feature importance of an aggregate image feature, according to some embodiments.

FIG. 19B is a flow chart of a method for explaining a value of a target based at least in part on an image feature, according to some embodiments.

FIG. 19C is a flow chart of a drift detection method for image data, according to some embodiments.

FIG. 19D is a flow chart of another drift detection method for image data, according to some embodiments.

FIG. 20 shows an example of exploratory data analysis results for an insurance claim data set.

FIG. 21 shows a blueprint for the development of a data analytics model that predicts insurance claims using image data and non-image data, according to some embodiments.

FIG. 22 shows another example of a user interface in which feature impact values for image and non-image features are displayed, according to some embodiments.

FIG. 23 shows an image inference explanation visualization indicating the impact of different regions of the exterior image of a house with respect to an individual prediction of a model, according to some embodiments.

FIG. 24 is a block diagram of an example computer system.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### DETAILED DESCRIPTION

### 1. Terms

As used herein, “data analytics” may refer to the process of analyzing data (e.g., using machine learning models or techniques) to discover information, draw conclusions, and/or support decision-making. Species of data analytics can include descriptive analytics (e.g., processes for describing the information, trends, anomalies, etc. in a data set), diagnostic analytics (e.g., processes for inferring why specific trends, patterns, anomalies, etc. are present in a data set), predictive analytics (e.g., processes for predicting future events or outcomes), and prescriptive analytics (processes for determining or suggesting a course of action).

“Machine learning” generally refers to the application of certain techniques (e.g., pattern recognition and/or statistical inference techniques) by computer systems to perform specific tasks. Machine learning techniques (automated or otherwise) may be used to build data analytics models based on sample data (e.g., “training data”) and to validate the models using validation data (e.g., “testing data”). The sample and validation data may be organized as sets of records (e.g., “observations” or “data samples”), with each record indicating values of specified data fields (e.g., “independent variables,” “inputs,” “features,” or “predictors”) and corresponding values of other data fields (e.g., “dependent variables,” “outputs,” or “targets”). Machine learning techniques may be used to train models to infer the values of the outputs based on the values of the inputs. When presented with other data (e.g., “inference data”) similar to or related to the sample data, such models may accurately infer the unknown values of the targets of the inference data set.

A feature of a data sample may be a measurable property of an entity (e.g., person, thing, event, activity, etc.) represented by or associated with the data sample. For example, a feature can be the price of a house. As a further example, a feature can be a shape extracted from an image of the house. In some cases, a feature of a data sample is a description of (or other information regarding) an entity represented by or associated with the data sample. A value of a feature may be a measurement of the corresponding property of an entity or an instance of information regarding an entity. For instance, in the above example in which a feature is the price of a house, a value of the ‘price’ feature can be $215,000. In some cases, a value of a feature can indicate a missing value (e.g., no value). For instance, in the above example in which a feature is the price of a house, the value of the feature may be ‘NULL’, indicating that the price of the house is missing.

Features can also have data types. For instance, a feature can have an image data type, a numerical data type, a text data type (e.g., a structured text data type or an unstructured (“free”) text data type), a categorical data type, or any other suitable data type. In the above example, the feature of a shape extracted from an image of the house can be of an image data type. In general, a feature's data type is categorical if the set of values that can be assigned to the feature is finite.

As used herein, “image data” may refer to a sequence of digital images (e.g., video), a set of digital images, a single digital image, and/or one or more portions of any of the foregoing. A digital image may include an organized set of picture elements (“pixels”). Digital images may be stored in computer-readable file. Any suitable format and type of digital image file may be used, including but not limited to raster formats (e.g., TIFF, JPEG, GIF, PNG, BMP, etc.), vector formats (e.g., CGM, SVG, etc.), compound formats (e.g., EPS, PDF, PostScript, etc.), and/or stereo formats (e.g., MPO, PNS, JPS, etc.).

As used herein, “non-image data” may refer to any type of data other than image data, including but not limited to structured textual data, unstructured textual data, categorical data, and/or numerical data. As used herein, “natural language data” may refer to speech signals representing natural language, text (e.g., unstructured text) representing natural language, and/or data derived therefrom. As used herein, “speech data” may refer to speech signals (e.g., audio signals) representing speech, text (e.g., unstructured text) representing speech, and/or data derived therefrom. As used herein, “auditory data” may refer to audio signals representing sound and/or data derived therefrom.

As used herein, “time-series data” may refer to data collected at different points in time. For example, in a time-series data set, each data sample may include the values of one or more variables sampled at a particular time. In some embodiments, the times corresponding to the data samples are stored within the data samples (e.g., as variable values) or stored as metadata associated with the data set. In some embodiments, the data samples within a time-series data set are ordered chronologically. In some embodiments, the time intervals between successive data samples in a chronologically-ordered time-series data set are substantially uniform.

Time-series data may be useful for tracking and inferring changes in the data set over time. In some cases, a time-series data analytics model (or “time-series model”) may be trained and used to predict the values of a target Z at time t and optionally times t+1, . . . , t+i, given observations of Z at times before t and optionally observations of other predictor variables P at times before t. For time-series data analytics problems, the objective is generally to predict future values of the target(s) as a function of prior observations of all features, including the targets themselves.

As used herein, “spatial data” may refer to data relating to the location, shape, and/or geometry of one or more spatial objects. A “spatial object” may be an entity or thing that occupies space and/or has a location in a physical or virtual environment. In some cases, a spatial object may be represented by an image (e.g., photograph, rendering, etc.) of the object. In some cases, a spatial object may be represented by one or more geometric elements (e.g., points, lines, curves, and/or polygons), which may have locations within an environment (e.g., coordinates within a coordinate space corresponding to the environment).

As used herein, “spatial attribute” may refer to an attribute of a spatial object that relates to the object's location, shape, or geometry. Spatial objects or observations may also have “non-spatial attributes.” For example, a residential lot is a spatial object that that can have spatial attributes (e.g., location, dimensions, etc.) and non-spatial attributes (e.g., market value, owner of record, tax assessment, etc.). As used herein, “spatial feature” may refer to a feature that is based on (e.g., represents or depends on) a spatial attribute of a spatial object or a spatial relationship between or among spatial objects. As a special case, “location feature” may refer to a spatial feature that is based on a location of a spatial object. As used herein, “spatial observation” may refer to an observation that includes a representation of a spatial object, values of one or more spatial attributes of a spatial object, and/or values of one or more spatial features.

Spatial data may be encoded in vector format, raster format, or any other suitable format. In vector format, each spatial object is represented by one or more geometric elements. In this context, each point has a location (e.g., coordinates), and points also may have one or more other attributes. Each line (or curve) comprises an ordered, connected set of points. Each polygon comprises a connected set of lines that form a closed shape. In raster format, spatial objects are represented by values (e.g., pixel values) assigned to cells (e.g., pixels) arranged in a regular pattern (e.g., a grid or matrix). In this context, each cell represents a spatial region, and the value assigned to the cell applies to the represented spatial region.

Data (e.g., variables, features, etc.) having certain data types, including data of the numerical, categorical, or time-series data types, are generally organized in tables for processing by machine-learning tools. Data having such data types may be referred to collectively herein as “tabular data” (or “tabular variables,” “tabular features,” etc.). Data of other data types, including data of the image, textual (structured or unstructured), natural language, speech, auditory, or spatial data types, may be referred to collectively herein as “non-tabular data” (or “non-tabular variables,” “non-tabular features,” etc.).

As used herein, “data analytics model” may refer to any suitable model artifact generated by the process of using a machine learning algorithm to fit a model to a specific training data set. The terms “data analytics model,” “machine learning model” and “machine learned model” are used interchangeably herein.

As used herein, the “development” of a machine learning model may refer to construction of the machine learning model. Machine learning models may be constructed by computers using training data sets. Thus, “development” of a machine learning model may include the training of the machine learning model using a training data set. In some cases (generally referred to as “supervised learning”), a training data set used to train a machine learning model can include known outcomes (e.g., labels or target values) for individual data samples in the training data set. For example, when training a supervised computer vision model to detect images of cats, a target value for a data sample in the training data set may indicate whether or not the data sample includes an image of a cat. In other cases (generally referred to as “unsupervised learning”), a training data set does not include known outcomes for individual data samples in the training data set.

Following development, a machine learning model may be used to generate inferences with respect to “inference” data sets. For example, following development, a computer vision model may be configured to distinguish data samples including images of cats from data samples that do not include images of cats. As used herein, the “deployment” of a machine learning model may refer to the use of a developed machine learning model to generate inferences about data other than the training data.

Computer vision tools (e.g., models, systems, etc.) may perform one or more of the following functions: image pre-processing, feature extraction, and detection/segmentation. Some examples of image pre-processing techniques include, without limitation, image re-sampling, noise reduction, contrast enhancement, and scaling (e.g., generating a scale space representation). Extracted features may be low-level (e.g., raw pixels, pixel intensities, pixel colors, gradients, patterns and textures (e.g., combinations of colors in close proximity), color histograms, motion vectors, edges, lines, corners, ridges, etc.), mid-level (e.g., shapes, surfaces, volumes, patterns, etc.), high-level (e.g., objects, scenes, events, etc.), or highest-level. The lower level features tend to be simpler and more generic (or broadly applicable), whereas the higher level features to be complex and task-specific. The detection/segmentation function may involve selection of a subset of the input image data (e.g., one or more images within a set of images, one or more regions within an image, etc.) for further processing. Models that perform image feature extraction (or image pre-processing and image feature extraction) may be referred to herein as “image feature extraction models.”

Collectively, the features extracted and/or derived from an image may be referred to herein as a “set of image features” (or “aggregate image feature”), and each individual element of that set (or aggregation) may be referred to as a “constituent image feature.” For example, the set of image features extracted from an image may include (1) a set of constituent image feature indicating the colors of the individual pixels in the image, (2) a set of constituent image features indicating where edges are present in the image, and (3) a set of constituent image features indicating where faces are present in the image.

As used herein, a “modeling blueprint” (or “blueprint”) refers to a computer-executable set of preprocessing operations, model-building operations, and postprocessing operations to be performed to develop a model based on the input data. Blueprints may be generated “on-the-fly” based on any suitable information including, without limitation, the size of the user data, features types, feature distributions, etc. Blueprints may be capable of jointly using multiple (e.g., all) data types, thereby allowing the model to learn the associations between image features, as well as between image and non-image features.

### 2. Overview

As noted above, recent advances in automated machine learning technology have substantially lowered the barriers to the development of certain types of data analytics tools, particularly those that operate on time-series data, categorical data, and numerical data. However, improved automated machine learning technology is needed to facilitate the development of (1) computer vision tools and (2) data analytics tools and models that operate on image data (alone or in combination with non-image data). There is also a need for data analytics tools that can determine the importance of image data relative to other types of data in the context of solving specific data analytics problems. In addition, there is a need for interpretive tools that can explain how computer vision tools and data analytics tools are interpreting image data (e.g., by identifying the portions of images that are most important to the inferences made or outputs generated by the tools).

The models (e.g., data analytics models) and techniques (e.g., modeling techniques, automation techniques, techniques for determining the importance of certain data relative to other data, techniques for interpreting the outputs of models and tools, etc.) described herein are generally described in the context of performing computer visions tasks (e.g., tasks related to the analysis and/or interpretation of images or videos) or solving data analytics problems using both image data and non-image data. However, one of ordinary skill in the art will appreciate that these models and techniques are applicable to other tasks (e.g., tasks related to the analysis and/or interpretation of natural language data, speech data, text data, audio data, etc.).

More generally, some embodiments of the models and techniques described herein are applicable to performing tasks, analyzing data (e.g., data with high dimensionality), or solving problems that might otherwise be performed, analyzed, or solved using neural networks (e.g., deep neural networks or “deep learning” models). In some cases, the data analytics models can be trained to perform specific tasks using fewer computational resources and/or less training data than would be required to train neural networks to perform the same tasks. In some cases, the trained data analytics models are able to perform the specific tasks using fewer computational resources than would be required by the trained neural networks to perform the same tasks. Such tasks may include computer vision tasks, natural language processing tasks, speech processing tasks, text processing tasks, image processing tasks, video processing tasks, audio processing tasks, etc.

Portions of the disclosure relate to data analytics models that analyze image data, alone or in combination with non-image data. Portions of the disclosure relate to the automation of processes for developing data analytics models that operate on (1) image data (e.g., for computer vision tools) or (2) image data and non-image data (e.g., for data analytics tools). Portions of the disclosure relate to techniques for determining, for an aggregate image feature extracted and/or derived from an image, the impact of that feature on the output of a data analytics model, and for comparing that impact to the impacts of other features of the model (e.g., other aggregate image features and/or non-image features). Portions of the disclosure relate to tools and techniques for providing visual explanations of image-based inferences. Portions of the disclosure related to tools and techniques for detecting drift in image data (or other, non-tabular data). Portions of the disclosure relate to tools and techniques for automatically developing models that perform tasks in the domains of computer vision, audio processing, speech processing, text processing, and/or natural language processing. Portions of the disclosure relate to tools and techniques for automatically developing models that analyze heterogeneous data sets containing (1) image data and non-image data, (2) tabular data and non-tabular data, or (3) two or more types of non-tabular data.

### 3. Some Motivations, Applications, Attributes, and Benefits

3.1. Some Motivations for Some Embodiments

The recent decade has seen a number of technological breakthroughs in solving problems that were traditionally considered difficult for computers. One such problem is computer vision (CV), which generally involves acquiring, processing, analyzing, and understanding digital images. The evolution of consumer computing devices and increased ease of access to the Internet has led to generating larger volumes of image data and the availability of computing power to process it.

Techniques for integrating computer vision with other AI-related technologies (e.g., data analytics) are needed. Incorporating image analysis into data analytics models can enable businesses to unlock new use cases (where the predictive modeling problem is visual in its nature) and improve the modeling accuracy in existing use cases (by augmenting existing data sets with new predictive image features).

Even though computer vision has been studied since the mid-20th century, early adopters have struggled with making computer vision technology generalizable for different domains and applications, with achieving performance comparable to humans, and with making the technology computationally efficient. However, in 2011, a significant milestone in computer vision was reached: for the first time in history, a machine learning model (powered by deep learning) achieved superhuman performance in a visual pattern recognition contest. In 2012, a similar system won the large-scale ILSVRC (“ImageNet”) competition, beating other machine learning approaches by a significant margin. These achievements have accelerated the academic and business interest in AI and the field of computer vision in particular.

Despite these milestones, computer vision (“CV”) (and deep learning CV in particular) remains a field with high entry barriers, which are further accentuated by the lack of qualified data science personnel in the industry. Leveraging image data in business applications using existing tools generally requires support from data scientists who can design bespoke deep learning models, write code, and validate, deploy, maintain, and troubleshoot computer vision systems.

Accordingly, there remains a need for an automated data analytics system capable of working with digital image data without requiring any significant specialized expertise from the user. Some embodiments of the system described herein are capable of putting the power of machine learning and deep learning for computer vision into the hands of business users with diverse backgrounds. In some embodiments, the system provides an easy-to-understand user interface, full transparency of the modeling process, and short time to value.

3.2. Some Applications, Attributes, and Benefits of Some Embodiments

Some embodiments of automated techniques for analyzing data sets containing image data are described herein. The use of these automated techniques may provide the following advantages: (1) reducing or eliminating human error from visual recognition tasks; achieving superhuman accuracy; (2) requiring fewer human resources for repetitive visual recognition tasks; being able to narrow down the number of cases for manual human involvement, in some cases even in the presence of model errors, still delivers large economic value in terms of reducing the number of human hours; (3) providing higher throughput compared to human vision, allowing users to speed up and scale production workflows; (4) facilitating robotic process automation (RPA) by introducing AI workers in the workflow.

Some domain-specific examples of useful applications of automated techniques for analyzing data sets containing image data may include the following:

Manufacturing: inspection of manufactured products for defects. An assembly line often involves a visual inspection step where products or parts are assessed for quality control compliance. Using a computer vision tool or image-based data analytics tool to automatically detect defects allows for increased product quality as well as scaled production throughput. When images are combined with other features that describe the manufacturing process as in some embodiments, it is possible for some embodiments of the data analytics tools described herein to find associations between manufacturing parameters and visual outcomes, and optimize the parameters of the environment to minimize expected defects.

Healthcare: diagnosing health conditions based on medical imaging. Medical diagnoses commonly rely on trained human experts to interpret images acquired from medical devices. Some embodiments of the automated computer vision tools or image-based data analytics tools described herein are capable of processing digital medical images directly, and can achieve specialist-level or superhuman accuracy in certain tasks: for instance, skin cancer classification, prostate cancer grading, and diabetic retinopathy detection. Increased diagnosis accuracy eliminates a number of risks with patient treatment and health insurance.

Insurance: property damage assessment. Visual inspection of the insured property allows an insurer to estimate possible losses. According to some embodiments, an image-based data analytics model that uses multiple image features at once (e.g. vehicle photo before and after an accident) can make more accurate predictions by learning associations between the images. When policy details are used as features in addition to images, the model can learn the association between them as well and provide more accurate predictions and more meaningful prediction explanations.

Security: detecting forbidden items at security checkpoints. An airport security line uses human operators for inspecting X-ray scans of luggage and body scans of passengers. In accordance with some embodiments, an automated computer vision system can be trained to detect certain items on scans without human errors or assist technicians in determining likelihood of forbidden items, and therefore improve (e.g., optimize) checkpoint throughput.

Media: detecting inappropriate posts on websites with user-generated content. Social networks, news websites, and Q&A platforms often rely on human moderators to review content before publishing it, or review existing questionable content reported by users. Visual user-generated content may include spam, pornography, shock content, or other sensitive material. According to some embodiments, using an automated moderation system powered by computer vision can increase moderation throughput by involving human moderators only in low-confidence predictions, and auto-moderate the majority of clear violations of content policies. Using images in combination with tabular features (e.g., user rating or registration date) and/or other non-tabular features can increase the accuracy of predicting inappropriate content compared to a model using the images alone.

Some embodiments of systems for developing and deploying image-based data analytics models are described herein. Characteristics of some embodiments may include: 1. Optimized for custom image analytics. 2. Usability by business personas with diverse backgrounds, without a STEM degree or specialized training in computer vision and image analytics. 3. Designed to support real-world business cases in multiple domains, such as insurance claims prediction and health care rehospitalization prediction. Many of these cases benefit from combining image data with non-image data to achieve desired performance. 4. Built-in guardrails to minimize spurious results, thereby improving model development and operations. Some non-limiting examples of guardrails include anomaly detection, data drift detection, target leakage detection, enforcement of data science best practices (e.g., cross validation, hyperparameter tuning, using the correct error metric for the problem, using validation and holdout sets, etc.), etc. 5. Efficiency and flexibility in terms of capital and operational expenses.

Some embodiments of the automated computer vision tools or image-based data analytics tools described herein may exhibit one or more (e.g., all) of the following characteristics or capabilities, which may help to address one or more (e.g., all) of the aforementioned challenges:

Code-free data ingestion, model development, and deployment. Many conventional CV systems are code-centric and require the user to write code to accomplish the desired goal. Business users often lack training in software engineering and are unable to program. The code-free data ingestion, model development, and model deployment capabilities of some embodiments greatly lower barriers to adoption and use of computer vision tools and image-based data analytics.

Exploratory data analysis, identifying data quality issues, and actionable model diagnostics. Unlike academic data sets, data quality in the field is far from perfect. Before starting modeling, users generally seek to confirm that the platform has understood the data correctly and/or to identify possible data issues. After modeling, users generally seek to understand the nature of any errors the model makes, to facilitate iterative model improvement. Existing CV systems generally provide limited exploration options before modeling and/or focus on general metrics (e.g., accuracy and/or area under curve (AUC)) after modeling, without drilling down into input data patterns, model error patterns, or explaining individual predictions.

Fully automated data science decisions. Many conventional CV systems require data science expertise from the user to be able to supply proper input information and parameters for modeling. Business users generally lack training in data science, therefore business teams using conventional CV systems still need the scarce resource of trained data scientists to deliver projects.

Ability to use multiple data types at once. The use case overview above indicates that using only images as inputs to a data analytics model in some cases may be insufficient to solve a business problem. Therefore, some embodiments of an automated image analytics system support multiple images per record, and/or combinations of image, numeric, categorical, text, geospatial, time series, and other data types in the same model.

Model diversity. In contrast to the well-known “No Free Lunch” theorem in machine learning (concluding that there is no single algorithm that is best suited for all possible scenarios and data sets), businesses are often constrained to use specific algorithms due to prior knowledge or interpretability/regulatory considerations. As a result, even though deep neural networks may achieve the best accuracy in certain use cases, businesses may be reluctant or unable to deploy them for compliance-sensitive projects. Instead, they may use less accurate models (e.g., linear or tree-based models). Some embodiments of the automated model development system described herein support a variety of models suitable for different business cases and automatic selection of appropriate models for particular data analytics problems. In contrast, many conventional CV systems use only neural networks and/or do not let the user choose a particular model type that is preferred in view of prior business considerations (e.g., monotonic relationships between the feature and the target).

Model explainability. To make sure the model is learning the right patterns in the data and does not contain hidden biases, some embodiments provide visual maps or other interpretive information to help users understand which parts of the images the model bases its decisions on. See the “Image Processing Model Explanations” section below.

Effective use of limited data and commodity hardware. Recent academic successes with deep learning models typically involve training models from scratch on large, commonly used data sets using hardware-accelerated platforms like GPU clusters. In the field, collecting large labeled data sets is very expensive, as is making upfront capital investments in high-performance hardware. Many currently available CV systems recommend that users run models on GPU-enabled hardware, otherwise the models suffer a significant performance penalty. Some embodiments significantly reduce the amount of training data and computation needed to develop image-based data analytics tools, thereby enabling the development of such tools using small data sets and commodity hardware.

Model monitoring. Data drift is a recognized problem in real-world machine learning systems. Over time, the inference data generally diverge from the training data used to develop the model. Data drift also occurs with image data. Therefore, some embodiments may support automatic data drift detection and model upgrade for deployed image-based data analytics models. To automatically detect data drift in images, some embodiments may track the drift in values (e.g., numeric values) of individual features extracted from the image. The drift of the values (e.g., numeric values) of individual features in the image may reflect the drift in the underlying image data. Some non-limiting examples of techniques for detecting drift in the values of features are described below. In this way, the problem of detecting drift in image data can be reduced to the problem of detecting drift in values (e.g., numeric values) of features extracted from the image data.

### 4. Model Development System

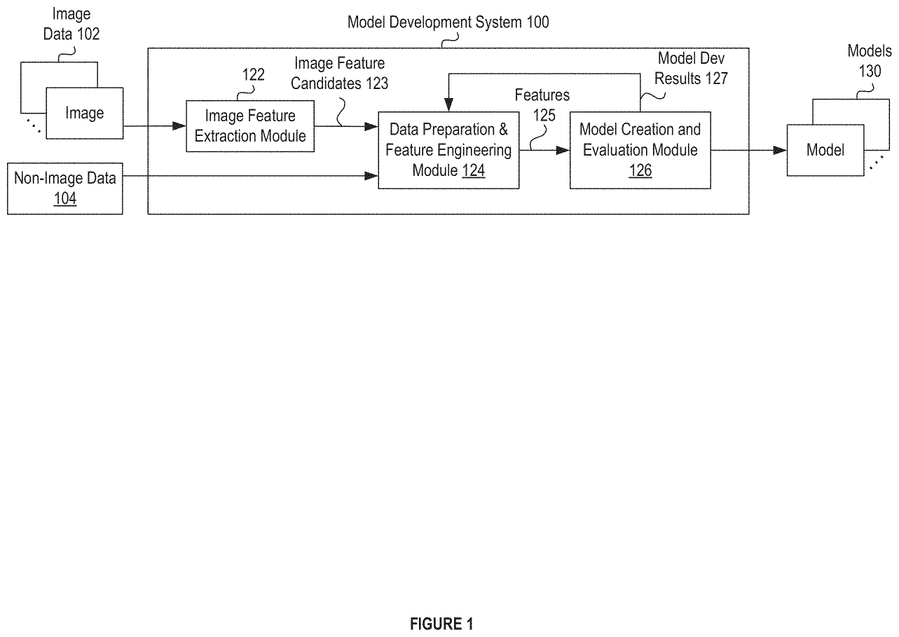

Referring to FIG. 1, a model development system 100 may include an image feature extraction module 122, a data preparation and feature engineering module 124, and a model creation and evaluation module 126. In some embodiments, the model development system 100 receives training data and uses the training data to develop (e.g., automatically develop) one or more models 130 (e.g., computer vision models, data analytics models, etc.) that solve a problem in a domain of computer vision or data analytics. The training data may include image data 102 (e.g., one or more images). Optionally, the training data may also include non-image data 104. Some embodiments of the components and functions of the model development system 100 are described in further detail below.

Collectively, the image feature extraction module 122 and the data preparation and feature engineering module 124 may perform one or more data ingestion operations on the input data (102, 104). Some non-limiting examples of data ingestion operations are described below in the section titled “Data Ingestion.”

The image feature extraction module 122 may perform one or more computer vision functions on the image data 102. In some embodiments, the image feature extraction module 122 performs image pre-processing and feature extraction on the image data 102, and provides the extracted features to the data preparation and feature engineering module 124 as image feature candidates 123. The extracted features may include, for example, unmodified portions of the image data 102, low-level image features, mid-level image features, high-level image features, and/or highest-level image features. Any suitable techniques may be used to extract the image feature candidates 123.

In some embodiments, the image feature extraction module 122 may perform image pre-processing and feature extraction using one or more image processing models. Some embodiments of image processing models are described below in the section titled “Image Processing Models.” As described in further detail below, image processing models may include pre-trained image feature extraction models, pre-trained fine-tunable image processing models, or a blend of the foregoing. In some embodiments, the image feature extraction module 122 uses a pre-trained image feature extraction model to extract image features from the image data 102. The image feature extraction model may be “pre-trained” in the sense that it has been trained to extract features suitable for performing a particular computer vision task (e.g., detecting cats in images), whereas the model development system 100 may be developing a model 130 that performs a different computer vision task (e.g., detecting fractures in medical images) or data analytics task (e.g., estimating the value of a house based in part on images thereof). In some embodiments, the image feature extraction module 122 uses a pre-trained, fine-tunable image processing model to extract image features from the image data 102. The fine-tunable image processing model may be “pre-trained” in the sense that it has been trained to extract features suitable for performing a particular computer vision task (e.g., detecting cats in images), whereas the model development system 100 may be developing a model 130 that performs a different computer vision task (e.g., detecting fractures in medical images) or data analytics task (e.g., estimating the value of a house based in part on images thereof). However, in contrast to the pre-trained image feature extraction model, one or more layers of the fine-tunable model's neural network may be tunable (trainable) to adapt the model's output to the computer vision task or data analytics task at hand.

The data preparation and feature engineering module 124 may perform data preparation and feature engineering operations with respect to the image feature candidates 123 and the non-image data 104. The data preparation operations may include, for example, characterizing the input data. Characterizing the input data may include detecting missing observations, detecting missing variable values, and/or identifying outlying variable values. In some embodiments, characterizing the input data includes detecting duplicate portions of input data (e.g., observations, images, etc.). If duplicate portions of input data are detected, the model development system 100 may notify a user of the detected duplication.

In some embodiments, characterizing the input data may include determining the “importance” of one or more of the image feature candidates 123 and/or candidate features derived from the non-image data 104. A candidate feature's “importance” may indicate the feature's expected utility (relative to other candidate features) in the context of developing solutions to the computer vision problem or data analytics problem at hand. For example, a candidate feature that is highly correlated with the target of a computer vision model or data analytics model generally has high “importance” (or “feature importance”) with respect to the development of such a model. Any suitable techniques may be used to determine a feature's importance, including (without limitation) the techniques described below in the section titled “Determining the Predictive Value of a Feature.”

The feature engineering operations performed by the data preparation and feature engineering module 124 may include, for example, combining two or more features and replacing the constituent features with the combined feature; extracting a new feature from the constituent features (e.g., average pixel intensity of an image, size of an image in megabytes, height of an image in pixels, width of an image in pixels, color histogram of an image, etc.); rotating, scaling, cropping, shifting, flipping (horizontally and/or vertically), blurring, cutting out portions of, and/or otherwise modifying images to create new images; dropping features that contain low variation (e.g., are mostly missing, or mostly take on a single value); extracting different aspects of date/time variables (e.g., temporal and seasonal information) into separate variables; normalizing variable values; infilling missing variable values; one hot encoding; text mining; etc. In some embodiments, the data preparation and feature engineering module 124 also performs feature selection operations (e.g., dropping uninformative features, dropping highly correlated features, replacing original features with top principal components, etc.). The data preparation and feature engineering module 124 may provide a curated (e.g., analyzed, engineered, selected, etc.) set of features 125 to the model creation and evaluation module 126 for use in creating and evaluating models.

The data preparation and feature engineering module 124 may use any suitable data characterization, feature engineering, and/or feature selection techniques, including (without limitation) the techniques described below in the section titled “Data Preparation and Feature Engineering.”

The model creation and evaluation module 126 may create one or more models and evaluate the models to determine how well they solve the computer vision problem or data analytics problem at hand. In some embodiments, the model creation and evaluation module 126 performs model-fitting steps to fit models to the training data (e.g., to the features 125 derived from the training data). The model-fitting steps may include, without limitation, algorithm selection, parameter estimation, hyper-parameter tuning, scoring, diagnostics, etc. The model creation and evaluation module 126 may perform model fitting operations on any suitable type of model, including (without limitation) decision trees, neural networks, support vector machine models, regression models, boosted trees, random forests, deep learning neural networks, k-nearest neighbors models, naïve Bayes models, etc. In some embodiments, the model creation and evaluation module 126 performs post-processing steps on fitted models. Some non-limiting examples of post-processing steps may include calibration of predictions, censoring, blending, choosing a prediction threshold, etc. In some embodiments, the model creation module 126 may perform one or more of the model-fitting and/or post-processing operations described in U.S. Pat. No. 10,496,927, which is incorporated by reference herein.

The model creation and evaluation module 126 may perform any suitable model creation and/or evaluation operations, including (without limitation) the techniques described below in the section titled “Model Building.”

In some cases, the model generated by the model creation and evaluation module 126 includes a gradient boosting machine (e.g., gradient boosted decision tree, gradient boosted tree, boosted tree model, any other model developed using a gradient tree boosting algorithm, etc.). Gradient boosting machines are generally well-suited to data analytics problems involving heterogeneous tabular data. Although gradient boosting machines (“GBMs”) are generally capable of handling wide, sparse, high-dimensional data (e.g., image data), GBMs may not perform particularly well when applied to such data. In some embodiments, the image feature extraction module 122 and data preparation and feature engineering module 124 extract a small number of dense, informative features from the image data 102, such that the extracted features are suitable for analysis using gradient boosting machines or other model types that may not perform well with high-dimensional data. In some embodiments, the data preparation and feature engineering module 124 determines the importance (e.g., univariate feature importance) of the individual image feature candidates 123 (and/or individual engineered features derived therefrom) to the target of a data set, and selects a subset of those feature candidates (e.g., the N most important feature candidates, all feature candidates having importance scores above a threshold value, etc.) as the features 125 used by the model creation and evaluation module 126 to generate and evaluate one or more models (e.g., gradient boosting machines).

In some cases, the model generated by the creation and evaluation module 126 includes a feed-forward neural network, with zero or more hidden layers. Feed forward neural networks are generally well-suited to data analytics problems that involve combining data from multiple domains (e.g., image data and text data, image data and tabular data, text data and tabular data, non-tabular data and tabular data, image data and other non-tabular data, etc.), pairs of inputs from the same domain (e.g., pairs of images, pairs of text samples, pairs of data samples of a non-tabular data type, pairs of tables, etc.), multiple inputs from the same domain (e.g., sets of images, sets of text samples, sets of data samples of a non-tabular data type, sets of tables, etc.), or combinations of singular, paired, and multiple inputs from a variety of domains (e.g., image data, text data, non-tabular data, and tabular data). In general, feed-forward neural networks are particularly well-suited to handling highly dimensional data (e.g., image data and/or other non-tabular data), and can additionally handle mixed dense and sparse data (e.g., the combination of dense image features with sparse word-occurrence features from a text sample).

In some cases, the model generated by the creation and evaluation module 126 includes a regression model, which can generally handle both dense and sparse data as described above. Regression models are often useful because they can be trained more quickly than other models that can handle both dense and sparse data (e.g., gradient boosting machines or feed forward neural networks).

Still referring to FIG. 1, in some embodiments, the data preparation and feature engineering module 124 and the model creation and evaluation module 126 form part of an automated model development pipeline, which the model development system 100 uses to systematically evaluate the space of potential solutions to the computer vision problem or data analytics problem at hand. In some cases, results 127 of the model development process may be provided to the data preparation and feature engineering module 124 to aid in the curation of features 125. Some non-limiting examples of systematic processes for evaluating the space of potential solutions to data analytics problems are described in U.S. Pat. No. 10,496,927, which is incorporated herein by reference.

In some embodiments, the model development system 100 enables highly efficient development of solutions to computer vision problems and/or data analytics problems involving non-tabular data (e.g., image data). Existing techniques for developing computer vision models are generally inefficient and expensive (some of them relying heavily on special-purpose hardware which is expensive to procure and maintain), and do not always yield optimal solutions to the problems at hand. In contrast to the machine learning domain, in which tools for model development have become increasingly automated over the last decade, techniques for developing computer vision models remain largely artisanal. Experts tend to build and evaluate potential solutions in an ad hoc fashion, based on their intuition or previous experience and on extensive trial-and-error testing. However, the space of potential solutions for computer vision problems is generally large and complex, and the artisanal approach to generating computer vision solutions tends to leave large portions of the solution space unexplored.

The model development system 100 disclosed herein can address the above-described shortcomings of conventional approaches by systematically and cost-effectively evaluating the space of potential solutions for computer vision problems and image-based data analytics problems. In many ways, the conventional approaches to solving computer vision problems are analogous to prospecting for valuable resources (e.g., oil, gold, minerals, jewels, etc.). While prospecting may lead to some valuable discoveries, it is much less efficient than a geologic survey combined with carefully planned exploratory digging or drilling based on an extensive library of previous results.

In some embodiments, the model development pipeline tailors its search of the solution space based on the computational resources available to the model development system 100. For example, the model development pipeline may obtain resource data indicating the computational resources available for the model creation and evaluation process. If the available computational resources are relatively modest (e.g., commodity hardware), the model development pipeline may extract feature candidates 123, select features 125, select model types, and/or select machine learning algorithms that tend to facilitate computationally efficient creation and evaluation of modeling solutions. If the computational resources available are more substantial (e.g., graphics processing units (GPUs), tensor processing units (TPUs), or other hardware accelerators), the model development pipeline may extract feature candidates 123, select features 125, select model types, and/or select machine learning algorithms that tend to produce highly accurate modeling solutions at the expense of using substantial computational resources during the model creation and evaluation process. Likewise, when substantial computational resources are available, the image feature extraction module 122 may finetune a fine-tunable image processing model and use the finetuned image processing model to perform image feature extraction, but when the available computational resources are more modest, the image feature extraction module 122 may use a pre-trained image feature extraction model to perform image feature extraction.

With respect to the development of data analytics models that analyze both image data and non-image data (e.g., tabular data derived from non-image features and/or other non-tabular data), the situation is even more dire. Using conventional tools, image data are generally analyzed using computer vision techniques, non-image data are analyzed using machine learning techniques or other domain-specific techniques (e.g., natural language processing, speech processing, etc.), and then the results of the separate computer vision, machine learning, and domain-specific processes are combined at a high level to produce an output (e.g., analysis, prediction, etc.) without recognizing or exploiting fine-grained relationships between the image data and the non-image data. The model development system 100 disclosed herein can address the above-described shortcomings of conventional approaches by (1) using computer vision techniques to extract image feature candidates from image data, (2) combining the image feature candidates and non-image data into an integrated data set (e.g., tabular data set), and (3) applying automated machine learning techniques to systematically and cost-effectively build models that use the available data to efficiently and accurately solve the analytics problem.

The model development system 100 may facilitate the use of the above-referenced solution-space evaluation techniques to evaluate potential solutions to computer vision problems and/or data analytics problems involving image data by separating image feature extraction operations and image feature analysis/interpretation operations into distinct models (or distinct stages of a multi-stage model). In particular, the image feature extraction module 122 may use a pre-trained image feature extraction model (e.g., a general-purpose or highly generic computer vision model) to extract image features (e.g., low-, mid-, and/or high-level features of images), and may provide those features (e.g., image feature candidates 123) to the automated model development pipeline. The model development pipeline may then train machine learning models to use those image feature candidates 123 (or features derived therefrom) to perform a data analytics task. If the data analytics task is a computer vision task, the pipeline may use the above-referenced solution-space evaluation techniques to provide automated development of computer vision tools. Otherwise, the pipeline may use the above-referenced solution-space evaluation techniques to provide automated development of data analytics tools capable of analyzing (e.g., jointly analyzing) image data and non-image data together in the same model.

Thus, in some embodiments, the model development system 100 generates modeling pipelines allowing use of multiple image features in the same data set, and/or use of multiple data types in the same data set (e.g. any combination of tabular and non-tabular features). Furthermore, by combining the aspects of deep learning in computer vision with aspects of general-purpose machine learning (e.g., linear, tree-based, and kernel-based models), the model development system 100 may achieve model diversity and adapt to additional business constraints. The integration of general-purpose machine learning for tabular data and deep learning for non-tabular data provides significant improvement in the efficiency and accessibility of model development technology for problems involving tabular data and non-tabular data (e.g., image data).

An example of a model development system 100 specifically configured to develop models that operate on image data 102 has been described. More generally, the model development system 100 receives training data and uses the training data to develop one or more models (e.g., computer vision models, natural language processing models, speech processing models, audio processing models, time-series models, data analytics models, etc.) that solve a problem in a domain of modeling or data analytics. The training data may include first data (e.g., non-tabular data, for example, image data, natural language data, speech data, text data, auditory data, spatial data, and/or time series data). Optionally, the training data may also include second data (e.g., tabular data or additional non-tabular data of any suitable type).

An example of a model development system 100 that includes an image feature extraction module 122 has been described. More generally, the model development system may include a feature extraction module operable to extract feature candidates based on first data. In general, the feature extraction module may use a pre-trained feature extraction model to extract the feature candidates. The feature extraction model may be “pre-trained” in the sense that it has been trained to extract features suitable for performing a particular task in the domain of the first data (e.g., a computer vision task, natural language processing task, speech processing task, text processing task, image processing task, video processing task, audio processing task, geospatial analysis task, time series data processing task, etc.), whereas the model development system 100 may be developing a model 130 that performs a different task in the domain of the first data or a data analytics task that relies on analysis of data from the domain of the first data. In some embodiments, the feature extraction model includes a neural network. In some embodiments, the neural network is a deep neural network that extracts a hierarchy of features (e.g., low-level features, mid-level features, and/or high-level features) from the first data.

For example, the feature extraction module may include a pre-trained audio feature extraction model, which may extract audio features (e.g., low-, medium-, high-, and/or highest-level audio features) from audio data. A pre-trained audio feature extraction model may use a convolutional neural network (CNN) or a Transformed-based neural network (e.g., wav2vec) pre-trained on a large collection of audio data. The collection of audio data may be from one or more domains that differ from the domain of the problem being solved by the model development system 100. Just as with image features, the outputs of intermediate neural network layers (e.g., pooled convolutions or Transformer encoder outputs) can be used as audio features (e.g., low-, medium-, or high-level audio features). In addition to extracting these “deep learning” features, in some embodiments the audio feature extraction model can extract traditional audio features (e.g., cepstral coefficients, chromagrams, mel-spectrograms, signal energy levels, spectral flatness, spectral contrast, etc.). In some embodiments, the feature extraction module may be capable of performing one or more audio pre-processing operations on audio data (e.g., detecting and cutting off silent segments, loudness normalization, detecting voice activity, converting speech to text, etc.).

As another example, the feature extraction module may include a pre-trained text feature extraction model, which may extract text features (e.g., low-, medium-, high-, and/or highest-level text features) from text data and/or natural language data. A pre-trained text feature extraction model may use a convolutional neural network (CNN), a recurrent neural network (e.g., RNN, including but not limited to long short-term memory (LSTM) RNN), or a Transformed-based neural network (e.g., ULMFiT, BERT, or any of their modifications, for example, TinyBERT, RoBERTa, etc.) pretrained on a large corpus of text. The corpus of text may be from one or more domains that differ from the domain of the problem being solved by the model development system 100. If the model uses a CNN, the outputs of intermediate neural network layers (e.g., pooled convolutions) can be used as text features (e.g., low-, medium-, or high-level text features). If the model uses a Transformer-based neural network, text features (e.g., low-, medium-, or high-level text features) may be derived from different intermediate layers in the Transformer network's stack of encoder layers, similarly to how image features are derived from intermediate layers in the CNN. In some embodiments, encoded text embeddings (e.g., text embeddings encoded by RNN, LSTM, or Transformer models) can be used as dense feature vectors. In addition to extracting these “deep learning” features, in some embodiments the text feature extraction model can extract traditional text features (e.g., part-of-speech (POS) tags, named entity recognition (NER) tags, a sample-term matrix, a compact matrix generated by performing Singular-Value Decomposition (SVD) factorization on the sample-term matrix, etc.).

The models 130 generated by the model development system 100 may be multi-stage (e.g., two-stage) models, in which the first stage is a pre-trained feature extraction model and the second stage is a data analytics model (e.g., machine learning model) trained to perform a modeling task or data analytics task using (1) the feature candidates extracted from first data by the pre-trained feature extraction model or features derived therefrom, and (2) (optionally) feature candidates extracted or derived from second data. In general, the multi-stage (e.g., two-stage) models 130 developed using the techniques described herein may exhibit approximately the same performance (e.g., accuracy) with respect to their modeling tasks or data analytics tasks as deep neural networks specifically trained to perform those same tasks. However, the model development system's process of developing a multi-stage (e.g., two-stage) model to perform a task (e.g., the process of extracting and engineering features for the downstream (e.g., second-stage) machine learning model, and the process of generating a downstream (e.g., second-stage) machine learning model) generally uses far fewer computational resources and far less training data than would be used to train a deep neural network to perform the same task with comparable performance (e.g., accuracy).

4.1. Data Ingestion

Data ingestion operations may include, without limitation, recognizing the type of computer vision problem or data analytics problem to be solved (e.g., based on the layout of the input data, the data type of a user-specified target, etc.); automatically assembling multiple image and non-image features into a single modeling data table; automatically performing detection, compression, and normalization of image formats and color spaces; and/or detecting image data integrity issues and notifying the user about detected defects in the data.

Without limitation, some embodiments support automated detection of (and development of modeling solutions to) the following problem types: regression; classification (e.g., binary, multiclass, multi-label, multi-target); time series forecasting; object detection; and anomaly detection. In multi-label classification problems, each data sample may be associated with a variable number of categorical feature values (e.g., an online comment 1) being offensive and political, 2) being offensive and political and using explicit language, or 3) only being political). In multi-target classification problems, each data sample may be associated with multiple targets (e.g., predictions of the existence of a tumor and of the coordinates of a tumor on an image generated by an MRI).

In some embodiments, the model development system 100 provides a user interface or application programming interface (API), whereby a user can upload a data set (e.g., raw data set with images). Some embodiments make it possible to work with image files directly, such that the user can arrange image files into folders, create an archive, and upload the archive to the system. In some embodiments, the system 100 inspects the metadata of the uploaded data set (e.g., archive) and automatically detect “user intent” (e.g., the type of problem that the user intends to solve and/or the type of modeling solution that the user intends to develop). For example, if the user uploads an archive of chest X-ray images, the system may infer that the user wishes to train a model to perform chest X-ray pathology classification.

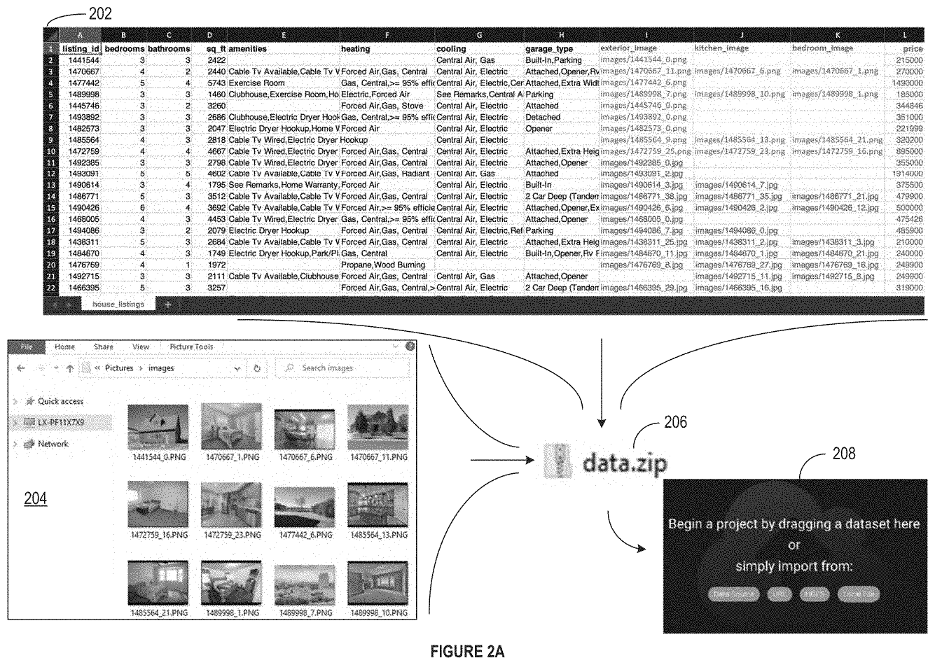

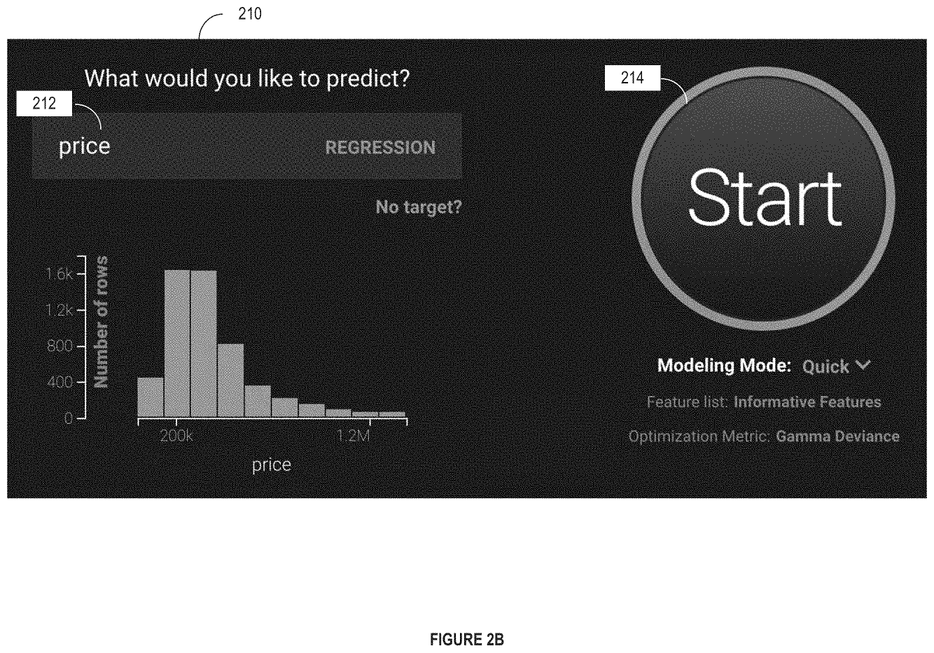

Referring to FIG. 2A, some non-limiting examples of data ingestion operations are illustrated with reference to an example data set. As shown in FIG. 2A, a data set that includes image data and non-image data may be arranged in a tabular format (e.g., a spreadsheet 202), which may be similar to the tabular formats frequently used for data sets that contain only tabular features. In the example of FIG. 2A, each row of the table (data sample) represents a unit of residential real estate (e.g., a house), and each column of the table (variable) represents an attribute of a unit of residential real estate. In the example of FIG. 2A, the values of tabular variables (e.g., the house's number of bedrooms, number of bathrooms, square footage, price, etc.) are stored directly in the table, whereas the values of image variables (e.g., photos of the houses) are represented by links or paths to files containing the corresponding image data.

Still referring to FIG. 2A, the heterogeneous data set for residential real estate price prediction may be provided to the model development system 100 by placing the spreadsheet 202 and the folder 204 containing the images of the houses in a file archive 206 (e.g., a .zip file) and dragging the file archive 206 onto a user interface 208 provided by the model development system 100 for uploading data sets. Other techniques for uploading a heterogeneous data set to the model development system 100 are possible.

Referring to FIG. 2B, after the data set has been uploaded, the model development system 100 may present a user interface 210 that prompts the user to specify the target of the modeling problem. In the example of FIG. 2B, the user interface 210 indicates that the price variable 212 of the data set has been selected as the target. Based on the selected target, the model development system may suggest the type of analysis to be performed (e.g., binary classification, multiclass classification, regression, etc.), or the user may select the type of analysis. In the example of FIG. 2B, the user interface 210 indicates that a regression analysis will be performed. The user can then select user interface element 214 (the ‘Start’ button) to initiate automated model development by the model development system 100.

The above-described tabular format for heterogeneous data is not limiting. Nevertheless, this spreadsheet-and-folder format provides an efficient and user-friendly mechanism by which users can organize data sets containing image data 102 and non-image data 104, and upload such data to a model development system 100.

4.2. Data Preparation and Feature Engineering

4.2.1. Exploratory Data Analysis

Exploratory data analysis operations may include, without limitation, automated assessment of image data quality (e.g., determining the feature importance of the candidate image features, detecting duplicates in the image data using image similarity techniques, detecting missing images, detecting broken image links, detecting unreadable images, etc.), and target-aware previewing of image data (e.g., displaying examples of images per class for classification problems, automated drilldown into images associated with different target subranges for regression problems, etc.). The feature importance of a candidate image feature may be, for example, the feature's univariate feature importance. Computation of univariate feature importance for image features is discussed in detail below in the section titled “Univariate Feature Importance.” If a missing image is detected (e.g., no link to an image is specified for an image variable of a data sample), the model development system may automatically impute a default image (e.g., an image in which all pixels are the same color, for example, black) for the image variable of the data sample. If a broken image link (e.g., a link to an image specified for an image variable of data sample, but the specified file does not exist at the specified location) or an unreadable image (e.g., specified image exists but is unreadable or corrupted) is detected, the model development system may notify the user, thereby giving the user an opportunity to correct the error or to instruct the system to substitute a default image for the broken image link/unreadable image.

In some instances, the model development system 100 automatically assembles multiple data sources into one modeling table. In such instances, automatic exploratory data analysis may include, without limitation, identifying the data types of the input data (e.g., numeric, categorical, date/time, text, image, location (geospatial), etc.), and determining basic descriptive statistics for one or more (e.g., all) features extracted from the input data. The results of such exploratory data analysis may help the user verify that the system has understood the uploaded data correctly and identify data quality issues early.

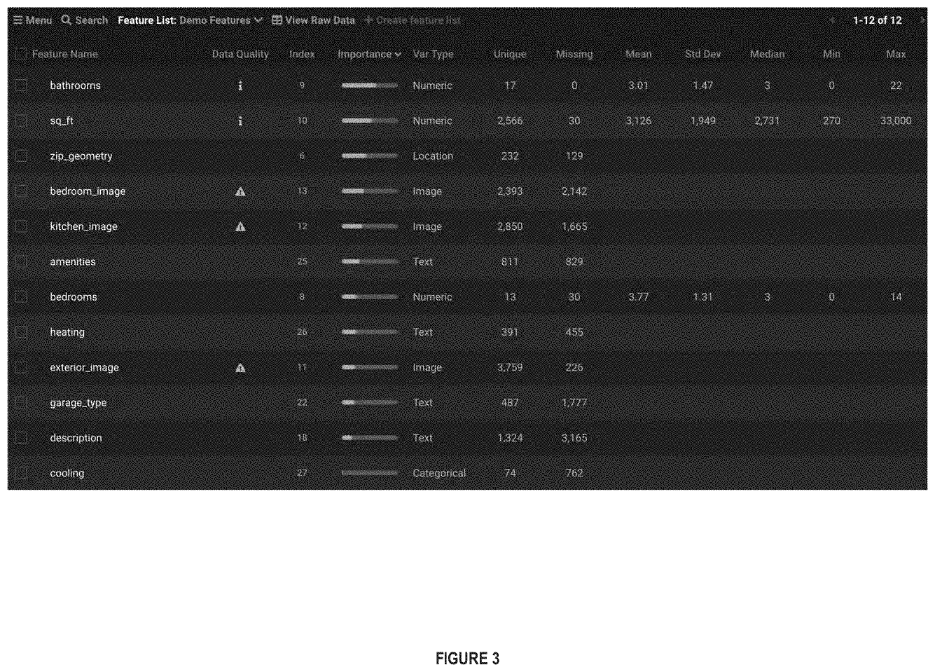

For the “residential real estate” data set introduced in the example of FIG. 2A, some embodiments of the exploratory data analysis may produce results similar to those shown in FIG. 3, In the example of FIG. 3, the results of the exploratory data analysis indicate the feature importance (“Importance”) of each of the data set's features with respect to the data set's target. The concept of feature importance and suitable techniques for determining a feature's ‘feature importance’ are described below in the section titled “Determining the Predictive Value of a Feature.” In the example of FIG. 3, the results of the exploratory data analysis indicate the data type (“Var Type”) of each variable in the data set, the number of unique values (“Unique”) of each variable, the number of data samples in which the value of each variable is missing (“Missing”), and the mean, standard deviation, median, minimum, and maximum (“Mean”, “Std Dev”, “Median”, “Min”, and “Max”, respectively) of the set of values of each of the numeric variables in the data set.

In the example of FIG. 3, the “feature importance” values for the image features may be univariate feature importance values that can be quantitatively compared with the feature importance values for the other, non-image features. This comparison may help the user gain intuition about the importance of including image data in the data set. In the example of FIG. 3, the images of a house's bedroom and kitchen are in the top 5 most important features in the data set, complemented by numeric features indicating the house's number of bathrooms and square footage, and a location (geospatial) feature indicating the boundaries of the zip code area in which the house is located.

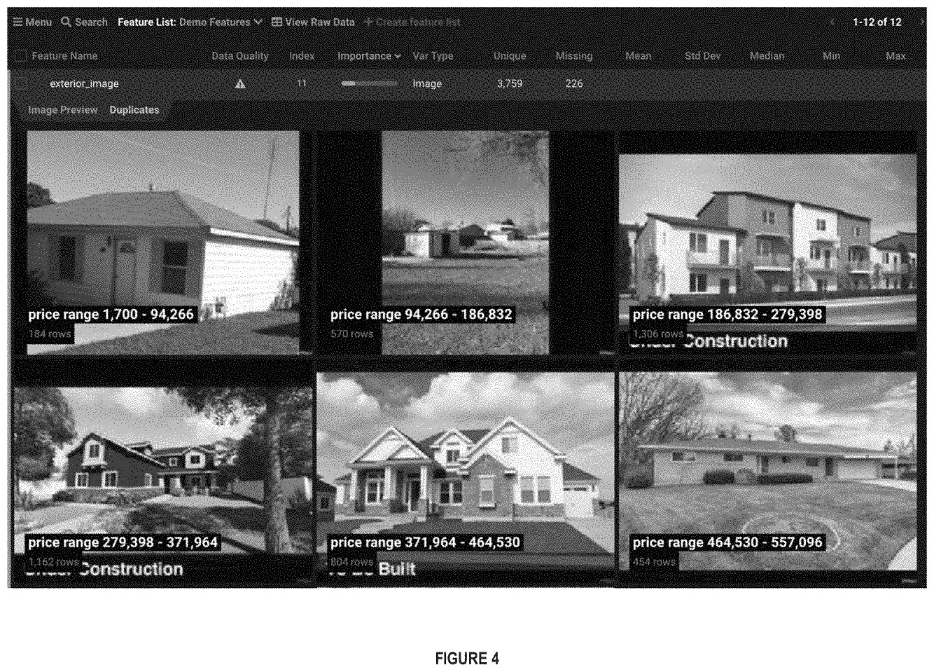

When the model's target is identified, some embodiments automatically recognize the type of modeling problem (e.g., Gamma regression), and provide automatic drilldown into subsets of image data in the data set. For the residential real estate data set, this functionality allows the user to visually inspect how houses in different price ranges look. In the example of FIG. 4, the system has grouped the houses into at least six price ranges ($1,700-$94,266; $94,266-$186,832, $186,832-$279,398, $279,398-$371,964, $371,964-$464,530, and $464,530-$557,096), and the system's user interface (UI) presents user-selectable collections of images corresponding to the houses in each price range. In the example of FIG. 5, the user has selected the set of images corresponding to houses in a higher price range ($834,794-$927,360), and the user interface presents the individual images corresponding to the houses in that price range.

Some embodiments can detect exact duplicate images or similar images assigned to different data samples in the input data (e.g., duplicate or similar images in the same column of a table in which the input data are organized), which can indicate possible data preparation mistakes made by the user.

4.2.2. Feature Engineering

In general, “feature engineering” encompasses “feature generation” (e.g., extracting features from an input data set, generating derived features based on raw or extracted features, etc.) and “feature selection” (e.g., determining which features in a set of candidate features are used to train a model). Some examples of feature engineering operations may include, without limitation, one-hot encoding, categorical encoding, normalizing numeric values, infilling missing variable values, combining two or more features and replacing the constituent features with the combined feature, etc.

In some embodiments, feature engineering operations are performed based on the predictive value (e.g., feature importance) of the features. For example, feature engineering may include pruning “less important” features from the dataset. In this context, a feature may be classified as “less important” if the predictive value (e.g., feature importance) of the feature is less than a threshold value, if the feature has one of the M lowest predictive values among the features in the dataset, if the feature does not have one of the N highest predictive values among the features in the dataset, etc. As another example, feature engineering may include creating derived features from “more important” features in the dataset. In this context, a feature may be classified as “more important” if the predictive value of the feature is greater than a threshold value, if the feature has one of the N highest predictive values among the features in the dataset, if the feature does not have one of the M lowest predictive values among the features in the dataset, etc.

4.3. Model Building

Some non-limiting examples of model creation and/or evaluation operations are described below. In some embodiments, the model development system 100 uses one or more of these operations to automatically generate models and/or modeling pipelines suitable for the uploaded modeling data set and/or data analytics targets and metrics.

In some embodiments, the model development system 100 automatically decides what type of image processing model to use to analyze the images of a data set. For example, the model development system 100 may select among computer vision (“CV”) models, pre-trained image feature extraction models (see below), pre-trained neural networks with transfer learning (e.g., pre-trained fine-tunable image processing models, as described below), custom-generated neural networks (e.g., neural networks trained from scratch for a specific computer vision or data analytics problem), or some combination thereof. The decision regarding which image processing model to use can be based, for example, on a comparison of the performance of the different types of image processing models on the given set of test data. Some embodiments can automatically decide which image processing model to use based on other factors, including, for example, time and/or cost, which can in turn depend upon available computing hardware, computational complexity, and/or data set size.

In some embodiments, the model development system 100 performs model-aware image preprocessing. Different image pre-processing operations may be more or less suitable for use with different image processing models. Thus, the model development system 100 may select a set of image pre-processing operations for a set of images based on the image processing model (or type of image processing model) that will be used to process the images. Image pre-processing operations may adjust any suitable aspect(s) of the data set's images, for example, image size, image file format, number of pixels in the image, color space of the image, image metadata, etc.

In some embodiments, the model development system 100 automatically selects image feature abstraction level(s) to adjust the amount of domain adaptation for the data set. In general, image processing models can be tuned to identify particular types of items (e.g., cats). Specifically, depending on the problem domain/ingested data set, image processing models may produce image features ranging from generic low-level features or specialized high-level features. At the lowest hierarchical level of an image processing model, edges (and/or other low-level image features) from an ingested image may be identified as candidate model features. At the next hierarchical level of an image processing model, the identified low-level image features may be aggregated into shapes (and/or other mid-level image features) for consideration as model features. At the next hierarchical level of an image processing model, the identified mid-level image features may be aggregated into objects (and/or other high-level image features) for consideration as model features.

In contrast to the model development system 100 disclosed herein, conventional CV systems generally force users to choose a feature level (e.g., low-, mid-, or high-level image features) and tune the image processing model for a specific type of object. Rather than tuning image processing models to identify different types of objects, the model development system 100 may use a general purpose image processing model (e.g., a pre-trained image feature extraction model, not tuned to a particular data set), export the outputs of one or more (e.g., all) levels of the image processing model hierarchy as features, and build a data analytics model using those image features (and, optionally, non-image features) as inputs. Thus, for some embodiments of the model development system 100, tuning a model for a particular application is a data analytics problem, not a computer vision problem. In other words, some embodiments of the model development system 100 simplify the computer vision problem by using automated machine-learning techniques to determine which image features are best suited to solve a particular computer vision problem or image-based data analytics problem.

In some embodiments, the model development system 100 automatically selects the non-image features of the input data set (or features derived therefrom) that produce the best models when combined with the selected image features. In some embodiments, the model development system 100 automatically selects the tabular features of the input data set (or features derived therefrom) that produce the best models when combined with the selected features extracted from the input data set's non-tabular data. In this context, models can be compared to determine which model is “best” using any suitable metric for model performance.

In some embodiments, the model development system 100 automatically augments the image data of the input data set for better model generalization. Obtaining a large number of images for model training is often difficult and expensive. Some embodiments can automatically augment available image data with transformed versions of the original images. Some examples of such image transformations may include, without limitation, horizontal and/or vertical flips, shifts, scaling the image up or down, rotations, blurring, cutting out regions of the image (e.g., replacing portions of the image with blank space), etc.

In various examples, searching for a model that fits a data set can involve choosing a suitable (e.g., optimal) set of values for modeling hyperparameters, which can be or include one or more parameters that define how a model is trained. In general, hyperparameters for neural networks can include, for example, mini-batch size, learning rate, dropout rate, number of epochs, hidden activation, output activation, etc. Additionally or alternatively, hyperparameters for image processing models (e.g., deep learning models used for image processing) may include the model's baseline architecture (e.g., SqueezeNet, MobileNetV3-Small, EfficientNet-b0, etc.), the model's pooling operation (e.g., Global Average Pooling (GAP), Generalized Mean Pooling (GeM), etc.), the type of post-processing performed on the extracted image features (e.g., Robust Standardization, L1 normalization, L2 normalization, etc.), the substitute architecture for model retraining (see below), etc. For blueprints that train image processing models, the number of possible sets of hyperparameter values can have an exponential relationship to the number of hyperparameters, and evaluating each set of hyperparameter values can utilize significant computational resources, especially when the underlying model architecture is large (e.g., contains many neurons and/or hidden layers).

Advantageously, the systems and methods described herein can streamline the hyperparameter selection process (also referred to herein as the “automated tuning” process) for image processing models (e.g., tunable image processing models) through the use of various heuristics, which can be based on one or more properties of the data set (e.g., number of images per data sample, number of classes, target type, amount of blur in the images, brightness level in the images, number of data samples, etc.), the type of data analytics problem being solved (e.g., classification, regression, etc.), the type of data analytics model being used to process the extracted image features, and/or any other suitable criteria.

In some embodiments, in connection with the training of a tunable image processing model, the model development system selects model architecture and pooling hyperparameters according to the following heuristics. By default, the system may select a SqueezeNet architecture with GAP layers as the baseline model architecture. If the problem being solved is a classification problem and the data set contains a small number of images per data sample (e.g., has no more than N1 images per data sample, where N1 may be 1, 2, 3, or more than 3), the system may select an architecture that provides high accuracy for classification tasks involving a single image or a small number of images (e.g., MobileNetV3-Small) as the baseline model architecture, rather than the SqueezeNet architecture. If the problem being solved is a classification problem and the number of classes is relatively large (e.g., greater than 10-30 classes, for example, greater than 20 classes), the system may select a different pooling operation (e.g., GeM) rather than GAP for the baseline model architecture.

In some embodiments, in connection with the training of tunable image processing model, the model development system selects image feature post-processing hyperparameters according to the following heuristics. By default, the system may post-process extracted image features using Robust Standardization. However, if the data analytics model is a linear model and the training data set is relatively small (e.g., has fewer than N2 data samples, where N2 may be between 2,000 and 5,000, for example, N2=3,000) the system may skip post-processing of the extracted image features. If the data analytics model is a stochastic gradient descent regressor/classifier and the training data set is relatively small (e.g., has fewer than N3 data samples, where N3 may be between 500 and 2,000, for example, N3=1,000), the system may post-process extracted image features using L2 normalization. If the data analytics model is a neural network and the training data set is relatively small (e.g., has fewer than N4 data samples, where N4 may be between 500 and 2,000, for example, N4=1,000), the system may post-process extracted image features using L1 normalization.

In some embodiments, if the baseline model architecture of the image processing model of the blueprint that produces a modeling solution (e.g., the best modeling solution) is a particular architecture (e.g., SqueezeNet or MobileNetV3-Small), the system may rerun the blueprint using an image processing model with a different (“substitute”) model architecture (e.g., EfficientNet-b0). When the blueprint is rerun with the substitute model architecture, the hyperparameter values may be initialized using the tuned hyperparameter values that were identified when the blueprint was run with the baseline model architecture. In some embodiments, the blueprint is rerun with the substitute model architecture and without further tuning of the hyperparameters. Optionally, further tuning of the hyperparameters may be performed when the blueprint is rerun. In general, the substitute architecture may be larger or more complex (e.g., more layers, more neurons, etc.) than the corresponding baseline architecture. In addition, when trained with suitable hyperparameters, a model with the substitute architecture may produce more accurate results than a model with the baseline architecture.

In many cases, the above-described process of tuning hyperparameters with a baseline model architecture during a first run of a blueprint and then rerunning the blueprint with a substitute model architecture allows the system to efficiently build an accurate model using commodity hardware. The modeling results obtained using this process often match or exceed those obtained by expert manual tuning on high-performance hardware, and this process is generally more computationally efficient than simply tuning the hyperparameters with the substitute model architecture during a single run of the blueprint.

The enhanced efficiency provided by the baseline/substitute tuning process derives from the observation that the optimal hyperparameter values for the more complex, more accurate substitute architecture are often substantially similar or identical to the optimal hyperparameter values for the less complex, less accurate baseline architecture. Accordingly, using the baseline architecture to identify a suitable set of hyperparameter values for the substitute architecture can greatly improve computational efficiency, with little or no loss in final model performance. The inventors have observed that when the above-described heuristics are used to automatically tune the hyperparameters of a blueprint, model performance generally improves by 25% or more, relative to the model performance obtained when the same computational resources and same blueprint are used without the above-described heuristics.

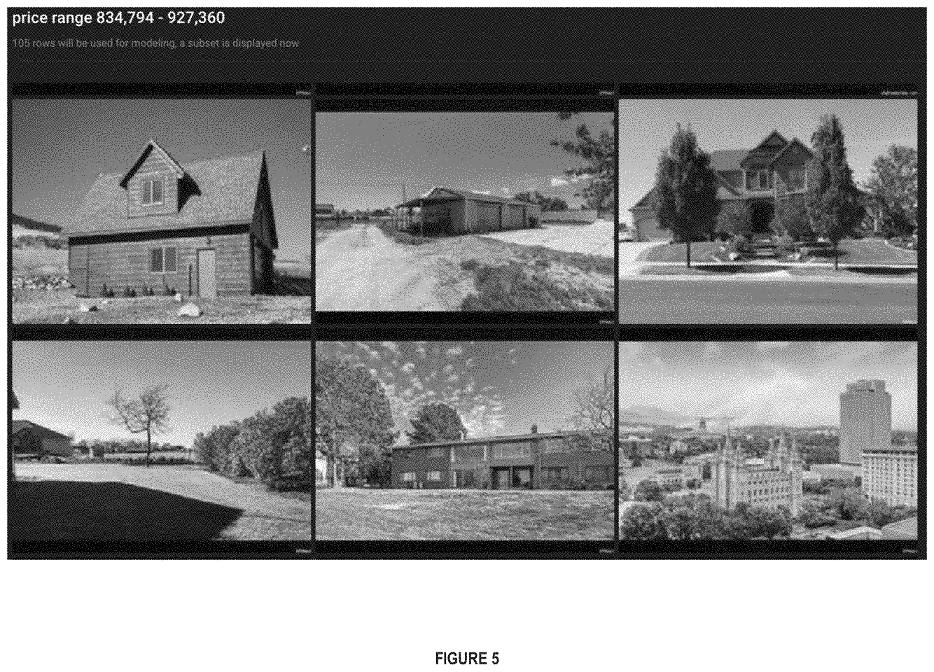

Referring now to FIGS. 6-9, some examples of model building operations are described. When the user uploads the input data, specifies the target, and initiates the operation of the model development system 100, the system may automatically partition the input data set into training, validation, and holdout sets, and generate a set of modeling blueprints tailored to the input data set.

FIG. 6 shows an example of a blueprint 600 that the model development system 100 can use to develop a model 650 that estimates the prices (e.g., market values) of units of residential real estate (e.g., houses) based on the above-described “residential real estate” data set. The model 650 may be any suitable type of data analytics model including, without limitation, a regression model (e.g., an eXtreme Gradient Boosted Trees Regressor (Gamma Loss), with or without early stopping). The target of the model 650 may be the price of a house (e.g., the “price” variable of the residential real estate data set), and the features (641-645) of the model may be engineered features derived from the data set. The model development system 100 may engineer the features (641-645) of the model 650 using the techniques described below.

In accordance with the blueprint 600, the model development system 100 may use a pre-trained image feature extraction model (604) to extract a set of image features (e.g., an image feature vector) from each of the images in the data set (e.g., the photographs of houses, identified in the columns labeled “exterior_image,” “kitchen_image” and “bedroom_image” in FIG. 2A). The pre-trained image feature extraction model 604 may have any suitable architecture, for example, a SqueezeNet Multi-Level Global Average Pooling (GAP) architecture. The model development system 100 may train models (614) to estimate the prices of the houses based on, respectively (1) the image feature vectors extracted from the “exterior” images, (2) the image feature vectors extracted from the “kitchen” images, and (3) the image feature vectors extracted from the “bedroom” images. Each of the models (614) may be any suitable type of data analytics model including, without limitation, a regression model (e.g., an Elastic Net Regressor (L2 normalization/Gamma Deviance)). The price estimates (615) generated by the models (614) may be rescaled (624) (e.g., rescaled such that each price estimate feature has a mean of 0 and a standard deviation of 1) to produce rescaled price estimate features 644 corresponding the respective image feature vectors. The individual, rescaled price estimate features 644 may be used as features of the model 650. Alternatively, in some embodiments, the price estimates 615 may be combined prior to rescaling, or the rescaled price estimates may be combined to produce a single price estimate feature based on all the image feature vectors. Any suitable technique may be used to combine the price estimates 615 or rescaled price estimates including, without limitation, averaging the values, selecting the maximum value, selecting the minimum value, etc. In such cases, the combined, rescaled price estimate feature 644 may be used as a feature of the model 650.

In accordance with the blueprint 600, the model development system 100 may perform ordinal encoding (601) with respect to the data set's categorical variables. The resulting encoded categorical feature values (641) may be used as features of the model 650.

In accordance with the blueprint 600, the model development system 100 may perform geospatial location conversion (602) (e.g., location extraction or coordinate extraction) with respect to values of the data set's geospatial (location) variable. In addition, the model development system may use the extracted location features and the values of the data set's numeric variables to extract spatial neighborhood features (612) from each data sample. The extracted location features and spatial neighborhood features for each sample may be combined to form a set of location-aware feature (642), which may be used as features of the model 650.

In accordance with the blueprint 600, the model development system 100 may perform missing value imputation (603) and difference detection (613) with respect to the data set's numeric variables. The resulting numerical values may be combined (623) to form a set of numeric features (643), which may be used as features of the model 650.

In accordance with the blueprint 600, the model development system 100 may extract one or more text-based features (645) from the data set's text variables. Any suitable techniques may be used to extract the text-based features (645). Some non-limiting examples of suitable techniques for extracting text-based features are described, for example, in International Patent Publication No. WO 2020/124037. For example, text mining (605) may be performed on one or more of the data set's text variables, and the results may be combined (615) into a combined mined text feature 645. In some embodiments, the text mining may be performed by an auto-tuned word n-gram text modeler using token occurrences. The combined mined text feature may be used as a feature of the model 650.

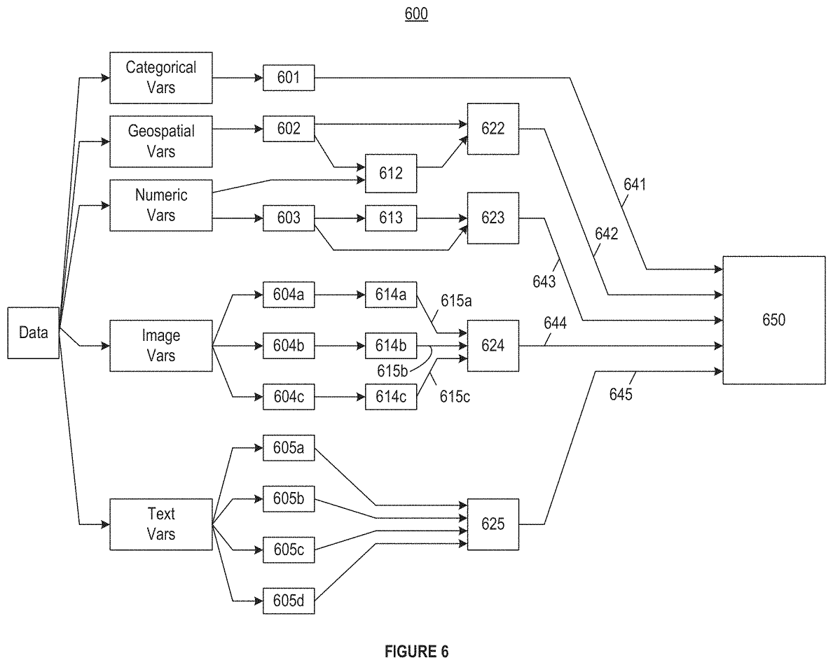

To promote model diversity, some embodiments of the model development system 100 generate multiple blueprints using different preprocessing techniques and machine learning algorithms. Some non-limiting examples of other blueprints that may be used to generate models suitable for estimating the prices of houses based on the “residential real estate” data set are summarized in FIG. 7. This approach allows users to maintain their preferred modeling techniques (e.g., linear, tree-based, or kernel-based models) to ensure compliance, while also leveraging the added accuracy from using image data.

Additional diversity and accuracy may be achieved by automatically combining multiple approaches to image modeling, for example: (1) using pre-trained image feature extraction models for image feature extraction, (2) using pre-trained, fine-tunable image processing models (e.g., for image feature extraction), (3) using traditional computer vision features (e.g., local descriptors), (4) using raw pixel data directly, (5) using one or more well-known model architectures (SqueezeNet, ResNet, VGG16, EfficientNet, etc.), (6) performing neural architecture search (NAS), (7) using flexible image augmentation strategies (e.g., generating modified copies of the training images to enrich the training dataset and provide additional robustness to rotations, color changes, perspective changes), etc.

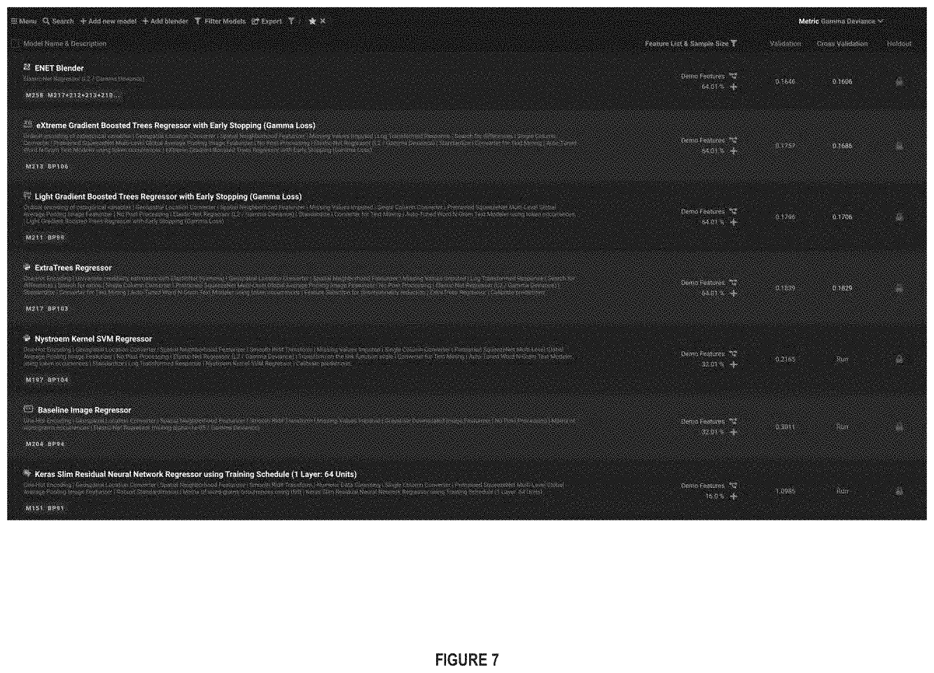

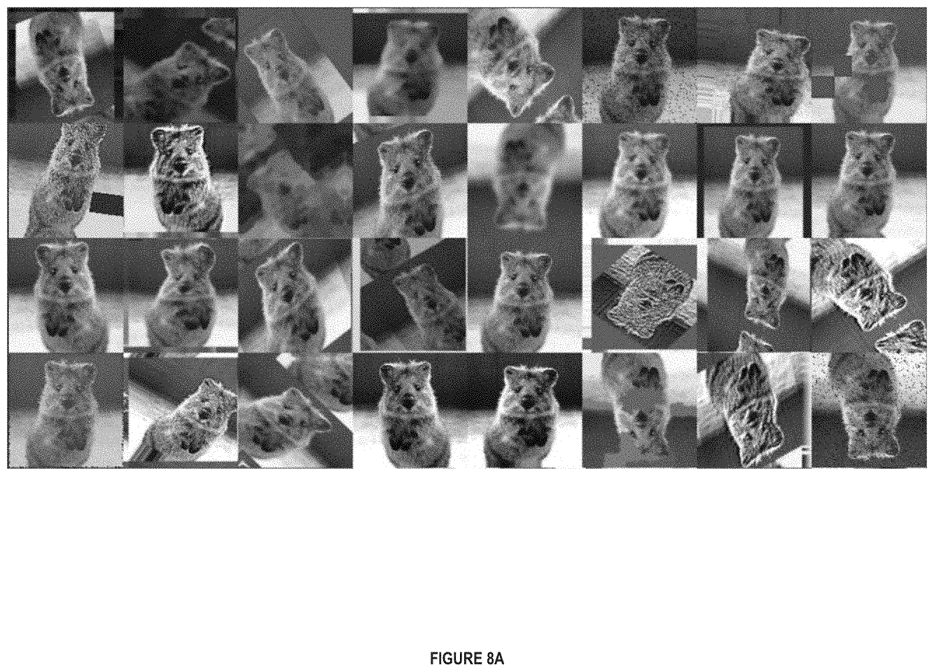

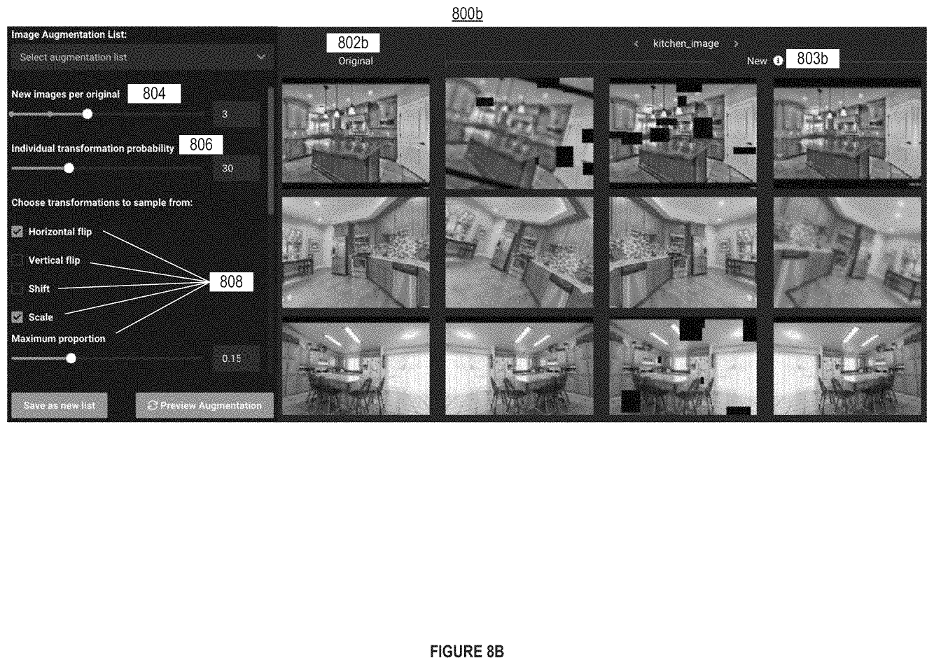

Some non-limiting examples of suitable image augmentations are illustrated in FIG. 8A, which shows a number of augmented images of a furry animal. Each modified image can be used as training data to train a data analytics model, so that the model is able to accurately accommodate variations in image type or quality (e.g., due to variations in lighting, exposure, camera orientation, physical obstructions, etc.).

In some instances, for example, a significant number of training images may be needed to obtain good modeling results and prevent overfitting; however, obtaining an adequate supply of training images can be difficult. For example, the images may be costly or difficult to obtain in the field, or may be costly to annotate. In general, image augmentation is a process of creating new artificial training examples by introducing slight modifications to existing examples, as shown in FIG. 8A.

Advantageously, some embodiments include an image augmentation tool that can provide a user with better control over and a better understanding of the image augmentation process. The image augmentation tool can allow users to avoid use of certain image augmentation techniques that may be harmful for some modeling problems. For example, a horizontal flip can be an undesirable augmentation when the user wants to distinguish between “E” and “3.” Likewise, shifting and scaling augmentations may be undesirable when the images are expected be properly centered and/or consistently scaled in production. The image augmentation tool can make the augmentation process visual and customizable, with a “what you see is what you get” approach. The tool may provide a user interface (UI) whereby users can select the types of augmentation operations to be performed, switch between different sets of image augmentation operations, and compare the effects (e.g., modeling accuracy, model-training efficiency) of each approach.

For example, the UI may provide interface elements whereby the user can specify individual augmentation settings (e.g., “augmentation lists”) for each image variable (e.g., image column) in a data set. The ability to specify customized augmentation lists for different image variables can be very useful, particularly when different image variables illustrate different aspects of a data sample (e.g., images that show the floor plans of houses vs. exterior images of houses).

As another example, the UI may provide interface elements whereby the user can specify default augmentation settings for all blueprints used to build models during an automated modeling session of the model development system 100. In some embodiments, the UI may provide interface elements whereby the user can select a trained model and initiate retraining (or “tuning”) of the model using the original training data set with a new augmentation list.

The image augmentation tool may be suitable for use not only with homogeneous image data sets, but also with heterogeneous data sets. To augment an image in a heterogeneous data set, the image augmentation tool may replicate the data sample that contains the original image, then replace the original image with the augmented image in the replicated sample. This process of data sample replication and augmented image substitution may be repeated for each augmented version of each image of each data sample.

For example, FIGS. 8B and 8C show screenshots (800b, 800c) of an embodiment of a graphical user interface (UI) for an image augmentation tool. In the depicted example, the image augmentation tool's UI displays a set of original images 802. In particular, FIG. 8B shows a set of original kitchen images 802b, and FIG. 8C shows a set of original bedroom images 802c. A row multiplier interface element 804 allows the user to specify how many new or augmented versions of each original kitchen_image will be created. The user can specify an individual transformation probability value via another interface element 806. In general, the individual transformation probability value can be or represent a likelihood that one or more transformation techniques will be applied to an original image when creating one of the corresponding images. For example, when the individual transformation probability value is 50%, the individual likelihood of each of the selected transformation technique being performed when creating the corresponding image can be 50%.

The image augmentation tool can include one or more interface elements (e.g., radio buttons, check boxes, etc.) (808, 810) that allow a user to select one or more transformations from a set of available transformations, which can include, for example, horizontal flip, vertical flip, shift (e.g., translate center of image to a different location), scale (e.g., zoom in or out), rotate, blur, cutout (e.g., remove one or more portions of the image), etc. When a particular transformation technique has been selected, the user may be given an option to specify one or more parameters associated with the technique. For example, the user can specify a degree of rotation, an amount of blur, and/or a number of cutouts to be used when generating the modified images. As the new images are created, thumbnail versions 803 of the augmented images can be presented adjacent to the original images, thereby allowing the user to review the quality and/or content of the new images and/or to make any desired changes to one or more settings in the image augmentation tool.

Some non-limiting examples of image modification operations that the model development system 100 can perform to generate augmented images have been described. In some embodiments, the model development system 100 can perform one or more other image modification operations including, without limitation, MixUp, CutMix, changing the image's color space (e.g., changing contrast, performing histogram equalization, changing white balance, converting the color space to grayscale or sepia, applying image filters known to one of ordinary skill in the art, shuffling channels, applying an RGB/HSL/gamma shift, etc.), compressing the image (e.g., JPEG compression), downscaling, upscaling, randomly cropping, injecting noise (e.g., Gaussian noise, applying kernel-based filters (e.g., emboss, sharpen, etc.), applying weather effects (e.g., shadow, rain, snow, sun flare, etc.), converting images into edges, GAN-based augmentations, etc. As discussed above, different set of image modification operations (“image augmentation lists”) can be specified for different image variables in the data set.

Some embodiments of an image augmentation tool have been described. More generally, some embodiments of the model development system 100 may include one or more feature augmentation tools, of which the image augmentation tool is one example. Other examples of feature augmentation tools may include an audio augmentation tool and text augmentation tool. Each feature augmentation tool may provide a user interface (UI) whereby users can specify customized lists of augmentation operations for any variables of a particular data type.

For example, an audio augmentation tool can include one or more interface elements that allow a user to select one or more audio transformations from a set of available transformations, which can include, for example, applying various filters to the audio signal, injecting various types of noise into the audio signal, converting audio speech to text, generating synthetic speech for the converted text (e.g., speech with a particular accent), etc. When a particular audio transformation technique has been selected, the user may be given an option to specify one or more parameters associated with the technique (e.g., the type of audio filter to be used, the type of noise to be injected, the type of accent to be used in the synthetic speech, etc.).

As another example, a text augmentation tool can include one or more interface elements that allow a user to select one or more text transformations from a set of available transformations, which can include, for example, translating the text into one or more other languages, translating the translated text back into the original language, etc. When a particular text transformation technique has been selected, the user may be given an option to specify one or more parameters associated with the technique (e.g., the language(s) into which the text is translated, etc.).

For embodiments of the model development system that use pre-trained image processing models (e.g., pre-trained image feature extraction models or pre-trained, fine-tunable image processing models) for feature extraction, the problem of domain adaptation is important. Different levels of image features may be more or less suitable for the development of models for different problem domains. Depending on the user's data set, the image processing model may produce a suitable combination of features on a range from highly generic (low level) features to highly specialized (high level) features. Some embodiments automatically tune the level of feature specificity to promote optimal adaptation to the user's domain. In this way, the model development system 100 may generate models that are adapted to different problem domains.

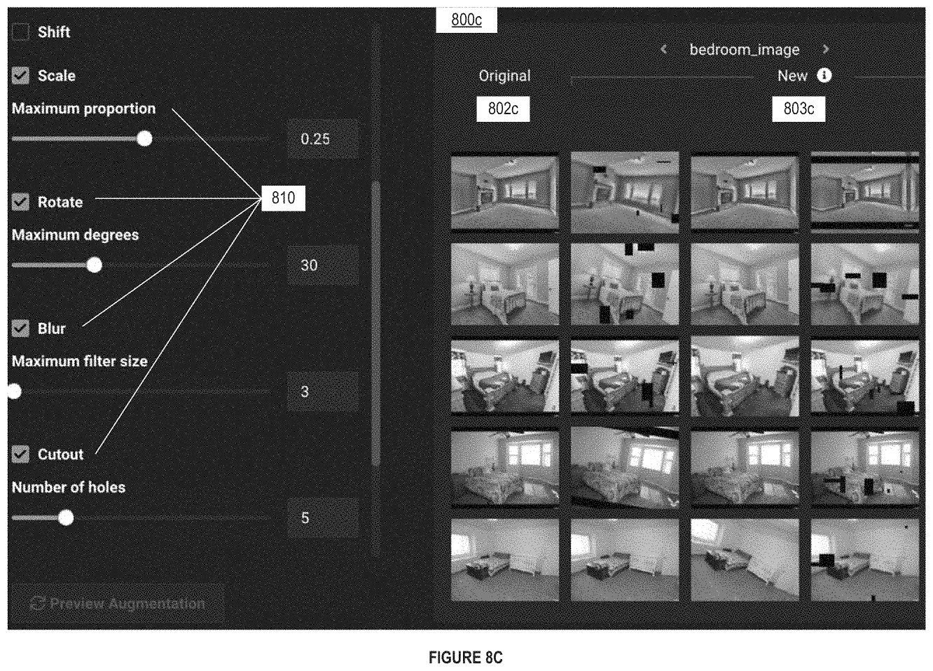

FIG. 9 shows an example of a user interface for tuning a pre-trained image processing model. In the example of FIG. 9, the system has automatically decided to skip the most generic features (use_low_level_features=False) and use more specific features to adjust to the real estate domain (use_high_level_features=True, use_highest_level_features=True, use_medium_level_features=True). In some embodiments, the user can override the default settings for the specificity of image features extracted by the image processing model.

Some embodiments automatically create model ensembles for additional accuracy improvements. These ensembles may be referred to as blenders or stacks (e.g., stacks of models). Blenders can strengthen the output of the individual models that are generated using differing underlying prediction strategies and algorithms. For example, one model may be good at identifying a certain type of visual object, and another model may be good at identifying a different type of visual object. Some embodiments provide different types of blenders that can combine the votes of individual models (resulting in improved accuracy) or even build a 2nd-level model on top of individual model predictions.

Unlike systems that require or recommend GPU hardware, some embodiments of the model development system 100 can run image blueprints on commodity hardware and still achieve high accuracy by utilizing data efficiently. This improved computation efficiency is the result of automated data science decisions and diverse model usage. Specifically, by turning computer vision into a data analytics modeling (e.g., predictive modeling) problem, some embodiments of the model development system are able to identify the best problem-specific data analytics models more efficiently (relative to conventional techniques for training and tuning models for computer vision applications). Experiments have shown that some embodiments can achieve the same accuracy on the same data 5 times faster on commodity hardware as a conventional CV system does on a GPU supercomputing station. For users, this means shorter time-to-value and significantly reduced capital expenditures.

4.4. Image Processing Models

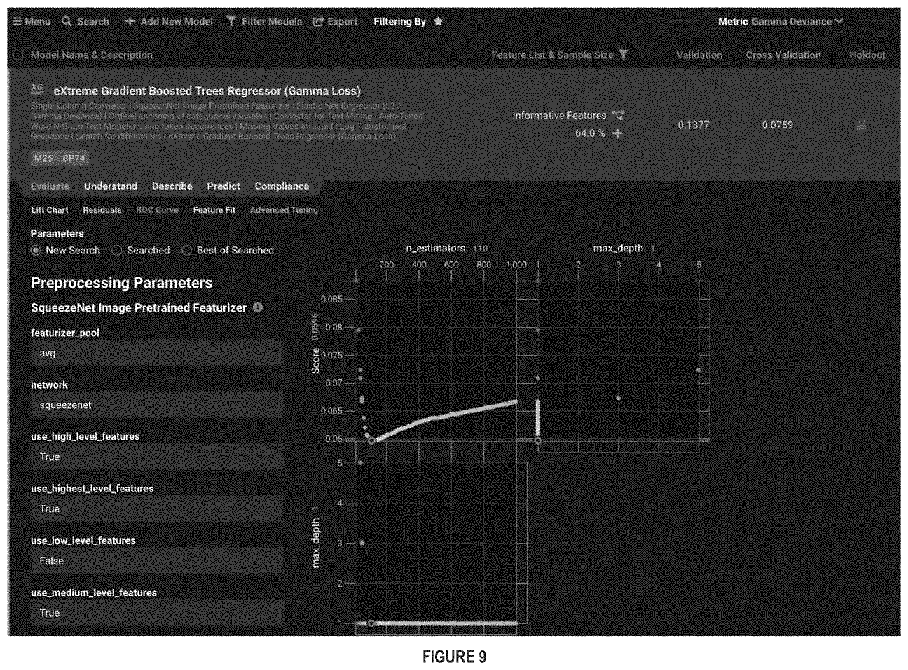

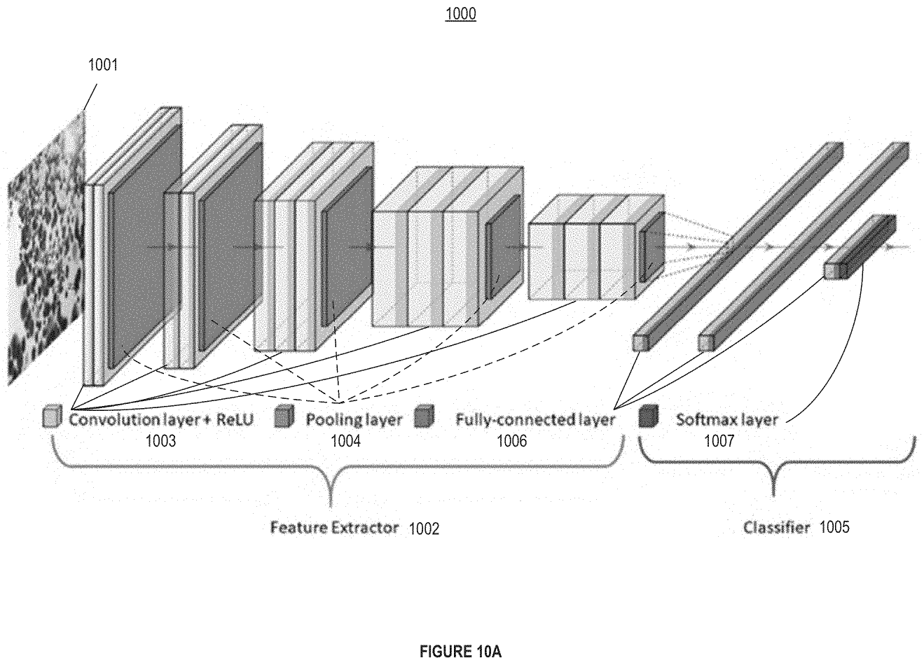

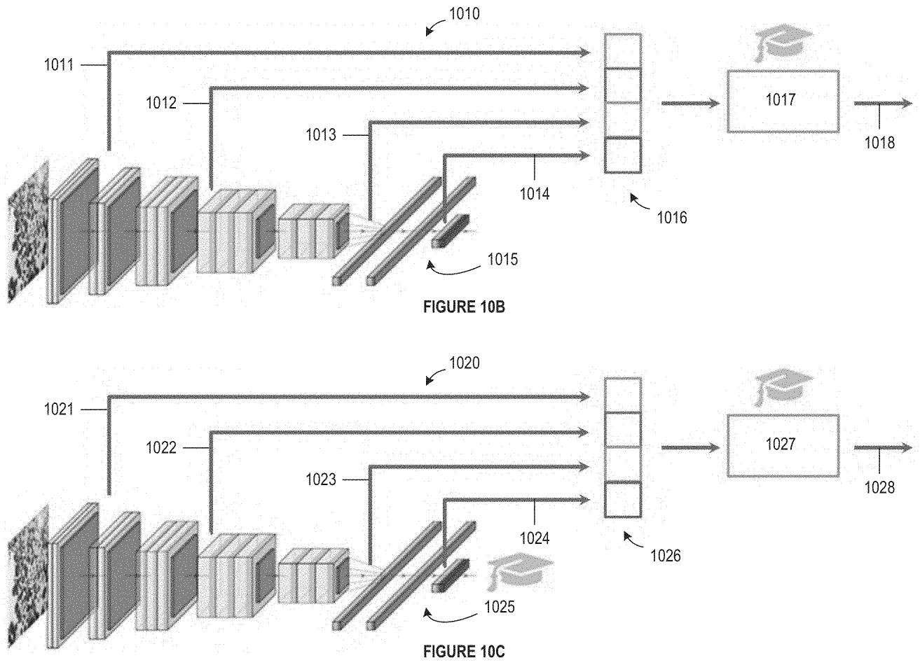

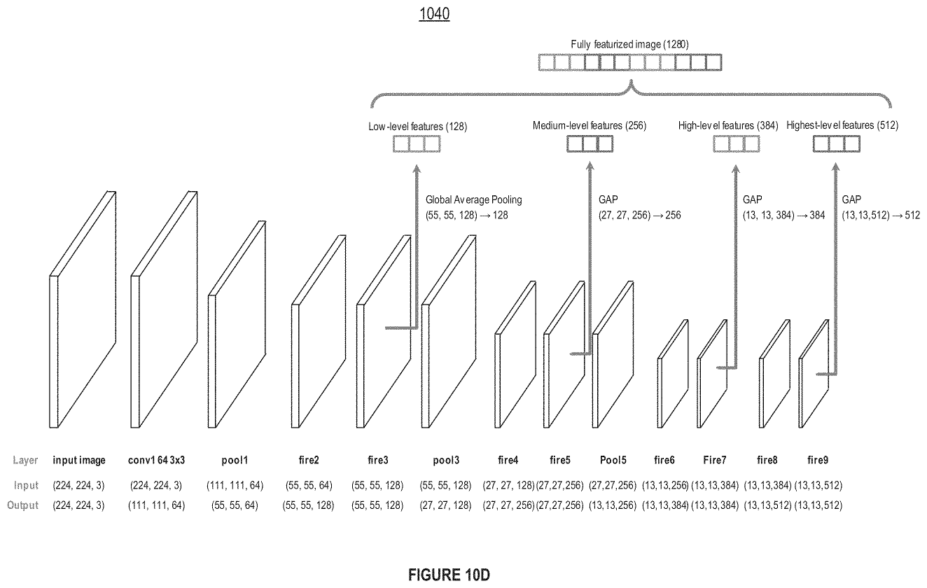

Referring to FIG. 10A, an image processing model may be or include a neural network 1000 (e.g., a convolutional neural network or “CNN”) trained to extract features (e.g., low-, mid-, high-, and/or highest-level features) from images 1001 and perform one or more computer vision tasks (e.g., image classification, localization, object detection, object segmentation, etc.) based on one or more of the extracted features. In the example of FIG. 10A, the upstream portion of the neural network 1000 functions as a feature extractor 1002, and the downstream portion of the neural network functions as a classifier 1005. More generally, the downstream portion of the neural network may be trained to perform data analytics operations other than classification. In the example of FIG. 10A, the feature extractor portion of the neural network 1000 includes a sequence of multi-layer blocks, each of which includes one or more convolution layers 1003 with rectified linear unit (ReLU) activation functions followed by a pooling layer 1004. Other suitable activation functions may be used. Each successive pooling layer 1004 outputs higher-level image features. In the example of FIG. 10A, the classifier portion of the neural network 1000 includes a sequence of fully connected layers 1006 followed by a Softmax layer 1007.

The neural network architecture shown in FIG. 10A is just one example of a neural network architecture that may be suitable for use in an image processing model. Any suitable neural network architecture may be used (e.g., VGG16, ResNet50, etc.).

4.4.1. Pre-Trained Image Feature Extraction Models

In some embodiments, an image processing model may be configured as a pre-trained image feature extraction model. An example of a pre-trained image feature extraction model 1010 is shown in FIG. 10B. In the example of FIG. 10B, low-level image features 1011 are the outputs of the first pooling layer, mid-level image features 1012 are the outputs of the third pooling layer, and high-level image features 1013 are the outputs of the fifth pooling layer. In the example of FIG. 10B, the highest-level image features 1014 are the inputs to the final fully-connected layer. Other mappings of neural network layer outputs to image feature sets are possible. Each set of image features (1011-1014) may be a set of numeric values, and the individual sets of image feature may be concatenated to form an image feature vector 1016 of numeric values.

In the pre-trained image feature extraction model 1010, the layers of the upstream portion 1002 and downstream portion 1005 of the neural network may be pre-trained. Thus, when used in a model development system 100, a pre-trained image feature extraction model 1010 may extract (or “derive”) image feature values from image training data without any layers of the neural network being trained or tuned on that image training data. In other words, the pre-trained image feature extraction model 1010 may be configured such that no layer of model's neural network learns during the model development process carried out by the model development system 100. Rather, as shown in FIG. 10B, the image feature vector 1016 may be used an input feature of a data analytics model 1017, and the model development system 100 may train that data analytics model 1017 to perform a data analytics task (e.g., to provide an inference 1018) based (at least in part) on the image feature vector 1016.

In some embodiments, one or more (e.g., all) neural network layers that are only used to train the network (e.g., Batch Normalization layers) may be removed from neural networks that are used as (or included in) pre-trained image feature extraction models. As discussed above, pre-trained image feature extraction models may be configured such that they do not learn during the model development process carried out by the model development system 100. In such scenarios, network layers that are only useful for learning (e.g., for training or tuning the network) are unnecessary. Removing such layers can eliminate a significant amount of otherwise wasteful computation performed by the model 1010. In general, removing such layers may increase the speed of the neural network's inference operation by a factor of 2× to 2.5×, and can reduce the neural network's RAM usage by roughly the same amount.

4.4.2. Pre-Trained Fine-Tunable Image Processing Models

In some embodiments, an image processing model may be configured as a pre-trained, fine-tunable image processing model. An example of a pre-trained, fine-tunable image processing model 1020 is shown in FIG. 10C. In the example of FIG. 10C, low-level image features 1021 are the outputs of the first pooling layer, mid-level image features 1022 are the outputs of the third pooling layer, and high-level image features 1023 are the outputs of the fifth pooling layer. In the example of FIG. 10C, the highest-level image features 1024 are the inputs to the final fully-connected layer. Other mappings of neural network layer outputs to image feature sets are possible. Each set of image features (1021-1024) may be a set of numeric values, and the individual sets of image feature may be concatenated to form an image feature vector 1026 of numeric values.

In the pre-trained, fine-tunable image processing model 1020, the layers of the upstream portion 1002 of the neural network may be pre-trained, but the layers of the downstream portion 1005 of the neural network may be tunable. Thus, when used in a model development system 100, a pre-trained, fine-tunable image processing model 1020 may extract (or “derive”) image feature values from image training data without any layers of the upstream portion 1002 of the neural network being trained or tuned on that image training data. However, during the model development process carried out by the model development system, the downstream portion 1005 of the model's neural network may be trained or tuned on the image training data, such that the highest-level image features 1024 produced by the image processing model 1020 are specifically adapted to the computer vision problem or data analytics problem that is being solved by the model development system 100. As shown in FIG. 10C, the image feature vector 1012 may be used an input feature of a data analytics model 1027, which may be trained to perform a data analytics task (e.g., trained to provide an inference 1028) based (at least in part) on the image feature vector 1026. Alternatively, if the data set contains only image data, the downstream portion 1005 of the model's neural network may be trained or tuned to provide the inference 1028 directly, without using a separate data analytics model 1027.

4.4.3. Example Image Processing Model

An example of an image processing model 1040 is shown in FIG. 10D. In the example of FIG. 10D, the image processing model 1040 includes a SqueezeNet neural network. In the example of FIG. 10D, the fire3, fire5, fire7, and fire9 layers of the neural network are Global Average Pooling (GAP) layers, and the outputs of those GAP layers are the model's low-level, medium-level, high-level, and highest-level image features, respectively. In the example of FIG. 10D, there are 128 low-level image features, 256 medium-level image features, 384 high-level image features, and 512 highest-level image features. Thus, the concatenated image feature vector includes 1,280 individual image features.

4.5. Additional Insights

To perform modeling tasks or data analytics tasks in a particular domain (e.g., to solve a particular modeling problem or data analytics problem), users often prefer to use a particular machine-learning model. For example, to estimate the value of a home, a property insurer may wish to use a particular type of machine-learning model. For instance, the property insurer may wish to use a relatively simple, computationally-efficient, and inexpensive machine-learning model to estimate home values.

However, in some cases, input data provided for use in home value estimation may be of a more complex data type, such as, for example, an image data type. The particular machine-learning model used by the property insurer may not be well-suited for ingesting such relatively complex input data. Specifically, relatively simple and computationally-efficient machine-learning models are often not well-suited for analyzing input data having complex data types, such as the image data type.

Instead, more complex machine-learning models, such as neural networks, can be used to perform modeling tasks based on input data having complex data types. Neural networks may be well-suited for extracting features from input data having the image data type. However, as mentioned above, many users may prefer to use a particular, simpler machine-learning model to generate predictions. Additionally, training more complex machine-learning models, such as neural network models, can be time-intensive and computationally inefficient. For instance, training a neural network model can require many more training data samples (e.g., on the order of thousands of training data samples) relative to training a simpler machine-learning model (e.g., on the order of hundreds of training data samples). This increased quantity of training data samples be difficult to obtain. Furthermore, in many cases, each training data sample must be labeled prior to use in training. Oftentimes, such labeling occurs manually, and thus the labeling process may require significant human resources. Even further, complex machine-learning models, such as neural network models, can require significant hardware and computational processing capabilities. As a result of these challenges posed by more complex machine-learning models, such as neural network models, alternative solutions for performing modeling tasks and data analytics tasks based on data having the image data type are needed.

As described above, one of the principle inefficiencies associated with complex machine-learning models such as neural networks is the process of training the complex machine-learning models. Conventional knowledge among those skilled in the art is that repurposing a neural network model previously trained to perform task T1 in domain D1, for use in performing task T2 in domain D1 or in a different domain D2, does not yield accurate results for task T2. However, contrary to conventional knowledge, the inventors have discovered that pre-trained complex models (e.g., neural networks) can be repurposed to extract features for modeling tasks or data analytics tasks that differ from the tasks for which the complex models (e.g., neural networks) were trained (e.g., for tasks in domains that differ from the domains in which the complex models were trained).

In other words, the inventors have discovered that complex models (e.g., neural networks) or portions thereof (e.g., layers thereof) can be repurposed as pre-trained image feature extraction models used in the first stage of the above-described multi-stage (e.g., two-stage) models. For a specific modeling task or data analytics task, the performance of a multi-stage (e.g., two-stage) model that uses a repurposed neural network model as a pre-trained image feature extraction model is generally approximately equal to the performance of a neural network custom-trained for the specific task. The inventors have hypothesized that repurposing a pre-trained neural network in this manner is effective because the process of training the neural network to perform a task in a given data processing field (e.g., computer vision, natural language processing, speech processing, text processing, auditory processing, etc.) generally teaches the neural network to identify and extract a widely-applicable (e.g., fundamental or universal) set of features from a sample set of field-specific data (e.g., image data, natural language data, speech data, text data, auditory data, etc.), irrespective of the specific task for which the neural network is trained. This basic learning of field-specific fundamental feature extraction by the neural network, regardless of the specific task for which the neural network is trained, can be leveraged for use by other machine learning models solving other tasks in the same field or even in other fields.

In the context of image processing, the inventors have observed that neural networks trained to extract image features in for a task T1 in a computer vision domain D1 can be used to extract image features for a different task T2 in the domain D1, in a different computer vision domain D2, or in other fields of data analytics that can derive useful information from image data. This successful repurposing of neural networks both eliminates the inefficiencies of training a new neural network for the task T2, and enables users to rely on their particular, preferred machine-learning models for modeling tasks or data analytic tasks, even when the tasks involve analysis of image data.

In some embodiments, a two-stage model 130 generated by the model development system may perform a modeling task or data analytics task as follows:

Obtain an inference data sample including image data. In some embodiments, the inference data sample also includes non-image data.

In stage 1 of the two-stage model 130, extract respective values for a plurality of constituent image features from the image data using a pre-trained image processing model. The pre-trained image processing model may be or include, for example, a pre-trained image feature extraction model or a pre-trained, fine-tunable image processing model. Some embodiments of pre-trained image processing models are described below in the section titled “Image Processing Models.” In some embodiments, the pre-trained image processing model has been previously trained on image data from a different domain than the image data in the inference data sample. In alternative embodiments, the pre-trained image processing model has been previously trained on image data from the same domain as the image data in the inference data sample.

Replace the image data with the extracted, respective values of the constituent image features in the inference data sample, thereby generating an updated data sample.

In stage 2 of the two-stage model, apply a machine-learning model to the updated data sample, thereby generating a modeling result or data analytics result for the data sample based at least in part on the constituent image features extracted from the image data by the pre-trained, stage 1 model.

Using this improved method, image-based modeling tasks or data analytics tasks can be performed while still using the preferred machine-learning model, and while improving computational efficiency of the model generation process (particularly in embodiments in which pre-trained image feature extraction models are used).

### 5. Model Deployment System

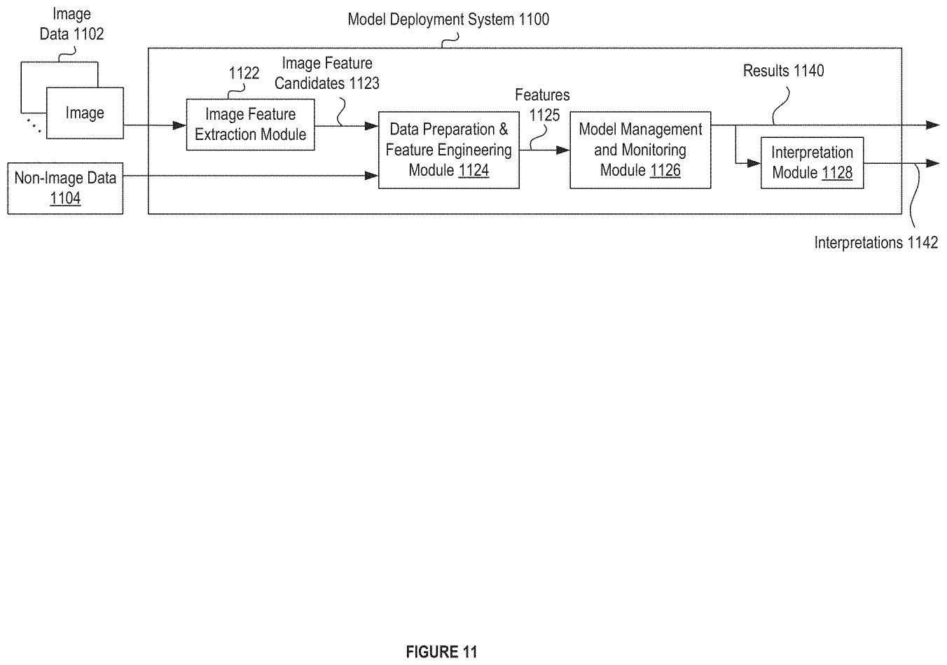

In some embodiments, the above-described model development system 100 provides a user interface whereby the user can select a blueprint and automatically deploy the blueprint to a model deployment system (e.g., a dedicated, high-throughput prediction environment). In some embodiments, the blueprint may be deployed in one click. Referring to FIG. 11, in some embodiments, a model deployment system 1100 may include an image feature extraction module 1122, a data preparation and feature engineering module 1124, a model management and monitoring module 1126, and an interpretation module 1128. In some embodiments, the model deployment system 1100 receives inference data and processes the inference data using one or more models (e.g., image processing models, machine learning models, etc.) to solve a problem in a domain of computer vision or data analytics. The inference data may include image data 1102 (e.g., one or more images). Optionally, the inference data may also include non-image data 1104. Some embodiments of the components and functions of the model deployment system 1100 are described in further detail below.

The image feature extraction module 1122 may perform one or more computer vision functions on the image data 1102. In some embodiments, the image feature extraction module 1122 performs image pre-processing and feature extraction on the image data 1102, and provides the extracted features to the data preparation and feature engineering module 1124 as image feature candidates 1123. The extracted features may include unmodified portions of the image data 1102, low-level image features, mid-level image features, high-level image features, and/or highest-level image features. Some embodiments of suitable techniques for extracting image feature candidates are described above with reference to image feature extraction module 122.

In some embodiments, the image feature extraction module 1122 may perform image pre-processing and feature extraction using one or more image processing models. Some embodiments of image processing models are described below in the section titled “Image Processing Models.” As described in further detail below, image processing models may include pre-trained image feature extraction models and/or pre-trained fine-tunable image processing models. In some embodiments, the image feature extraction module 1122 uses a pre-trained image feature extraction model to extract image features from the image data 1102. In some embodiments, the image feature extraction module 122 uses a pre-trained, fine-tunable image processing model to extract image features from the image data 1102.

The data preparation and feature engineering module 1124 may perform data preparation and feature engineering operations with respect to the image feature candidates 1123 and the non-image data 1104 to generate a set of features 1125, which may be provided as inputs to a deployed model (e.g., the second stage of two-stage model 130) managed by the model management and monitoring module 1126. Some embodiments of suitable techniques for performing data preparation and feature engineering operations are described above with reference to data preparation and feature engineering module 124 and/or in the section titled “Data Preparation and Feature Engineering.”

The model management and monitoring (“MMM”) module 1126 may manage the application of a deployed model (e.g., the second stage of a two-stage model 130) to the features 1125 extracted or derived from the inference data, thereby solving the computer vision problem or data analytics problem and producing results 1140 characterizing the solution. In some embodiments, the model management and monitoring module 1126 may track changes in data (including image data) over time (e.g., data drift) and warn the user if excessive data drift is detected. In addition, the MMM module may be capable of retraining a deployed model (e.g., rerunning the model blueprint on new training data) and/or replacing a deployed model with another model (e.g., the retrained model). Retraining and/or replacement of a deployed model may be manually initiated by the user (e.g., in response to receiving a warning that excessive data drift has been detected) or automatically initiated by the MMM module (e.g., in response to detecting excessive data drift). Some non-limiting examples of techniques for detecting drift in image data are described below in the section titled “Drift Detection.”

The interpretation module 1128 may interpret the relationships between the results 1140 (e.g., inferences) provided by the model deployment system 1100 and the portions of the image data 1102 on which those results 1140 are based, and may provide interpretations (or “explanations”) 1142 of those relationships. In some embodiments, the interpretation module 1128 may provide such interpretations by performing one or more of the operations described below in the section titled “Image Processing Model Explanations.”

For example, the interpretation module 1128 may provide one or more of the following types of interpretations:

Feature importance. By deriving numeric image feature vectors from images and providing those numeric image feature vectors as inputs to data analytics models, some embodiments make it possible for the feature importance of image features and non-image features (e.g., tabular features or other non-tabular features) to be quantified using the same technique, and thereby make it possible for the feature importance of image features and non-image features to be directly compared. Some non-limiting examples of techniques for determining feature importance are described below in the section titled “Determining the Predictive Value of a Feature.”

Visual explanations of areas of interest in images. In some embodiments, the interpretation module 1128 provides visual explanations of areas of interest in images (e.g., “visual image inference explanations” or “image inference explanations”). For example, the interpretation module 1128 may provide image inference explanation visualizations highlighting the regions of images that the model considers important for making inferences, regardless of the algorithmic nature of the data analytics model. For example, in some embodiments, the data analytics model for which visual image inference explanations are provided can be a deep learning model, while in other embodiments the data analytics model for which visual image inference explanations are provided is not a deep learning model. In other words, some embodiments may provide model-agnostic visual image inference explanations. Some non-limiting examples of techniques for visual image inference explanations are described below in the section titled “Determining the Predictive Value of a Feature.”

User interface tools for “drilling down” into specific model inferences. In some embodiments, the interpretation module 1128 provides a user interface for drilling down into specific model inferences (e.g., erroneous model inferences). This user interface may enable the user to see the examples of image data for which a specific target was predicted or for which the data sample had a specific ground truth value.

An example of a model deployment system 1100 specifically configured for deployment of models that operate on image data 1102 has been described. More generally, the model deployment system 1100 receives inference data and provides the inference data to a modeling pipeline that uses one or more models (e.g., computer vision models, natural language processing models, speech processing models, audio processing models, time-series models, data analytics models, etc.) to solve a problem in a domain of modeling or data analytics. The inference data may include first data (e.g., non-tabular data, for example, image data, natural language data, speech data, text data, auditory data, spatial data, and/or time series data). Optionally, the inference data may also include second data (e.g., tabular data or additional non-tabular data of any suitable type).

An example of a model deployment system 1100 that includes an image feature extraction module 1122 has been described. More generally, the model deployment system may include a feature extraction module operable to extract feature candidates based on first data. In general, the feature extraction module may use a pre-trained feature extraction model to extract the feature candidates. In some embodiments, the feature extraction model includes a neural network. In some embodiments, the neural network is a deep neural network that extracts a hierarchy of features (e.g., low-level features, mid-level features, and/or high-level features) from the first data. For example, the feature extraction module may include a pre-trained audio feature extraction model, which may extract audio features (e.g., low-, medium-, high-, and/or highest-level audio features) from audio data. As another example, the feature extraction module may include a pre-trained text feature extraction model, which may extract text features (e.g., low-, medium-, high-, and/or highest-level text features) from text data and/or natural language data.

5.1. Drift Detection

Referring again to FIG. 11, in some embodiments, the model management and monitoring (“MMM”) module 1126 can assess the inference image data 1102 (or “scoring image data” 1102) for changes and deviation from the training image data 102 (or from earlier-provided inference image data) over time. To detect any changes or drift in the image data, the MMM module may individually assess the image feature candidates 1123 extracted from the image data (e.g., the image feature vectors (1016, 1026) extracted from the respective images) using (1) a specified binning strategy and drift metric for that image feature and/or (2) anomaly detection. The binning strategies available for use may include, without limitation, fixed width, fixed frequency, Freedman-Diaconis, Bayesian Blocks, decile, quartile, and/or other quantiles. Available drift metrics may include, without limitation, Population Stability Index (PSI), Hellinger distance, Wasserstein distance, Kolmogorov-Smirnov test, Kullback-Leibler Divergence, Histogram intersection, and/or other drift metrics (e.g., user-supplied or custom metrics).

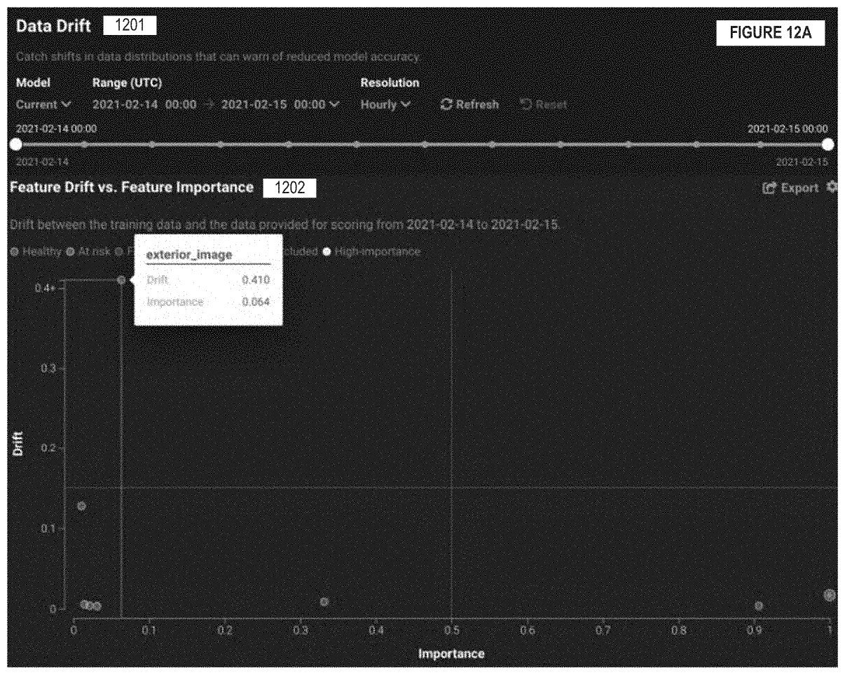

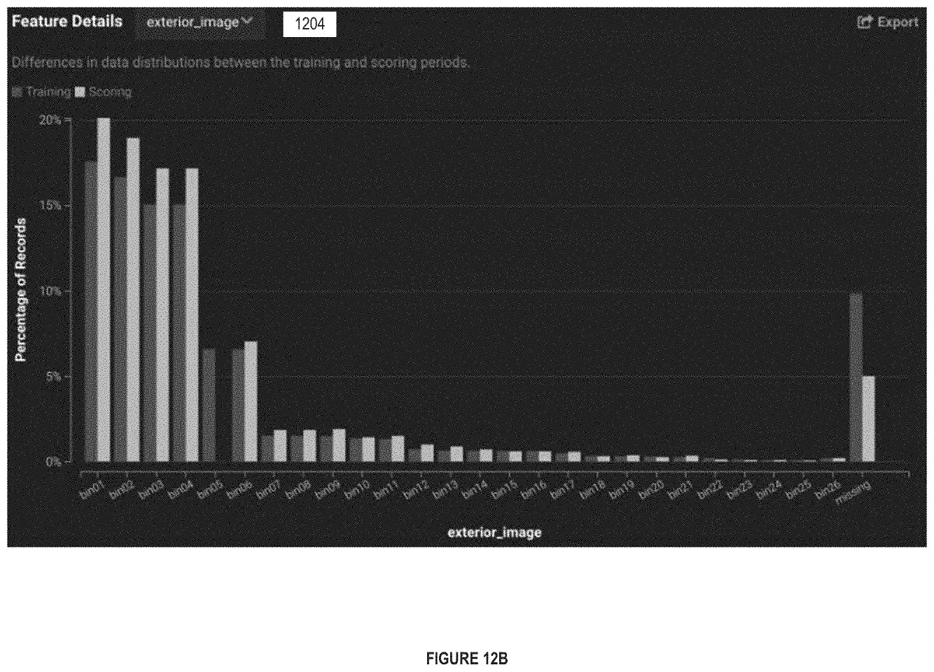

FIGS. 12A and 12B are screenshots of a user interface (UI) of the MMM module for displaying visualizations of data drift, according to some embodiments. A portion 1201 of the drift monitoring UI allows the user to specify the time period over which drift is assessed. In the example of FIG. 12A, the UI displays a scatter plot 1202. Each point in the scatter plot 1202 indicates the drift level and feature importance of a corresponding feature of the data set. Some non-limiting examples of techniques for calculating feature importance are described below in the section titled “Determining the Predictive Value of a Feature.” In some instances, the points in the scatter plot 1202 are color coded according to the importance of the corresponding feature and/or the amount of drift in the corresponding feature. For example, points having low values (e.g., low importance and/or low drift) can be coded green, points having medium values (e.g., medium importance and/or medium drift) can be coded yellow, and points having high values (e.g., high importance and/or high draft) can be coded red. In the example of FIG. 12A, the point corresponding to the image features derived from the exterior images is coded yellow because that image feature has relatively low importance (0.064) and its values are exhibiting medium drift (0.410).

In the example of FIG. 12A, the UI displays a histogram 1204, which can illustrate the distribution of feature values in the training data and in the scoring data for a specified feature. In the example of FIG. 12B, the histogram 1204 shows the distribution of normalized values of a numeric feature (“F_num”) derived from the image feature vectors (“F_vec”) (1016, 1026) extracted from the “exterior” images in the training data set (see the left-side histogram bars in the histogram bins) and the distribution of normalized values of the numeric feature derived from the image feature vectors (1016, 1026) extracted from the “exterior” images in a scoring data set (see the right-side histogram bars in the histogram bins). The value of the numeric feature F_num corresponding to an image feature vector F_vec can be derived from the feature vector using any suitable operation or transformation Z (e.g., F_num=Z(F_vec)), including (without limitation) principal component analysis (PCA), uniform manifold approximation and projection (UMAP), etc.

Referring again to FIG. 11, the MMM module 1126 can be configured to monitor the scoring data over time, for example, to detect systemic changes or trends occurring over consecutive or multiple time periods. In some examples, when drift in a particular feature or set of features from the scoring data is observed frequently (e.g., over multiple batches of scoring data or over multiple time periods (e.g., days, weeks, or months)), the MMM module 1126 can initiate a system effect protocol, which can assess the impact of this drift on the whole of the data. This can be accomplished by building a classifier (e.g., a covariate classifier, also referred to as a covariate shift classifier, a binary classifier, or an adversarial classifier) that can discriminate between the training data and the scoring data. If the classifier (or other AI model) can successfully tell the two datasets apart, then this can imply that the drift has had a system-wide effect. Once the impact of the drift has been assessed at both an individual and systemic level, a user of the system 100 can be alerted with a recommended course of action, or other corrective action can be taken or facilitated, as described herein.

In general, the covariate shift classifier can be used to distinguish between the training data and one or more sets of scoring data, for one or more features in the data (e.g., for numeric feature values extracted from image data). In certain examples, the feature values from the original training data can be concatenated to the feature values from the scoring data from specific batches or periods of time where individual feature drift has been identified. This can result, for example, in a new dataset having the feature values from the original training data, which can be labeled “Class 1,” and the features values from the scoring data from a time period T, which can be labeled “Class 0.” In various examples, any names or labels can be chosen for the target as long as the training data is allocated to one of the classes and the scoring data is allocated to the other class. Next, the feature values extracted from a new dataset can be provided as input to the covariate shift classifier, which can classify the new data as belonging to either Class 1 or Class 0. If the datasets are similar and no systemic data drift has occurred, then the classifier may “fail” at discerning between the training data and the scoring data. If there is a substantial shift in the data (e.g., a score of about 0.80 AUC), however, the classifier can easily distinguish between the training data and the scoring data.

Additionally or alternatively, the MMM module 1126 can run anomaly detection (e.g., using an isolation forest blueprint, using the techniques described in International Patent Publication No. WO 2020/124037, or using any other suitable technique) on the training data to quantify a percentage of anomalies in a training data sample. The anomaly detection model can then be used to predict a percentage of anomalies in a scoring data sample. The MMM module 1126 can generate or output an anomaly drift score, based on a comparison of the percentage or quantity of anomalies in the training data sample and the percentage or quantity of anomalies in the scoring data sample. For example, the anomaly drift score can be the percentage of anomalies in the training data sample divided by the percentage of anomalies in the scoring data sample.

5.2. Model Explanations

5.2.1 Introduction

In general, decision makers are reluctant to rely on the inferences generated by a data analytics model unless those models and their inferences can be explained and understood. Some embodiments of techniques for explaining models and/or their inferences are described below. These explanatory techniques may be applicable to models that draw inferences from heterogeneous data sets (e.g., data sets with image features or other non-tabular features; heterogeneous data sets with tabular features and non-tabular features; heterogeneous data sets with image features and non-image features, etc.). For example, these explanatory techniques may be applicable to multi-stage (e.g., two-stage) models as described herein. In some embodiments, the model creation and evaluation module 126 of the model development system 100 may use one or more such explanatory techniques to explain a model 130 and/or its inferences (e.g., inferences generated by the model during validation). In some embodiments, the model management and monitoring (“MMM”) module 1126 of the model deployment system 1100 may use one or more such explanatory techniques to explain a deployed model and/or its inferences (e.g., inferences generated by the deployed model for inference data).

Some of the explanatory techniques described below rely on various “feature importance” metrics to generate visual explanations of model inferences. A feature's “feature importance” may indicate the feature's expected utility (on an absolute scale or relative to other features) for inferring the solution to a computer vision problem or data analytics problem. For example, a feature that is highly correlated with the target of a computer vision/data analytics problem generally has high expected utility for inferring the solution to that problem. Any suitable technique or metric may be used to assess feature importance including, without limitation, univariate feature importance, feature impact, and SHapley Additive exPlanations (“SHAP”). The foregoing techniques/metrics for assessing feature importance are described in further detail below.

By deriving numeric image feature vectors from images and providing those numeric image feature vectors as inputs to data analytics models, some embodiments make it possible for the feature importance of image features and non-image features (e.g., tabular features or other non-tabular features) to be quantified using the same technique, and thereby make it possible for the feature importance of image features and non-image features to be directly compared. Likewise, some of the explanatory techniques described herein may rely on the feature importance values of image features and non-image features to explain the inferences generated by models.

In some embodiments, the above-mentioned explanatory techniques may include one or more techniques for generating explanatory visualizations of models and/or model inferences. These explanatory visualizations may include, without limitation, general-purpose explanatory visualizations, neural network visualizations, image inference explanations, image embedding visualizations, etc.

General-purpose explanatory visualizations are visualizations that can be applied to both visual models and inferences (e.g., models and inferences derived from image features) and nonvisual models and inferences (e.g., models and inferences not derived from image features). Some examples of general-purpose explanatory visualizations may include, without limitation, lift charts, feature impact charts, receiver operating characteristic (“ROC”) curves, and confusion matrices.

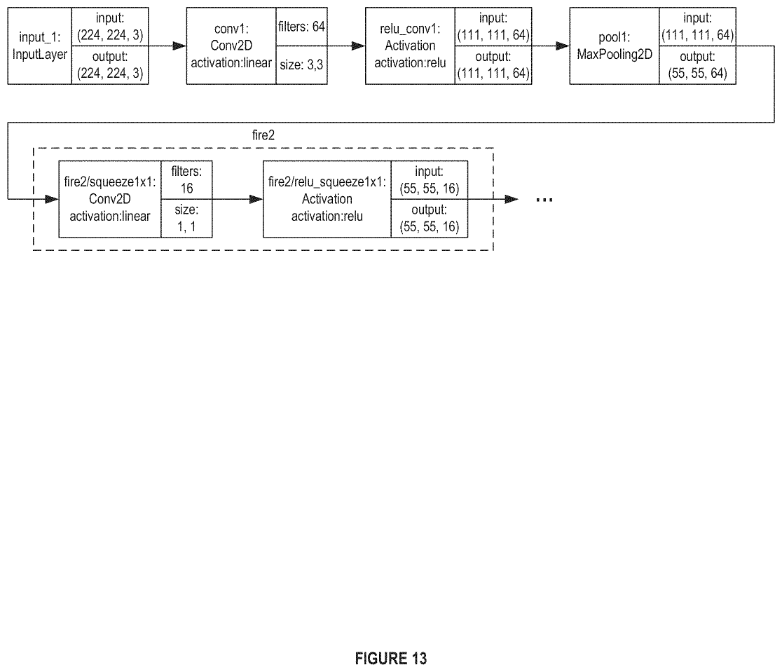

Neural network visualizations may be used to show key attributes of neural networks. Such attributes may include, without limitation, the number and sequence of layers in the network, each layer's type (e.g., input, activation, pooling, output, etc.), the number of inputs to each layer, the number of outputs from each layer, the type of activation function used by each activation layer, the type of pooling function used by each pooling layer, etc. An example of a neural network visualization is shown in FIG. 13.

As used herein, an “image inference explanation” refers to any visualization that indicates the extent to which a model has relied on the various portions of an image in a data sample to generate an inference based on the data sample. In other words, an “image inference explanation” may include any visualization that indicates the relative significance of the various portions of an image with respect to the inference generated by a model in response to a data sample that includes the image. From another perspective, image inference explanations may identify the areas of an image that are “of interest” to a model that is generating an inference based on the image, in the sense that the image features extracted from those areas of the image have a significant impact on the model's output.

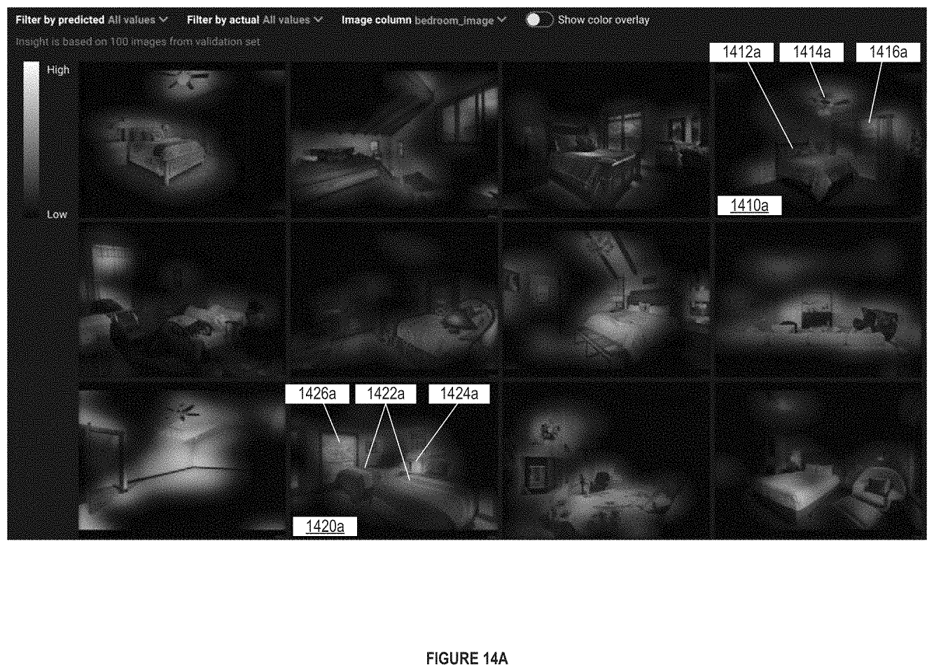

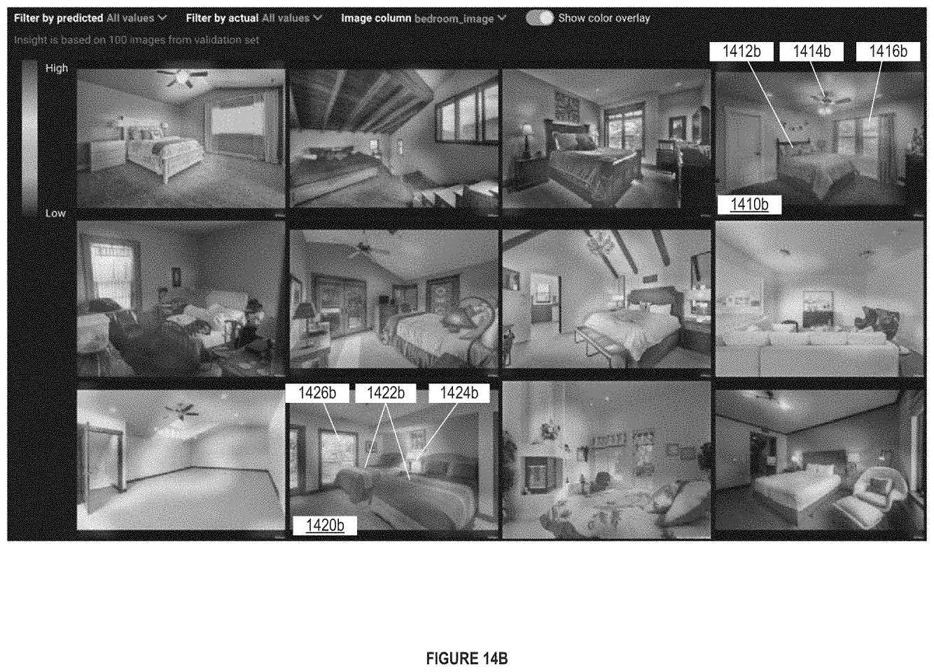

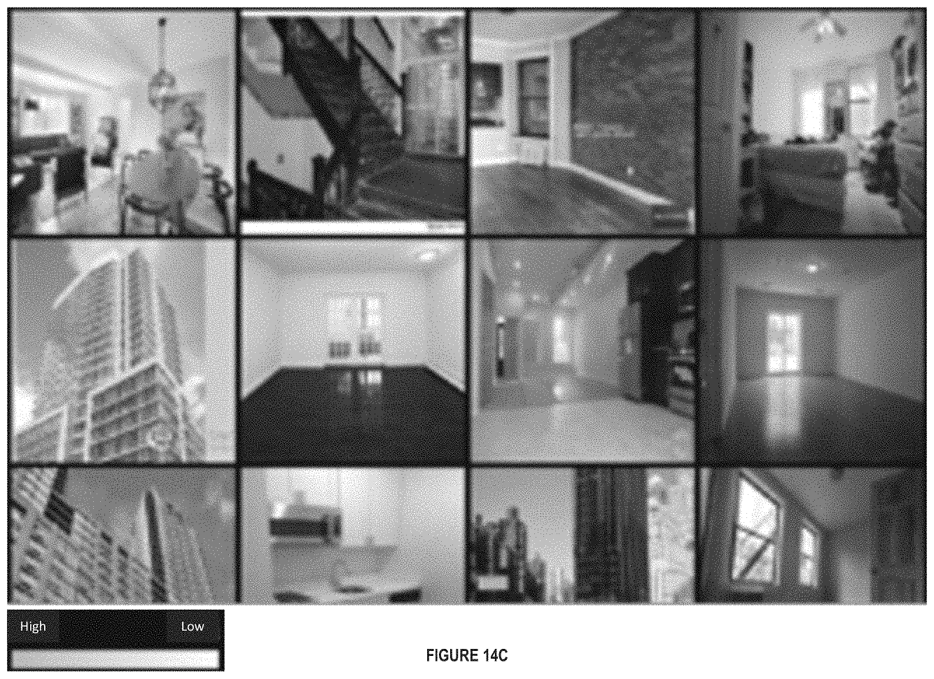

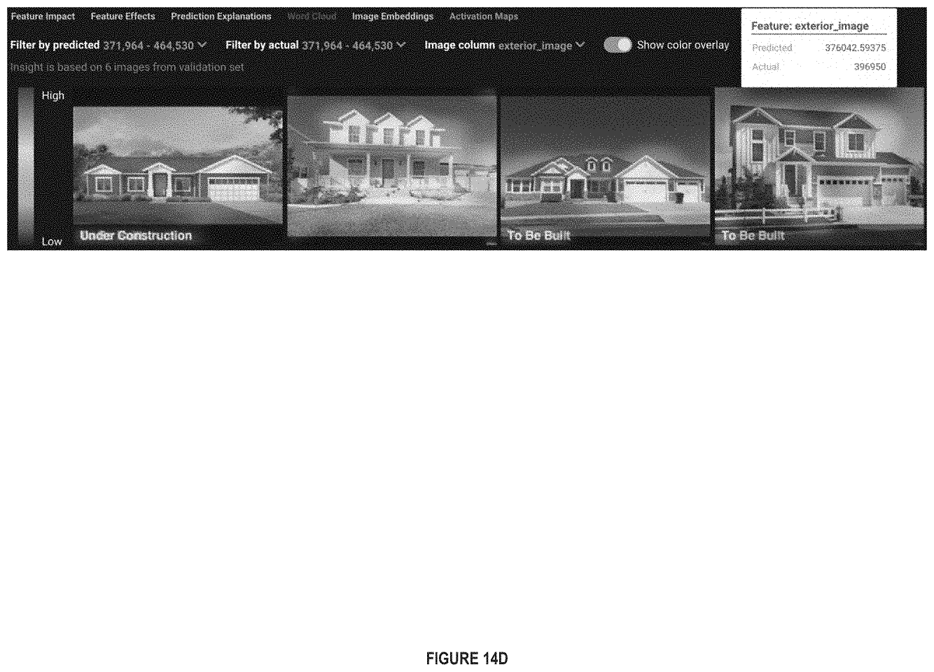

Some examples of image inference explanations for inferences generated by models of the pricing of residential real estate are shown in FIGS. 14A-14C. In particular, FIG. 14A shows some examples of occlusion-based image inference explanations for images of bedrooms in the above-discussed residential real estate data set. In occlusion-based image inference explanations, different portions of the original image are obscured to varying degrees by a layer of darkness that overlays the image, with the portions of the image that are less significant to the model's inference being more occluded (e.g., less visible), and the portions of the image that are more significant to the model's inference being less occluded (e.g., more visible). For example, in image inference explanation 1410a, the portions of the image most significant to the model's inference are the bed 1412a, the light fixture 1414a, and the window (or light source) 1416a. Likewise, in image inference explanation 1420a, the portions of the image most significant to the model's inference are the beds 1422a, the lamp 1424a, and the window (or light source) 1426a.

Likewise, FIG. 14B shows some examples of multicolor image inference explanations (or “spectrum-based image inference explanations”) for the same bedroom images shown in FIG. 14A. In multicolor-based image inference explanations, the original image is shown in greyscale and the portions of the greyscale image that have at least a minimum level of significance to the model's inference are “painted” with color. Furthermore, in the painted regions, the portions of the image that are less significant to the model's inference are painted with colors corresponding to the lower wavelengths of visible light (e.g., violet, blue), the portions of the image that are moderately significant to the model's inference are painted with colors corresponding to the middle wavelengths of visible light (e.g., light blue, green, light yellow), and the portions of the image that are moderately significant to the model's inference are painted with colors corresponding to the higher wavelengths of visible light (e.g., orange, red). For example, in image inference explanation 1410b, the portions of the image with at least a minimum level significance to the model's inference include the bed 1412b, the light fixture 1414b, and the window (or light source) 1416b. Furthermore, the colors in image inference explanation 1410b appear to indicate that the light fixture's lights are more significant than the fan blades, and that the uncovered portion of the window is more significant than the portions of the window covered by blinds. Likewise, in image inference explanation 1420b, the portions of the image with at least a minimum level significance to the model's inference include the beds 1422b, the lamp 1424b, and the window (or light source) 1426b.

The above-described examples of occlusion-based and multicolor-based image inference explanations are not limiting. FIG. 14C shows examples of monochromatic image inference explanations, in which the original image is shown in greyscale, the portions of the greyscale image that have at least a minimum level of significance to the model's inference are “painted” with a single color (e.g., orange), and the lightness or darkness of the color painted on a given region of the image indicates that portion's relative significance. (Specifically, in the example of FIG. 14C, darker regions of color correspond to greater significance.) More generally, any visualization that indicates the extent to which a model has relied on the various portions of an image in a data sample to generate an inference based on the data sample may be used. Some embodiments of image inference explanations may, for example, display arrows pointing to the significant portions of the image, with attributes of the arrows (e.g., length, line weight, color, etc.) indicating the level of significance of the portion of the image to which the arrow points. In some embodiments, a “topographical map” may be drawn on top of the image, such that areas of less significance are shown at “lower elevations” and areas of greater significance are shown at “higher elevations.”

Image inference explanations may help the user understand individual inferences of image-based models. For example, some embodiments of the model development system 100 and/or the model deployment system 1100 may provide an explanation user interface (explanation UI) for “drilling down” on individual inferences or sets of related inferences generated by an image-based model for individual data samples or sets of data samples. In response to receiving user input indicating selection of an individual inference or set of inferences, the explanation UI may display the image inference explanation(s) for images in the data sample(s) corresponding to the inference(s). For example, if the image-based model is a classifier, the user may drill down on data samples that the model correctly assigned to a particular class to better understand which aspects of the images led the model to assign those data samples to that class. Likewise, if the image-based model is a regression model, the user may drill down on data samples that the model correctly assigned to a particular numerical range to better understand which aspects of the images led the model to assign those data samples to that range.

Referring to FIG. 14D, an example of an explanation UI displaying image inference explanations corresponding to inferences of the residential real estate price prediction model is shown. In particular, in the example of FIG. 14, image inference explanations for the exterior images of houses that were correctly assigned to a particular price range ($371,964-$464,530) are shown. By comparing these image inference explanations, the user may better understand what attributes of the exteriors of these houses led the model to assign the houses to that price range.

More generally, reviewing the image inference explanations corresponding to various inferences of a model may help the user better understand how the model works and whether the model has any hidden biases. For example, if a classifier correctly classifies an image of a dog, but the image inference explanation for that inference highlights the image's background rather than dog, the user may conclude that the model has been over-fitted to the data set. The user may then attempt to improve the model by invoking techniques that combat over-fitting. Such techniques may include, without limitation, increasing regularization (e.g., by using a smaller batch size and/or a larger learning rate), adding more data (e.g., retraining with image augmentations, for example, cutout augmentations that may hide parts of the images to which the model is over-fitted), and/or some combination of the foregoing. As another example, if a classifier correctly classifies an image of a cat, but the image inference explanation for that inference highlights the cat and other parts of the image (e.g., the top of a sofa), the user may conclude that the model is identifying patterns across images (e.g., the model has learned that cates tend to sit on sofa tops).

In some embodiments, the explanation UI may provide controls whereby the user can drill down into various types of inference errors committed by a model (e.g., misclassification, overestimation, underestimation, etc.). For example, with respect to the residential real estate price prediction model, the explanation UI may provide user interface elements by which the user can navigate to image inference explanations for instances in which the model overestimates the price of the property. As another example, if a classifier misclassifies an image of a dog even though the image inference explanation shows that the dog is highlighted, the user may conclude that the model has been under-fitted to the data set. The user may then attempt to improve the model by invoking techniques that combat under-fitting. Such techniques may include, without limitation, using a smaller learning rate, using a larger batch size, using more epochs, using a more complex model, and/or some combination of the foregoing.

Image inference explanations have some attributes in common with “activation maps” (e.g., “feature activation maps,” “class activation maps,” or “heatmaps”) for deep learning models (e.g., CNNs). For CNNs that operate on image data, feature activation maps are visualizations that indicate which areas of an input image activated particular feature extraction layers of the CNN. In other words, feature activation maps indicate which portions of an image caused a CNN to detect a particular feature in the image. In some embodiments, the image processing model(s) used for image feature extraction by an image feature extraction module (122, 1122) may generate feature activation maps indicating the areas of input images where various image features are detected.

In contrast to techniques for generating activation maps, which are generally applicable only to deep learning models, image inference explanations may be generated to explain the operation of any type of image-based model (e.g., linear models, tree-based models, kernel-based models, neural networks, blenders, etc.). Some embodiments of techniques for generating image inference explanations are described below in the Section titled “Techniques for Generating Image Inference Explanations.”

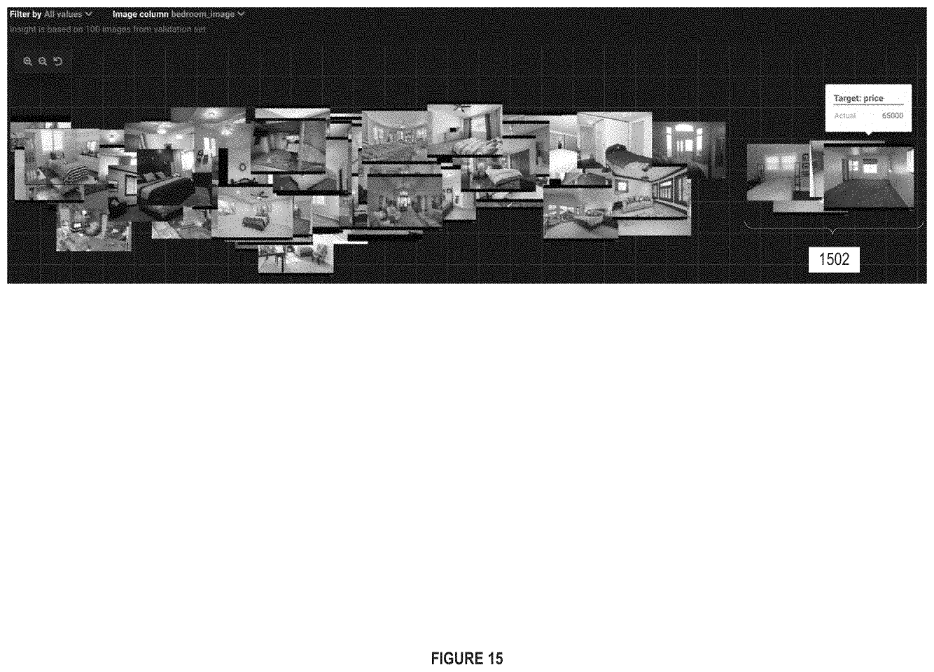

Another type of explanatory visualization is the image embedding visualization. In an image embedding visualization, a set of images (e.g., from a training data set or an inference data set) are clustered and displayed on a 2D plot, such that images that appear similar to a model (e.g., a data analytics model) are located relatively close together, and images that appear dissimilar to the model are located relatively far apart. Image embedding visualizations can help the user identify unexpected patterns in the image data. Referring to FIG. 15, an example of an image embedding visualization of bedroom images from the residential real estate data set is shown. In the example of FIG. 15, a small number of images 1502 of unfurnished or sparsely furnished bedrooms are clustered together, apart from the images of fully furnished bedrooms. From the perspective of an image feature extraction model or a downstream data analytics model, the images 1502 in this cluster may be anomalous. More generally, the image embedding visualization may help users to identify anomalous images or sets of anomalous images in a data set, because such images or sets (e.g., clusters) of images may be spaced apart from the other images in an image embedding visualization.

In some embodiments, a model development system 100 and/or a model deployment system 1100 may be capable of generating image embedding visualizations of the images in a data set. Image embedding visualizations may be generated using any suitable technique. In some embodiments, the highest-level image features extracted from each image in the set of images may be converted into 2D coordinates (e.g., Cartesian coordinates). This conversion may be carried out, for example, by performing a dimensional reduction (e.g., a TriMap dimensionality reduction) on the highest-level feature set to reduce the dimensionality of the highest-level feature set to 2D. Other conversion functions may be used including, without limitation, principal component analysis (PCA), uniform manifold approximation and projection (UMAP), t-distributed stochastic neighbor embedding (T-SNE), etc. The set of images may then be displayed in a 2D coordinate space, with each of the images located at its coordinates.

5.2.2. Determining the Predictive Value of a Feature

In some embodiments, feature importance metrics used by a model development system 100 and/or a model deployment system 1100 may include, without limitation, univariate feature importance, feature impact, and SHapley Additive exPlanations (“SHAP”). These metrics and some embodiments of techniques for assessing (or “scoring”) the feature importance of non-tabular features (e.g., image features) according to these metrics are described below.

5.2.2.1. Univariate Feature Importance

In general, the “univariate feature importance” of a feature F for a modeling problem P is an estimate of the correlation between the target of the modeling problem P and the feature F. Any suitable technique may be used to determine the univariate feature importance of tabular features.

In some embodiments, the univariate feature importance of non-tabular features (e.g., image features) may be determined using the Alternating Conditional Expectations (ACE) algorithm, treating the constituent features of a non-tabular data element (e.g., an image) as a single, aggregate feature. The ACE algorithm, which is based on L. Breiman et al., “Estimating Optimal Transformations for Multiple Regression and Correlation,” Journal of the American Statistical Association (1985), pp. 580-598, estimates the correlation between a target and one feature (e.g., a set of constituent image features treated as an aggregate image feature).

In some embodiments, the univariate feature importance of an aggregate non-tabular feature F_{A} (e.g., image feature vector) is estimated by (1) extracting a set of one or more constituent features F_{C} (e.g., constituent image features) from each instance of the non-tabular data element (e.g., image) in a data set (e.g., a training data set), (2) determining independent ACE scores for each of the constituent features F_{C}, (3) optionally normalizing the individual ACE scores of the features F_{C}, and (4) determining the feature importance of the aggregate feature F_{A} based on the (optionally normalized) ACE scores of the constituent features F_{C}. Any suitable technique may be used to determine the feature importance of the aggregate feature F_{A} including, without limitation, selecting the maximum normalized ACE score of the set of constituent features F_{C} as the feature importance of the aggregate non-tabular feature F_{A}, using the mean or median of the N highest ACE scores of the set of constituent features F_{C} as the feature importance of the aggregate non-tabular feature F_{A}, where N is any suitable positive integer (e.g., 3, 5, 10, 20, 50, 100, etc.). The constituent features F_{C} of the non-tabular data elements (e.g., images) may be extracted, for example, using feature extraction models (e.g., image feature extraction models).

Any suitable set of constituent features extracted from the non-tabular data elements of a group of data samples by a feature extraction model may be used to calculate the aggregate feature importance of an aggregate non-tabular feature. For example, the set of features used to calculate the feature importance of a non-tabular feature may be or include (i) all extracted features, all low-level features, all medium-level features, all high-level features, all highest level features, all globally pooled outputs of the last convolutional neural network layer in the CNN of a feature extraction model, or any suitable combination of the foregoing.

The ACE scores determined for each of the constituent features F_{C} may be individually and independently normalized against the target feature based on the project metric (for example, to account for the Gini Norm and Gamma Deviance metrics being on different scales). The normalization may be done relative to the target, since the target relative to itself has the largest ACE score. After normalization, the constituent feature F_{C} that contributes the highest score may be displayed or otherwise identified.

In some embodiments, the univariate feature importance values determined for various features (e.g., features of the same type, features of different types, tabular features, non-tabular features, image features, non-image features, etc.) can be quantitatively compared to each other. This comparison may help the user understand the importance of including various non-tabular data elements (e.g., images) in the data set.

In some embodiments, the model development system 100 may determine univariate feature importance scores for one or more (e.g., all) the features of a data set during the exploratory data analysis phase of the model development process.

In some embodiments, the model development system 100 may determine ACE scores for each of the constituent features F_{C} (e.g., constituent image features) extracted from a column of non-tabular data elements (e.g., images) by a feature extraction model (e.g., an image feature extraction model), and may concatenate those ACE scores to form a non-tabular (e.g., image) feature importance vector. The ordering of the feature importance elements in the non-tabular (e.g., image) feature importance vector may match the ordering of the constituent features (e.g., constituent image features) in the non-tabular (e.g., image) feature vector. Such feature importance vectors may be used to generate image inference explanations, as described in further detail below in the section titled “Techniques for Generating Image Inference Explanations.”

5.2.2.2. Feature Impact

In general, the “feature impact” of a feature F for a model M is an estimate of the extent to which the feature F contributes to the performance (e.g., accuracy) of the model M. The feature impact of a feature F may be “model-specific” or “model-dependent” in the sense that it may vary with respect to two different models M1 and M2 that solve the same modeling problem (e.g., using the same feature set). Any suitable technique may be used to determine the feature impact of tabular features including, without limitation, the technique referred to as “universal feature importance” in U.S. Pat. No. 10,496,927.

In general, the feature impact of a non-tabular feature F for a trained model M may be determined by (1) using the model M to generate one set of inferences for a validation data set in which the data samples contain the actual values of the feature F, (2) using the model M to generate another set of inferences for a version of the validation data set in which the values of the feature F have been altered to destroy (e.g., reduce, minimize, etc.) the feature's predictive value, and (3) comparing the performance P1 (e.g., accuracy) of the first set of inferences to the performance P2 (e.g., accuracy) of the second set of inferences. In general, as the difference between P1 and P2 increases, the feature impact of the feature F increases.

In some embodiments, the following process may be used to determine the feature impact of a non-tabular feature F for a trained model M: (1) use the model M to generate a set of inferences INF1 for a validation data set V in which the data samples contain the actual values of all the model's features, and score the model's performance P1 based on the inferences INF1 using any suitable performance metric (e.g., accuracy); (2) generate a modified version of the validation data set V′ in which the predictive value of the feature F has been destroyed (e.g., by shuffling the values of the feature F across the data samples in V′, by storing the same value of the feature F in each of the data samples in V′, etc.); (3) use the model M to generate a set of inferences INF2 for the data set V′, and score the model's performance P2 based on the inferences INF2 using the same performance metric; and (4) determine the feature impact F_{IMP} of the feature F for the model M based on the difference between the performance scores P1 and P2 (e.g., F_{IMP}=P1−P2, F_{IMP}=(P1−P2)/P1, etc.).

In some embodiments, the feature impact of one or more (e.g., all) features of the model's feature set may be determined in parallel. In some cases, the feature impact of a feature F may be negative, indicating that the model's reliance on the feature decreases the model's performance. In some embodiments, features with negative feature impact may be removed from the feature set, and the model may be retrained using the reduced feature set.

In some embodiments, after the feature impacts of one or more features of interest (e.g., all features) have been determined, the feature impacts may be normalized. For example, the feature impacts may be normalized so that the highest feature impact is 100%. Such normalization may be achieved by calculating normalized_F_{IMP}(Fi)=raw_F_{IMP}(Fi)/max(raw_F_{IMP}(all Fi)) for each feature Fi. In some embodiments, the N greatest normalized feature impact scores may be retained, and the other normalized feature impact scores may be set to zero to enhance efficiency. The threshold N may be any suitable number (e.g., 100, 500, 1,000, etc.).

In some embodiments, the model development system 100 may determine feature impact scores for one or more (e.g., all) the features of a data set during the model creation and evaluation phase of the model development process. In some embodiments, the model development system may determine feature impact scores for aggregate non-tabular features (e.g., image feature vectors) and/or for constituent non-tabular features (e.g., constituent image features).

In some embodiments, the feature impact scores determined for various features (e.g., features of the same type, features of different types, tabular features, non-tabular features, image features, non-image features, etc.) can be quantitatively compared to each other. This comparison may help the user understand the importance of including various non-tabular data elements (e.g., images) in the data set. Likewise, the model-specific feature impact scores of a particular feature (e.g., a non-tabular feature) for a set of models may be compared. This comparison may help the user understand which models are doing a good job exploiting the information represented by the feature and which are not.

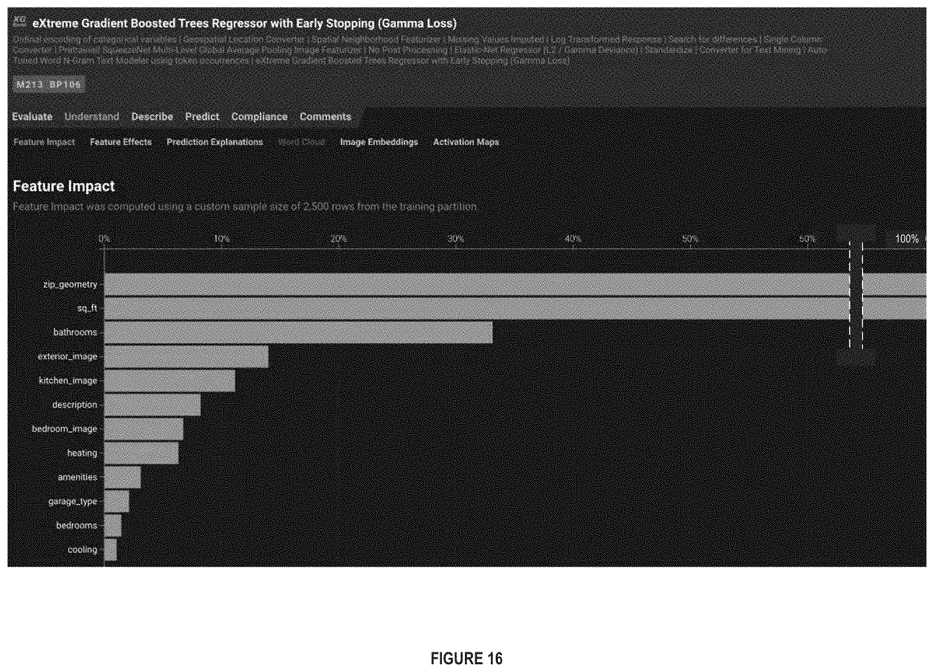

FIG. 16 shows normalized feature impact scores for the features of a model developed by the model development system 100 to infer the prices of units of residential real estate. In the example of FIG. 16, the geospatial feature (“zip_geometry”) and the square footage feature (“sq_ft”) have the greatest feature impact scores, and the three images of the house are among the seven features with the highest feature impact scores.

In some embodiments, the model development system 100 may determine feature impact scores for each of the constituent features F_{C} (e.g., constituent image features) extracted from a column of non-tabular data elements (e.g., images) by a feature extraction model (e.g., an image feature extraction model), and may concatenate those feature impact scores to form a non-tabular (e.g., image) feature importance vector. The ordering of the feature importance elements in the non-tabular (e.g., image) feature importance vector may match the ordering of the constituent features (e.g., constituent image features) in the non-tabular (e.g., image) feature vector. Such feature importance vectors may be used to generate image inference explanations, as described in further detail below in the section titled “Techniques for Generating Image Inference Explanations.” To facilitate the use of the feature importance vector to generate image inference explanations, the feature impact scores in the feature importance vector may be standardized. Any suitable standardization operation may be used to standardize the feature impact scores in the feature importance vector including, without limitation, the softmax operation:

$${σ ( z )}_{i} = \frac{{e}^{{z}_{i}}}{{\sum }_{j = 1}^{K} {e}^{{z}_{j}}} for i = 1 , … , K and z = ( {z}_{1} , … , {z}_{K} ) ∈ {ℝ}^{K}$$

5.2.2.3. SHAP Values

In general, SHapley Additive exPlanations (“Shapley values” or SHAP values”) can be used in game theory to provide a system for fairly dividing a payout among members of a team, even though the members may not have made equal contributions. The same set of concepts can be applied to interpretation of machine learning models, in which the “payout” is the model prediction, the “team members” are the features or variables taken into consideration by the model, and a goal of the exercise is to assign importance to each feature, even though the features may not all be equally influential to the model. Shapley values have appealing properties for this application because, for example, they are mathematically well-founded in game theory, including certain uniqueness theorems, and they have a property of “additivity” that ensures that the sum of all Shapley values equals the total payout/prediction, making their interpretation intuitive and concrete. For example, Shapley values can be provided in the same units as the prediction (e.g., dollars, meters, hours, etc.).

In some embodiments, the Shapley values of a linear model's features may be used to determine feature importance values for those features. In some embodiments, Model-Specific Approximations of SHAP values of a tree-based model's features, as described in the literature for SHAP Tree Explainer, may be used to determined feature importance values for those features. Since SHAP is a per sample feature attribution technique, the following additional processing may be performed to determine feature importance values for a set of features feature based on the Shapley values of the features for a set of samples: (1) select an absolute number of the samples; (2) determine an average of the SHAP values for each feature of the selected samples; and (3) apply the softmax standardization to the average SHAP values to obtain a balanced set of SHAP-based feature importance value.

In some embodiments, the model development system 100 may determine SHAP-based feature importance scores for one or more (e.g., all) the features of a data set during the model creation and evaluation phase of the model development process. In some embodiments, the model development system 100 may determine SHAP-based feature importance scores for aggregate non-tabular features (e.g., image feature vectors) and/or for constituent non-tabular features (e.g., constituent image features).

In some embodiments, the model development system 100 may determine SHAP-based feature importance scores for each of the constituent features F_{C} (e.g., constituent image features) extracted from a column of non-tabular data elements (e.g., images) by a feature extraction model (e.g., an image feature extraction model), and may concatenate those SHAP-based feature importance scores to form a non-tabular (e.g., image) feature importance vector. The ordering of the feature importance elements in the non-tabular (e.g., image) feature importance vector may match the ordering of the constituent features (e.g., constituent image features) in the non-tabular (e.g., image) feature vector. Such feature importance vectors may be used to generate image inference explanations, as described in further detail below in the section titled “Techniques for Generating Image Inference Explanations.”

5.2.3. Techniques for Generating Image Inference Explanations

Many image processing models (including some embodiments of pre-trained image feature extraction models and pre-trained fine-tunable image processing models) can use known, documented methods to generate image activation maps that highlight portions of an image that correlate with the model's output. In other words, many image processing models can use known, documented methods to provide visual explanations of their image-based predictions. Some of these known, documented explainability methods include, for example, Grad-CAM and SHAP Gradient Explainer.

Despite the above-described benefits of using multi-stage (e.g., two-stage) models 130 to perform modeling tasks or data analytics tasks, the use of pre-trained image feature extraction models for image feature extraction introduces some additional challenges. For example, in the case of a pre-trained image processing model repurposed as a stage-one image feature extraction model of a two-stage model 130, because the stage-one image processing model is pre-trained for a task or domain that differs from the task/domain in which the two-stage model 130 is used, the conventional image activation maps produced by the stage-one image processing model generally do not accurately explain results produced by the two-stage model 130. Furthermore, in the case of both pre-trained image feature extraction models and pre-trained fine-tunable image processing models, in embodiments in which a stage-two machine learning model of a two-stage model 130 generates results based on one or more non-image features in addition to one or more image features, the image activation maps produced by the stage-one feature extraction model generally do not accurately explain the results generated by the two-stage model 130 because the image activation maps only account for the impact of image features, not the impact of non-image features. Therefore, challenges are encountered when attempting to explain the results generated by two-stage models 130.

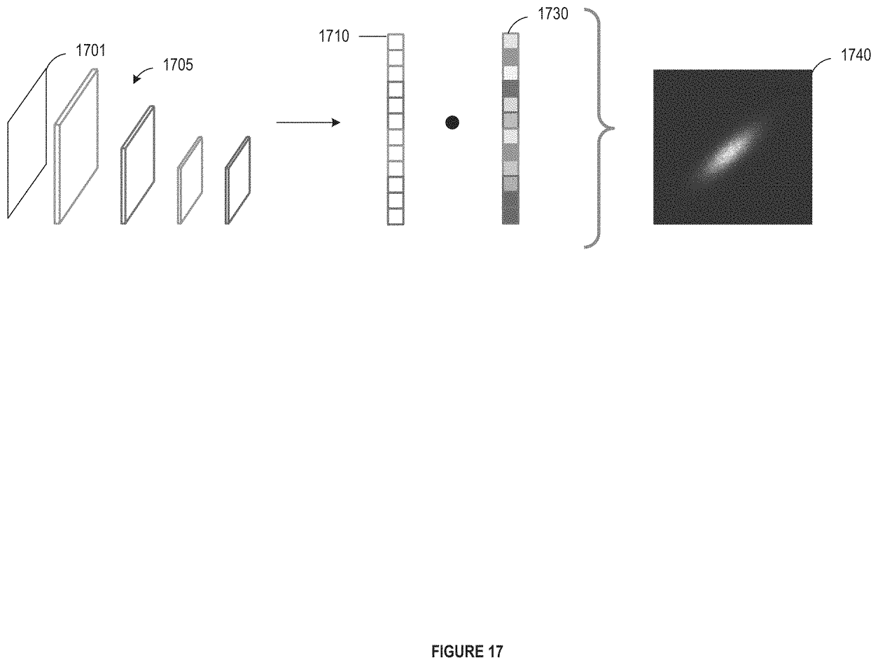

As described above, image inference explanations may address the shortcomings of conventional image activation maps with respect to the use of pre-trained image processing models in multi-stage data analytics models and with respect to the combined use of image features and non-image features in such data analytics models. Some embodiments of a method for generating image inference explanations are described below with reference to FIG. 17, which shows a dataflow diagram that illustrates aspects of the method.

Obtain a feature vector 1710 (e.g., image feature vector) representing the features of a non-tabular data element 1701 (e.g., an image 1701). Some embodiments of techniques for generating feature vectors for non-tabular data elements are described above. In some embodiments, the feature vector 1710 may be generated by concatenating a set of constituent features extracted from the non-tabular data element 1701 by a pre-trained feature extraction model (e.g., pre-trained image feature extraction model).

Obtain a set of activation maps 1705 corresponding to the set of respective constituent features extracted from the non-tabular data element 1701 by the pre-trained feature extraction model. Some embodiments of techniques for generated activation maps are described above.

Obtain a feature importance vector 1730. The elements of the feature importance vector 1730 may be or indicate feature importance values for the constituent features of a feature vector 1710. Some embodiments of techniques for generating feature importance vectors are described above. In some embodiments, the feature importance vector 1730 may be generated in advance (e.g., during model development and evaluation) and retrieved from a computer-readable storage medium.

Generate an image inference explanation visualization based on the non-tabular data element (e.g., image) 1701, the activation maps 1705, the feature vector 1710 derived from the non-tabular data element 1701, and the feature importance vector 1730. The image inference explanation visualization may indicate (e.g., highlight) the portions of the image 1701 in the inference data sample that contributed most to the output generated by the two-stage model 130 for the inference data sample. The image inference visualization explanation may be generated by forming a weighted combination of the individual activation maps of the constituent image features, with each of the individual activation maps weighted by a value derived from the feature importance score and feature value of the corresponding constituent image feature. For example, the weight applied to the activation map for a particular constituent feature may be the product of the feature importance score and the feature value for that feature.

### 6. Automated Data Analytics Methods

6.1. A Modeling Method

In some embodiments, a method for developing and deploying a data analytics model may include one or more of the following steps, which may be performed in the order presented in or in any other suitable order:

The user may create an archive file (e.g., a zip file) 206 containing a training data set. Non-tabular data elements (e.g., images) 204 may be placed into different folders to classify them, or a file (e.g., spreadsheet, a comma-separated value (“csv”) file, etc.) 202 may specify the values of the data samples if a heterogeneous data set is being modeled. See, for example, FIG. 2A and the above discussion thereof.

The user may provide the archive file 206 to a model development system 100. For example, the user may drag and drop the archive file onto a user interface (“UI”) of the model development system. See FIG. 2A.

The user or the model development system 100 may select a target 212, and the user may select a user interface element (e.g., Start button 214) to initiate the automated model development process. See FIG. 2B.

The model development system 100 may perform automated exploratory data analysis (EDA) on the training data set and display information about the data set. See FIG. 3 and the above discussion thereof. In response to receiving suitable user input, the model development system may display subsets of the data set's images corresponding to different classes or ranges of the target. See FIGS. 4-5 and the above discussion thereof.

The model development system 100 may automatically select, train, test and compare a plurality of blueprints and then optionally recommends the best blueprint for the user's application. See FIGS. 6-7 and the above discussion thereof.

In response to receiving suitable user input, the model development system 100 may present visualizations to facilitate the user's evaluation of one or more blueprints (e.g., the recommended blueprint). See FIGS. 13-17 and the above discussion thereof.

Optionally, in response to receiving suitable user input indicating that the user wishes to refine (e.g., tune, tweak, retrain, etc.) a model before deploying it, the model development system 100 may expose one or more (e.g., all) of the blueprint's hyperparameters for user adjustment. See FIGS. 8B, 8C, and 9 and the above discussion thereof.

In response to receiving suitable user input (e.g., selection of a user interface element, for example, a single click), the model development system 100 can deploy a selected blueprint to the model deployment system 100.

The model deployment system 1100 may provide tools for displaying the status of the deployed blueprint/model. For example, the model deployment system 1100 may display user interfaces that show how the blueprint/model performs over time and the extent to which the model's features have drifted over time. See FIG. 12A-12B and the above discussion thereof.

6.2. Additional Methods

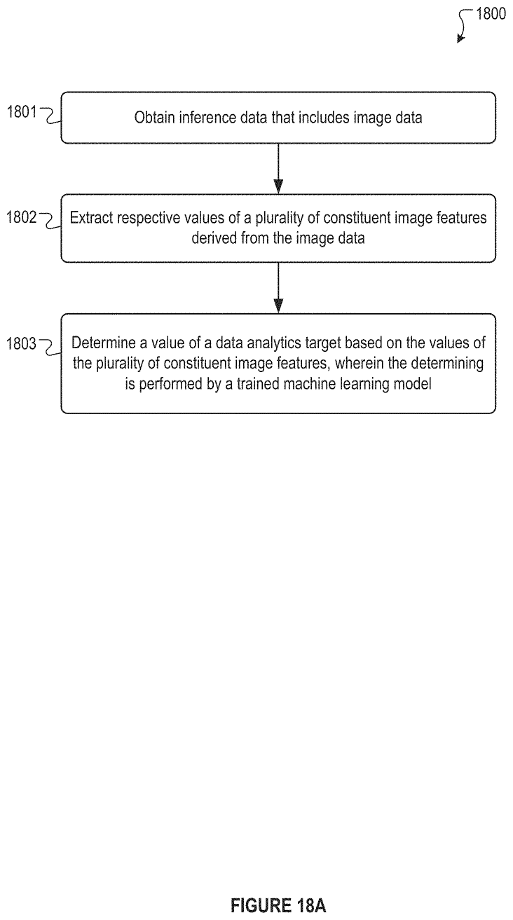

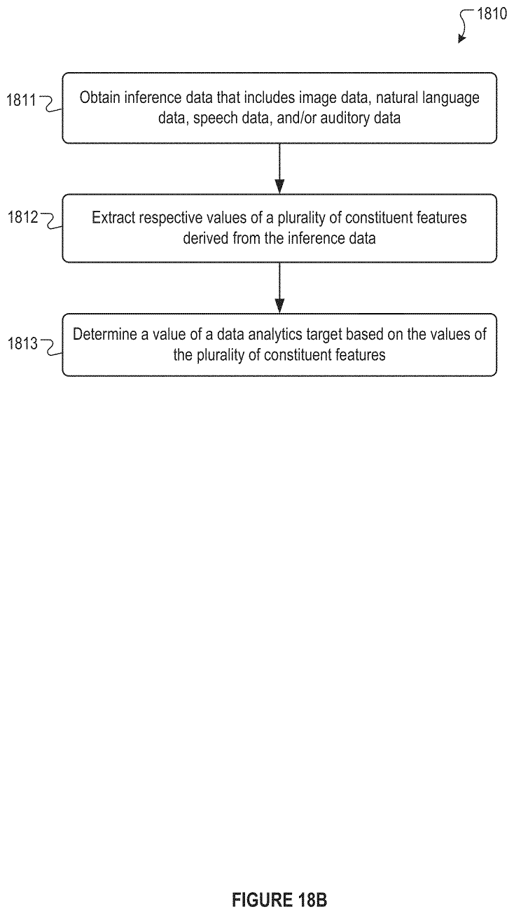

Referring to FIG. 18A, an image-based data analytics method 1800 may include steps 1801-1803, according to some embodiments. In some embodiments, the method 1800 may be performed by a model deployment system 1100.

In step 1801, inference data that include image data are obtained.

In step 1802, respective values of a plurality of constituent image features are extracted (e.g., derived) from the image data. The values of the constituent image features may be extracted from the image data by an image feature extraction model. In some embodiments, the image feature extraction model is pre-trained. In some embodiments, the image feature extraction model includes a convolutional neural network. The constituent image features may include one or more low-level image features, one or more mid-level image features, one or more high-level image features, and/or one or more highest-level image features.

In step 1803, a value of a data analytics target is determined based on the values of the constituent image features. The value of the data analytics target may be determined by a trained machine learning model. In some cases, the inference data further include non-image data. In some embodiments, the determining of the value of the data analytics target is also based on values of one or more features derived from the non-image data. In some embodiments, the image feature extraction model is not fitted to the values of the constituent image features derived from the image data.

In some embodiments, the method 1800 further includes a step of arranging the values of the constituent image features and the values of the features derived from the non-image data in a table. In some embodiments, the determining of the value of the data analytics target is performed by applying the trained machine learning model to the table. In some embodiments, the trained machine learning model includes a gradient boosting machine. In some embodiments, the value of the data analytics target includes a prediction based on the inference data, a description of the inference data, a classification associated with the inference data, and/or a label associated with the inference data.

Referring to FIG. 18B, a two-stage data analytics method 1810 may include steps 1811-1813, according to some embodiments. In some embodiments, the method 1810 may be performed by a model deployment system 1100.

In step 1811, inference data that include first data of a non-tabular data type (e.g., image data, textual data, natural language data, speech data, auditory data, spatial data, or a combination thereof) are obtained.

In step 1812, respective values of a plurality of constituent features are extracted (e.g., derived) from the first data. The values of the constituent features may be extracted from the first data by a feature extraction model. In some embodiments, the feature extraction model is pre-trained. In some embodiments, the feature extraction model includes a convolutional neural network (CNN). The constituent features may include one or more low-level features extracted by a first layer of the CNN, one or more mid-level features extracted by a second layer of the CNN, one or more high-level features extracted by a third layer of the CNN, and/or one or more highest-level features extracted by a fourth layer of the CNN.

In step 1813, a value of a data analytics target is determined based on the values of the constituent features. The value of the data analytics target may be determined by a trained machine learning model. In some cases, the inference data further include second data of a tabular data type (e.g., numeric data, categorical data, time-series data, etc.). In some embodiments, the determining of the value of the data analytics target is also based on values of one or more features derived from the second data. In some embodiments, the feature extraction model is not fitted to the values of the constituent features derived from the first data.

In some embodiments, the method 1810 further includes a step of arranging the values of the constituent features of the first data and the values of the features derived from the second data in a table. In some embodiments, the determining of the value of the data analytics target is performed by applying the trained machine learning model to the table. In some embodiments, the trained machine learning model includes a gradient boosting machine. In some embodiments, the value of the data analytics target includes a prediction based on the inference data, a description of the inference data, a classification associated with the inference data, and/or a label associated with the inference data.

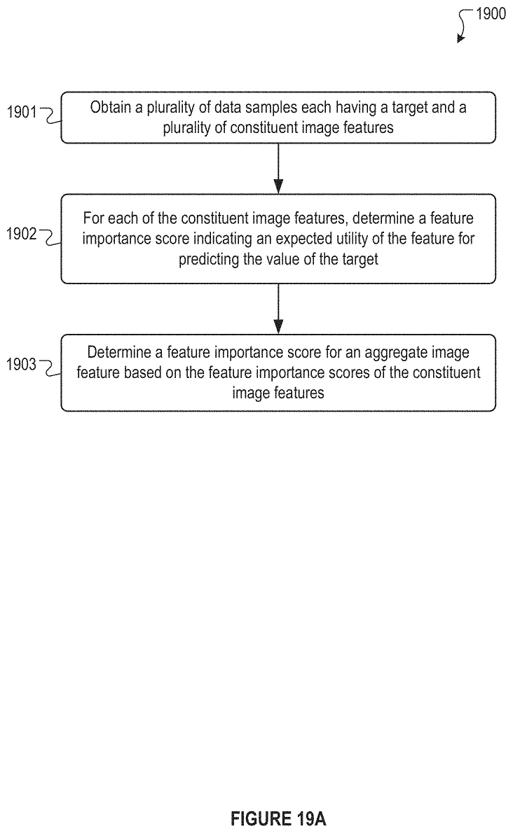

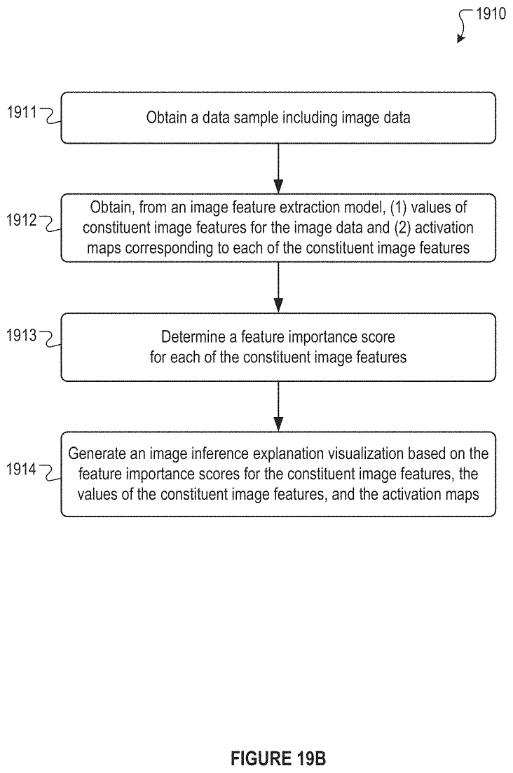

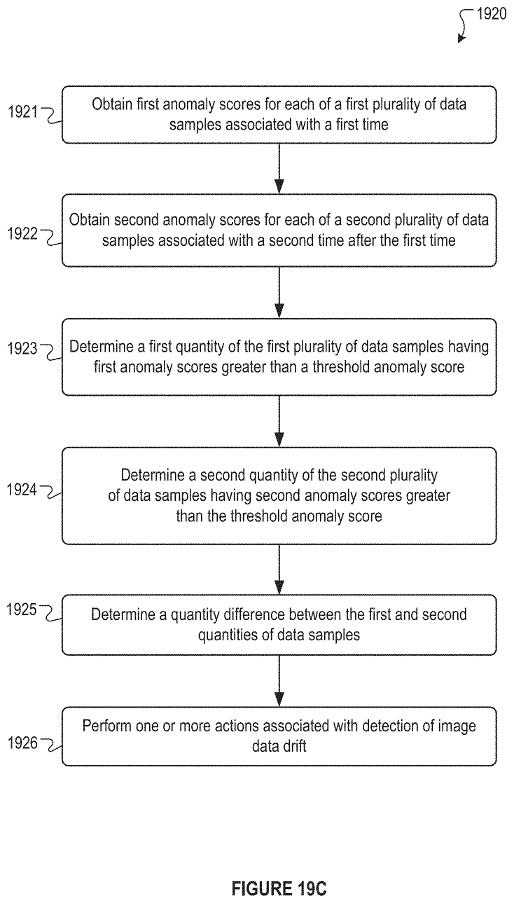

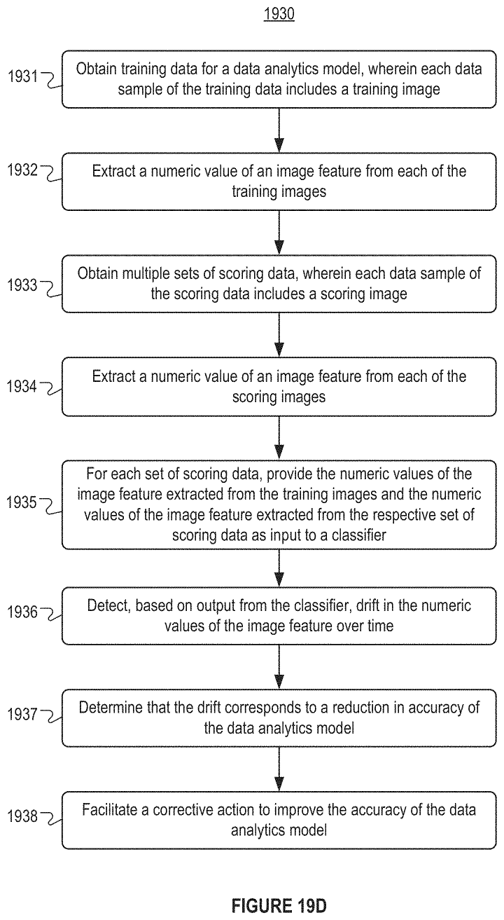

Referring to FIG. 19A a method 1900 for determining the feature importance of an aggregate image feature may include steps 1901-1903, according to some embodiments. In some embodiments, the method 1900 may be performed by a model development system 100 and/or by a model deployment system 1100.

In step 1901, a plurality of data samples are obtained. Each of the data samples may be associated with respective values for a set of features and with a respective value for a target. The set of features may include a feature having an aggregate image data type (“aggregate image feature”). The aggregate image feature may be, for example, an image feature vector. The aggregate image feature may include a plurality of features each having a constituent image data type (“constituent image features”).

In step 1902, for each of the constituent image features, a feature importance score is determined. The feature importance score may indicate an expected utility of the constituent image feature for predicting the values of the target. In some embodiments, the feature importance score is a univariate feature importance score, a feature impact score, or a Shapley value.

In step 1903, a feature importance score for the aggregate image feature is determined (e.g., based on the feature importance scores of the constituent image features). The feature importance score for the aggregate image feature may indicate an expected utility of the aggregate image feature for predicting the values of the target.

In some embodiments, the method 1900 further includes a step of normalizing and/or standardizing the feature importance scores for the constituent image features. The normalizing and/or standardizing may be performed prior to determining the feature importance score for the aggregate image feature.

In some embodiments, for each data sample, the method 1900 further includes a step of extracting respective values for the constituent image features from one or more first images using a pre-trained image processing model. In some embodiments, the pre-trained image processing model includes a pre-trained image feature extraction model or a pre-trained, fine-tunable image processing model. In some embodiments, the pre-trained image processing model includes a convolutional neural network model previously trained on a training data set containing one or more second images. In some embodiments, determining the feature importance score for the aggregate image feature includes selecting a highest feature importance score among the feature importance scores for the constituent image features, and using the selected highest feature importance score as the feature importance score for the aggregate image feature.

In some embodiments, the set of features further includes a feature having a non-image data type, and the method 1900 further includes steps of quantitatively comparing a feature importance score of the feature having the non-image data type with the feature importance score of the aggregate image feature, and determining, based on the quantitative comparison, whether the non-image feature or the aggregate image feature has greater expected utility for predicting the values of the target.

Referring to FIG. 19B, a method 1910 for explaining a value of a target based at least in part on an image feature may include steps 1911-1914, according to some embodiments. In some embodiments, the method 1910 may be performed by a model development system 100 and/or by a model deployment system 1100.

In step 1911, a data sample that includes image data is obtained. The data sample may be associated with respective values for a set of features and a value for a target. The set of features may include an aggregate image feature, and the aggregate image feature may include a plurality of constituent image features.

In step 1912, respective values of the constituent image features for the image data are obtained, and respective activation maps corresponding to each of the constituent image features are obtained. The constituent image feature values and the activation maps may be obtained from an image feature extraction model. Each of the activation maps may indicate which portions of the image data, if any, activated a neural network layer corresponding to the respective constituent image feature.

In step 1913, a feature importance score for each of the plurality of constituent image features is determined. The feature importance score for each constituent image feature may indicate an expected utility of the constituent image feature for predicting the value of the target.

In step 1914, an image inference explanation visualization is generated based on the feature importance scores for the constituent image features, the values of the constituent image features, and the activation maps. The image inference explanation visualization may identify portions of the image data that contribute to the determination of the value of the target.

In some embodiments, the data sample further includes non-image data. In some embodiments, the value of the target is determined by a two-stage visual artificial intelligence (AI) model. In some embodiments, the image inference explanation visualization explains, in part, how the model determined the value of the target.

Referring to FIG. 19C, a drift detection method 1920 for image data may include steps 1921-1926, according to some embodiments. In some embodiments, the drift detection method 1920 may be performed by a model deployment system 1100.

In step 1921, respective first anomaly scores for each of a first plurality of data samples associated with a first time are obtained. Each of the first plurality of data samples may be associated with respective values for a set of constituent image features extracted from first image data. The respective first anomaly score for each data sample may indicate an extent to which the data sample is anomalous.

In step 1922, respective second anomaly scores for each of a second plurality of data samples associated with a second time after the first time are obtained. Each of the second plurality of data samples may be associated with respective values for the set of constituent image features extracted from second image data. The respective second anomaly score for each data sample may indicate an extent to which the data sample is anomalous.

In step 1923, a first quantity of the first plurality of data samples having respective first anomaly scores greater than a threshold anomaly score is determined. In step 1924, a second quantity of the second plurality of data samples having respective second anomaly scores greater than the threshold anomaly score is determined. In step 1925, a quantity difference between the first and second quantities of data samples is determined.

In step 1926, responsive to an absolute value of the quantity difference being greater than a threshold difference, one or more actions associated with detection of image data drift are performed. In some embodiments, the one or more actions associated with detection of image data drift include providing a message to a user. The message may indicate that image data drift has been detected. In some embodiments, the one or more actions associated with detection of image data drift include generating a new data analytics model based on the second plurality of data samples associated with the second time point.

Referring to FIG. 19D, another drift detection method 1930 for image data may include steps 1931-1938, according to some embodiments. In some embodiments, the drift detection method 1930 may be performed by a model deployment system 1100.

In step 1931, training data for a data analytics model are obtained. The training data may include a plurality of training data samples. Each of the data samples may include a respective training image.

In step 1932, a respective numeric value of an image feature is extracted from each of the training images.

In step 1933, multiple sets of scoring data are obtained. Each set of scoring data may correspond to a different time period and may include a respective plurality of scoring data samples. Each of the scoring data samples may include a respective scoring image.

In step 1934, a respective numeric value of the image feature is extracted from each of the scoring images.

In step 1935, for each set of scoring data, the numeric values of the image feature extracted from the training images and the numeric values of the image feature extracted from the respective set of scoring data are provided as input to a classifier. In some embodiments, the classifier is a covariate shift classifier configured to detect statistically significant differences between two sets of data.

In step 1936, based on output from the classifier, drift in the numeric values of the image feature over time is detected. In some embodiments, detecting the drift over time involves detecting the drift in two or more of the sets of scoring data.

In step 1937, a determination is made that the drift corresponds to a reduction in accuracy of the data analytics model. In some embodiments, determining that the drift corresponds to a reduction in accuracy of the data analytics model involves determining an impact of the image feature on the reduction in accuracy. In some embodiments, determining the impact includes displaying, via a graphical user interface, a chart indicating the impact of the image feature on the reduction in accuracy.

In step 1938, a corrective action to improve the accuracy of the data analytics model is facilitated. In some embodiments, the corrective action includes sending an alert to a user of the data analytics model, refreshing the data analytics model, retraining the data analytics model, switching to a new data analytics model, or any combination thereof.

In some embodiments, the data analytics model is trained using the training data, and the data analytics model is used to make predictions based on the scoring data. In some embodiments, each set of scoring data represents a distinct period of time.

In some embodiments, for a particular image selected from the training images or scoring images, extracting the numeric value of the image feature of the particular image includes (1) with a pre-trained image processing model, extracting respective values of a plurality of constituent image features from the particular image, and (2) applying a transformation to the values of the constituent image features to determine the numeric value of the image feature. In some embodiments, the transformation is a dimensionality-reducing transformation. In some embodiments, the transformation includes a principal component analysis (PCA) and/or a uniform manifold approximation and projection (UMAP).

### 7. Use Cases

Some embodiments can be used across all industries in a wide variety of use cases. Retailers can use computer vision to improve the customer experience, detect when product is out-of-stock on store shelves or even watch for suspicious activity to help with loss prevention. Manufacturers can use some embodiments to identify product defects in real-time. As the parts and components come off their production line, images can be fed into their model to flag potential defects and avoid problems further downstream.

Insurance companies can conduct more consistent and accurate vehicle damage assessments to help reduce fraud and streamline the claims process. Healthcare providers can use image-based neural networks to automate the examination and diagnosis of health issues from MRI's, CAT scans and X-rays.

Other applications range from using images of gas stations to help better plan where to focus marketing spend, to the automated labeling of apparel from fashion photography for eCommerce websites.

For example, a hospital readmissions model built on tabular data, with features such as diagnosis, age, and gender can be enhanced with more diverse information such as surgeon notes, and with some embodiments, images from the patient's MM.

7.1 Insurance Claims Prediction

Above, an example is described in which a model is developed and used to infer the prices of units of residential real estate (e.g., houses) based on images of the units, text descriptions of the units, and other information. In this section, an example is described in which a model is developed and used to predict insurance claims (e.g., under homeowner's insurance, small business insurance, and/or vehicle insurance policies). This example was developed and validated using real-world data provided by an insurer.

The ability to predict losses (claims) has a significant impact on an insurer's management decisions. By accurately predicting the total amount of claims and estimating the size of claims reserve, insurers can effectively utilize the capital and make better management decisions about investments, new products, and sales strategy. One approach to predicting insurance claims is to train a custom deep learning model M1 on a data set derived from historical claims. Here, the inventors used an embodiment of the model development system 100 to develop a data analytics model M2 for predicting claims under homeowners' insurance policies, and compared the performance of model M2 and the in-house model M1.

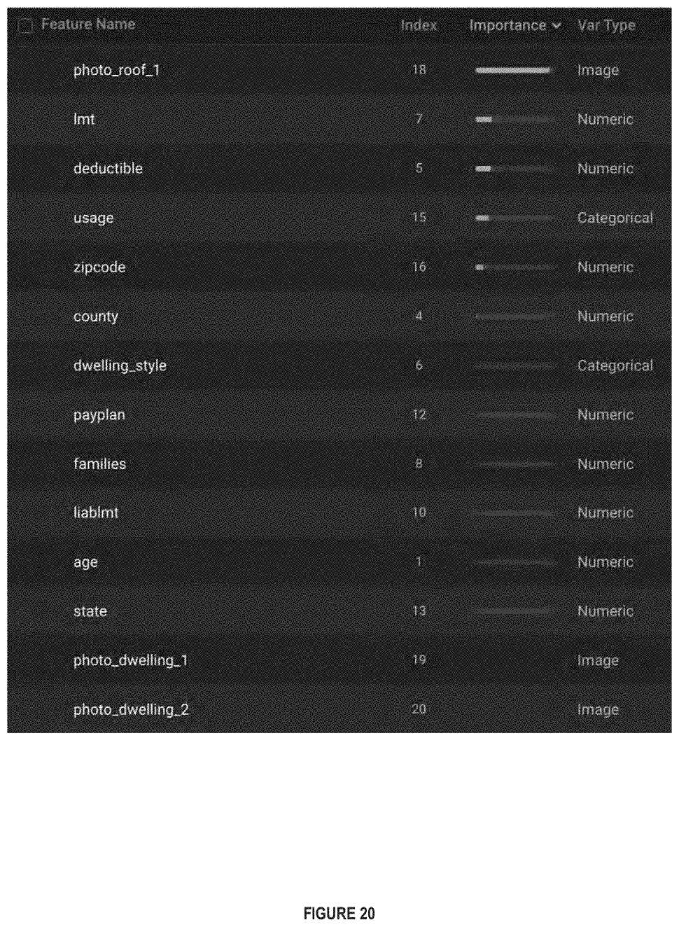

The input data set of historical claim outcomes contained 20,000+ data points, 2,500 of which were used for training and 18,000 for scoring. As can be seen in FIG. 20, the data set had variables of a variety of data types, including multiple numeric, categorical, and image features. Still referring to FIG. 20, feature importance scores (e.g., univariate feature importance scores) indicate that a photo of the roof of the house is the most informative feature for model development, with numeric/categorical policy details being the next most informative features. These policy details include the claim limit under the policy (“lmt”), the policy deductible (“deductible”), the usage of the insured dwelling (“usage”), and the zip code of the insured dwelling's address (“zipcode”).

The data set (e.g., as a ZIP archive with images) was provided to the model deployment system 100, which automatically built a number of models in a matter of hours on commodity hardware in the cloud. The accuracy of the best model M2 (AUC 0.8798) was on par with the accuracy of the in-house model M1, which had been developed over a period of weeks by a team of data scientists using GPU-accelerated hardware.

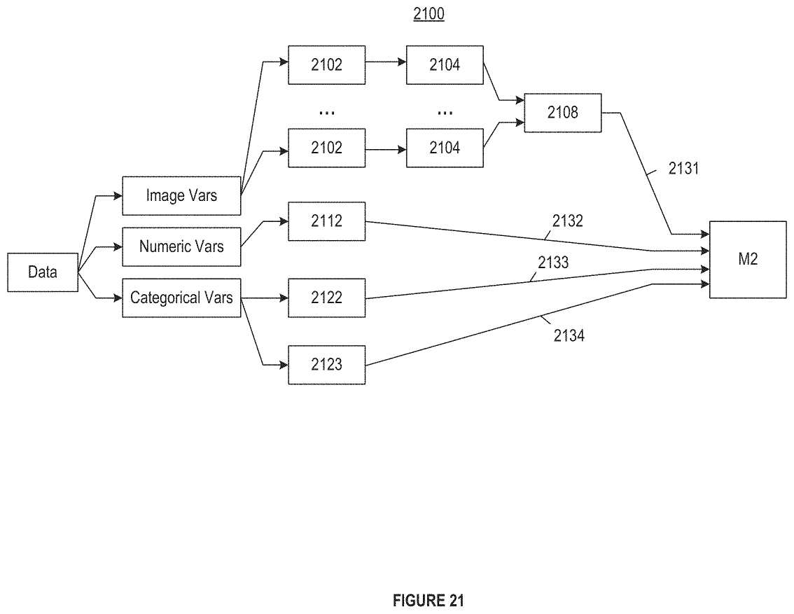

FIG. 21 shows the blueprint used by the model development system 100 to develop the best model. In this case, the model 2150 is an entropy-based random forest classifier. The target of the model is a binary classification (‘claim’ or ‘no claim’), and the features (2131-2134) of the model are engineered features derived from the above-described data set. In particular, in accordance with the blueprint 2100, a pre-trained image feature extraction model 2102 is used to extract a set of image features from each of the images in the data set, and models 2104 are trained to infer the ‘claim’ or ‘no claim’ classification based on the respective sets of extracted image features. In this case, each of the models 2104 is a classifier (e.g., an Elastic Net Classifier (L2/Binomial Deviance)). The classifications generated by the models 2104 are combined 2108 to produce a single inferred classification 2131 based on all sets of image features. Any suitable technique may be used to combine the inferred classifications including, without limitation, voting. The combined, image-based inferred classification 2131 is used as a feature of the model 2150. Furthermore, in accordance with the blueprint 2100, missing value imputation (2112) is performed with respect to the data set's numeric variables, and ordinal encoding (2122) and category counting (2124) are performed with respect to the data set's categorical variables. The resulting numerical features (2132) and categorical features (2133, 2134) are used as features of the model 2150.

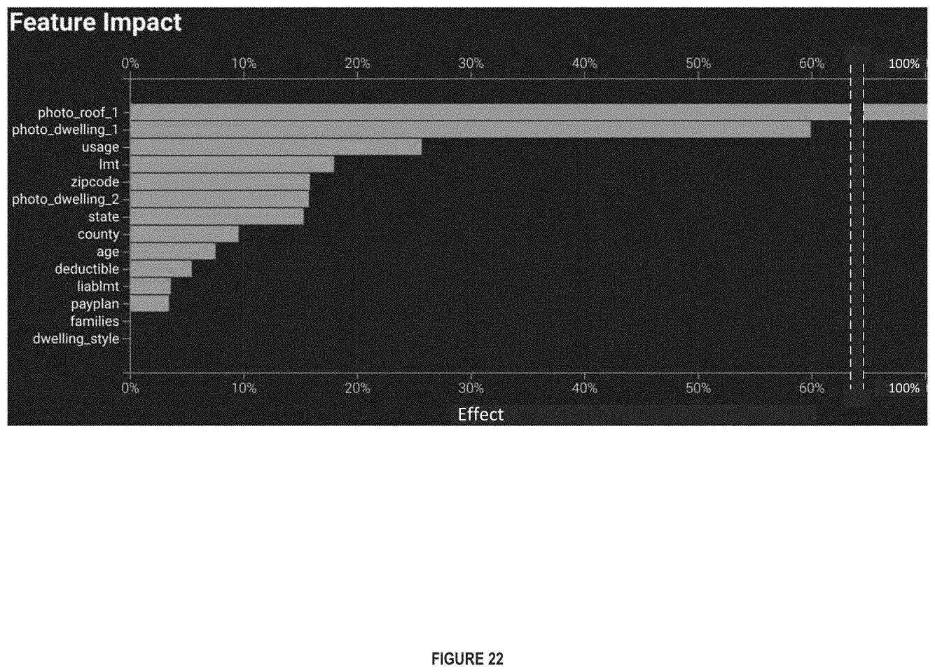

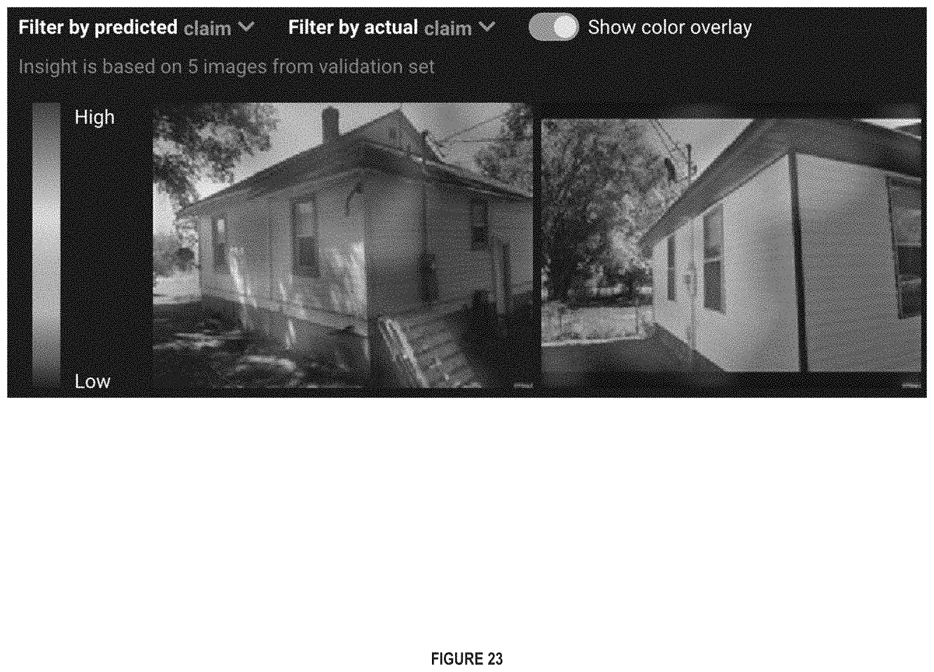

In this example, the insurer was able to explore the image and non-image features through the user interface of the model development system 100, which provided the model explanation visualizations shown in FIGS. 22 and 23. FIG. 22 shows the normalized impact of image and non-image features with respect to an individual prediction of the model M2. FIG. 23 shows an image inference explanation visualization indicating the impact of different regions of the exterior_image of a house with respect to an individual prediction of the model M2.

The insurer was able to deploy the model M2 to an embodiment of model deployment system 1100 in the cloud and score 18,000 records (in batches of 50) containing 37,000+ images in less than 30 minutes.

### 8. Further Description of Some Embodiments

Some examples have been described in which a computer vision model (e.g., a neural network) extracts values of image features from image data, and a machine learning model that has not been trained on the extracted values of the image features (or values of features derived therefrom) generates inferences based on the extracted values. Such two-stage models may be referred to herein as “visual artificial intelligence models” or “visual AI models.”

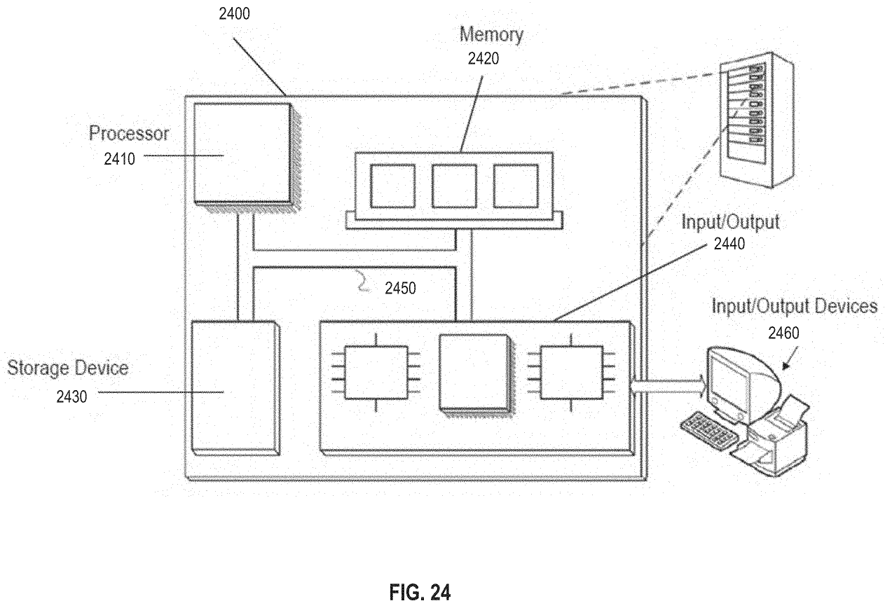

FIG. 24 is a block diagram of an example computer system 2400 that may be used in implementing the technology described in this document. General-purpose computers, network appliances, mobile devices, or other electronic systems may also include at least portions of the system 2400. The system 2400 includes a processor 2410, a memory 2420, a storage device 2430, and an input/output device 2440. Each of the components 2410, 2420, 2430, and 2440 may be interconnected, for example, using a system bus 2450. The processor 2410 is capable of processing instructions for execution within the system 2400. In some implementations, the processor 2410 is a single-threaded processor. In some implementations, the processor 2410 is a multi-threaded processor. The processor 2410 is capable of processing instructions stored in the memory 2420 or on the storage device 2430.

The memory 2420 stores information within the system 2400. In some implementations, the memory 2420 is a non-transitory computer-readable medium. In some implementations, the memory 2420 is a volatile memory unit. In some implementations, the memory 2420 is a nonvolatile memory unit.

The storage device 2430 is capable of providing mass storage for the system 2400. In some implementations, the storage device 2430 is a non-transitory computer-readable medium. In various different implementations, the storage device 2430 may include, for example, a hard disk device, an optical disk device, a solid-date drive, a flash drive, or some other large capacity storage device. For example, the storage device may store long-term data (e.g., database data, file system data, etc.). The input/output device 2440 provides input/output operations for the system 2400. In some implementations, the input/output device 2440 may include one or more of a network interface devices, e.g., an Ethernet card, a serial communication device, e.g., an RS-232 port, and/or a wireless interface device, e.g., an 802.11 card, a wireless modem (e.g., 3G, 4G, or 5G). In some implementations, the input/output device may include driver devices configured to receive input data and send output data to other input/output devices, e.g., keyboard, printer and display devices 2460. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 2430 may be implemented in a distributed way over a network, for example as a server farm or a set of widely distributed servers, or may be implemented in a single computing device.

Although an example processing system has been described in FIG. 24, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array) or an ASIC (application specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, an engine, a pipeline, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

### 9. Terminology

The phraseology and terminology used herein is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

Measurements, sizes, amounts, etc. may be presented herein in a range format. The description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as 10-20 inches should be considered to have specifically disclosed subranges such as 10-11 inches, 10-12 inches, 10-13 inches, 10-14 inches, 11-12 inches, 11-13 inches, etc.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

1. A method for determining an importance of an aggregate image feature, the method comprising:
obtaining a plurality of data samples, wherein each of the plurality of data samples is associated with respective values for a set of features and with a respective value for a target, wherein the set of features includes a feature having an aggregate image data type, and wherein the feature having the aggregate image data type comprises a plurality of features each having a constituent image data type;
for each of the plurality of constituent image features, determining a feature importance score indicating an expected utility of the constituent image feature for predicting the values of the target; and
determining a feature importance score for the aggregate image feature based on the feature importance scores of the constituent image features, wherein the feature importance score for the aggregate image feature indicates an expected utility of the aggregate image feature for predicting the values of the target.

2. The method of claim 1, wherein the aggregate image feature comprises an image feature vector.

3. The method of claim 1, wherein the feature importance score comprises a univariate feature importance score, a feature impact score, or a Shapley value.

4. The method of claim 1, further comprising:
prior to determining the feature importance score for the aggregate image feature based on the feature importance scores of the constituent image features, normalizing and/or standardizing the feature importance scores for the constituent image features.

5. The method of claim 1, further comprising, for each data sample of the plurality of data samples:
extracting respective values for the plurality of constituent image features from a first plurality of images using a pre-trained image processing model.

6. The method of claim 5, wherein the pre-trained image processing model comprises a pre-trained image feature extraction model or a pre-trained, fine-tunable image processing model.

7. The method of claim 5, wherein the pre-trained image processing model comprises a convolutional neural network model previously trained on a training data set comprising a second plurality of images.

8. The method of claim 1, wherein determining the feature importance score for the aggregate image feature comprises selecting a highest feature importance score among the feature importance scores for the constituent image features, and using the selected highest feature importance score as the feature importance score for the aggregate image feature.

9. The method of claim 1, wherein the set of features further includes a feature having a non-image data type, and wherein the method further comprises:
quantitatively comparing a feature importance score of the feature having the non-image data type with the feature importance score of the aggregate image feature; and
determining, based on the quantitative comparison, whether the non-image feature or the aggregate image feature has greater expected utility for predicting the values of the target.

10. An image-based data analytics method, comprising:
obtaining inference data, wherein the inference data include image data;
extracting, by an image feature extraction model, respective values of a plurality of constituent image features derived from the image data; and
determining a value of a data analytics target based on the values of the plurality of constituent image features, wherein the determining is performed by a trained machine learning model.

11. The method of claim 10, wherein the image feature extraction model is pre-trained.

12. The method of claim 10, wherein the image feature extraction model comprises a convolutional neural network.

13. The method of claim 10, wherein the plurality of constituent image features include one or more low-level image features, one or more mid-level image features, one or more high-level image features, and/or one or more highest-level image features.

14. The method of claim 10, wherein the inference data further include non-image data.

15. The method of claim 14, wherein the determining of the value of the data analytics target is also based on values of one or more features derived from the non-image data.

16. The method of claim 15, further comprising arranging the values of the constituent image features and the values of the features derived from the non-image data in a table, wherein the determining of the value of the data analytics target is performed by applying the trained machine learning model to the table.

17. The method of claim 15, wherein the image feature extraction model is not fitted to the values of the plurality of constituent image features derived from the image data.

18. The method of claim 17, wherein the trained machine learning model includes a gradient boosting machine.

19. The method of claim 15, wherein the value of the data analytics target includes a prediction based on the inference data, a description of the inference data, a classification associated with the inference data, and/or a label associated with the inference data.

20. A model development system comprising:
an image feature extraction module operable to extract values of one or more image feature candidates from image data;
a data preparation and feature engineering module operable to obtain values of one or more of a plurality of features based, at least in part, on the values of the image feature candidates; and
a model creation and evaluation module operable to generate and evaluate one or more machine learning models trained to determine a value of a data analytics target based on the values of the plurality of features.

21-47. (canceled)
